(19) United States
(12) Patent Application Publication
(10) Pub. No.: US 2011/0307217 A1
(43) Pub. Date: Dec. 15, 2011

(54) Method and apparatus for analysis and assessment of measurement data of a measurement system

(75) Inventors: Sven C. Fritz, Rodgau (DE); Thomas Guntschnig, Graz (AT); Martin Stettner, Graz (AT); Marvin Berger, Krieglach (AT); Werner Fuchs, Assling (AT)

(73) Assignee: AVL LIST GMBH

(21) Appl. No.: 13/137,496

(22) Filed: Aug. 22, 2011

Related U.S. Application Data
(63) Continuation of application No. 12/320,013, filed on Jan. 14, 2009.

(30) Foreign Application Priority Data
Jan. 14, 2008 (AT) GM 22/2008

(51) Int. Cl. G06F 15/00

(52) U.S. Cl. 702/183

(57) ABSTRACT

A method for analysis and assessment of measurement data of a measurement system having at least one measurement channel provides for the assessment of the measurement data at freely selectable times and over a freely selectable period on the basis of at least one of a plurality of predeterminable criteria. In order in this case to develop a central and generally applicable measurement data diagnosis, in which any desired number of measurement channels can be monitored at the same time with little effort and with good result representation, preferably with determination of the faulty channels, the raw data of the measurement channel is supplied to a fault isolation stage and then to a fault classification stage, and a measure is then determined for the quality of the measurement data of the respective measurement channel. An input for the raw data of the measurement channel as well as a unit in which a fault isolation stage and then a fault classification stage are implemented are provided for this purpose in the apparatus for analysis and assessment of measurement data of a measurement system.

The invention relates to a method for analysis and assessment of measurement data of a measurement system having at least one measurement channel, comprising the assessment of the measurement data at freely selectable times and over a freely selectable period on the basis of at least one of a plurality of predeterminable criteria.

The requirements of modern test panels with regard to reproducibility, quality and costs in the test process have become considerably more stringent in recent years because the objectives have become more complex.

The requirement for shorter development times contrasts with a more than proportional increase in the application effort. This conflict of aims is caused by the continuous increase in the degrees of freedom and by the growing number of measurement variables. In consequence, considerably more extensive and more complex test tasks will have to be carried out in an ever shorter time in the future.

This development results not least from the ever stricter requirements from exhaust-gas legislation. As a consequence, the number of modern open-loop and closed-loop control engineering functions with appropriate sensor systems and actuator systems for closed-loop control of internal combustion engines is rising continually.

The object of the application is now to determine the optimum setting of the degrees of freedom resulting from this, taking account of specific restrictions.

The test panels used by the engine and drive-train manufacturers have reacted to these requirements by the widespread use of intelligent measurement methods. In particular, the use of statistical experimental planning (DoE—Design of Experiment) is focussed on the maximum validity of the experimental results while minimising the measurement effort at the same time.

As a result of the combination of technical expert knowledge with mathematical methods, DoE leads, by means of specific experimental plans, to a reduction in the required measurement points and at the same time to efficient modelling. The subsequent optimization process results in the data input of the parameters, characteristics and families of characteristics for the ECU. The result of the optimization process in this case depends on the model quality and measurement data quality.

The application specialist uses his specialist knowledge to determine the model approach to be used, and thus contributes significantly to the later model quality.

At the moment, only a small amount of measurement data is yet available for modelling for DoE. This means that this data must be subject to appropriate quality requirements. This immediately becomes clear when forming a second degree polynomial model with the same model quality from 3 instead of 5 measurement values.

Normally, the model quality and the optimization result react extremely sensitively to incorrect measurement data, and it is absolutely essential to check the measurement data before modelling and optimization.

From the economic point of view, measurement data diagnosis makes sense for every test run since this allows spurious measurements to be avoided or to be considerably reduced. Estimates of test rig times lost as a result of incorrect measurements that are recognized too late or are not recognized are between 10% and 40%.

However, because of the large amounts of data, objective and automated assessment of the measurement data is worthwhile only when all the required data can be accessed centrally and online.

A further aspect results from unmanned test rig operation. An appropriate reaction in the event of irregularities during data acquisition can also be achieved during unmanned or partially manned operation by means of a universal diagnosis tool.

If the measurement data diagnosis is not only centralised but is also designed to be configurable, it can be used for any desired test run and unit under test.

Various solution approaches have been proposed for the diagnosis of technical systems which are comparable to the diagnostic requirements for engine test rigs. In addition to on-board diagnosis of the engine electronics (OBD), for example, various model-based and specific test-rig-related approaches have been proposed, and their optimization potential has been indicated.

The requirements for OBD and for measurement data diagnosis are very similar over wide areas. Legal regulations from the CARB (California Air Resource Board) have led since 1988 in California to legally required monitoring of specific components in the vehicle. The first stage of this regulation (OBD I) initially related only to the electrical monitoring of all sensors and actuators which are connected to the ECU. The driver is informed about malfunctions in the OBD-monitored emission control loop by means of a fault lamp, the MIL (Malfunction Indicator Light). Workshops and service centres were able to read faults stored via the MIL, by means of a flashing code.

OBD II has been in force since 1994. In addition to the monitoring of simple components, it has now also become necessary to monitor complete systems that are relevant to the exhaust gas.

Since then, standardised data transmission using standardised plugs (GST=Generic Scan Tool) has replaced the flashing code for reading the fault memory in the vehicle. In addition to the fault codes, additional engine operating data for the fault time period can be read via this interface. Approximately one third of the total time required for the application is normally involved in setting the OBD. The OBD functions are nowadays designed such that, in addition to recognition, isolation and storage, active reactions also take place. Some of these are likewise regulated by the legislation. One classic example, for example, is the change in the emergency running operating mode. Nowadays, numerous system monitoring activities are carried out beyond the legal requirements in order to gather information for maintenance work in the workshops.

The basic functions of OBD are on the one hand to monitor the input and output signals and on the other hand to check the controller communication and the internal appliance functions of the ECU. The monitoring of the input signals in general tests the connecting lines to the ECU, the voltage supply to the sensors, and carries out possible plausibility checks (see “Exhaust-gas technology for Otto-cycle engines”, Bosch Technical Report, Yellow Series, 2002, Table T2.1). The output signals are monitored by means of circuit analysis between the output signal and the output stage or by deliberate system effects which occur during operation of an actuator. A large number of model-based fault recognition methods have been developed in recent years for this purpose in the field of actuator monitoring.

Nowadays, ECU communication is monitored essentially by checking mechanisms for the CAN bus systems. Internal functions and components are tested directly after starting, and then at regular intervals during operation.

The history of OBD shows that the manipulated value for vehicle diagnosis has grown continuously. The fundamental OBD requirements can therefore also be used as a template for measurement data diagnosis with corresponding visualization and data management. However, the OBD fault diagnosis only ever applies to the applied engine range. For this purpose, the fault-free system behaviour is determined during the application by models, characteristics and characteristic values, and is stored. The known system environment also allows the checking, as described in Table T2.1, of specific electrical circuits or of corresponding signal ranges.

TABLE T2.1
Monitored input signals

| Signal path | Monitoring |
|---|---|
| Accelerator pedal | Check of the supply voltage and of |
| sensor | the signal range |
| | Plausibility with redundant signal |
| | Plausibility with brake |
| Crankshaft | Check of the signal range |
| rotation-speed | Plausibility with camshaft |
| sensor | rotation-speed sensor |
| | Check of the changes over time |
| | (dynamic plausibility) |
| Engine temperature | Check of the signal range |
| sensor | Logical plausibility as a function |
| | of the rotation speed and the |
| | engine load |
| Speed signal | Check of the signal range |
| | Logical plausibility as a function |
| | of the rotation speed and engine |
| | load |
| AGR valve | Check for short circuits and line |
| | discontinuities |
| | Exhaust-gas feedback control |
| | Check of the system reaction to the |
| | valve control |
| Battery voltage | Check of the signal range |
| Air mass flow | Check of the supply voltage and of |
| meter | the signal range |
| | Logical plausibility |
| Air temperature | Check of the signal range |
| | Logical plausibility |

In contrast to OBD, measurement data diagnosis on engine test rigs is, however, not just restricted to the emission-relevant components or to one specific engine. In contrast to OBD, the measurement data diagnosis must be flexibly applicable to different engines and experiments.

In contrast, “Modellbasierte Fehlererkennung und Diagnose der Einspritzung und Verbrennung von Dieselmotoren” [Model-based fault recognition and diagnosis of the injection and combustion in diesel engines] by Frank Kimmich, Dissertation 2003, Darmstadt Technical University, has described a number of sought-after examples for the use of methods based on signals and process models for fault recognition for internal combustion engines. (Like OBD), these methods likewise relate to technical systems which can be described unambiguously.

In general, the principles of signal theory are used for the application of signal models. For example, “Erkennung von Zündaussetzern aus Drehzahlsignalen mit Hilfe eines Frequenzbereichsverfahrens” [Recognition of ignition misfires from rotation-speed signals with the aid of a frequency domain method] by Führer et al., Conference on Electronics in motor vehicles, Haus der Technik, Essen, describes a method based on FFT (Fast Fourier Transformation) for recognition of ignition misfires from the rotation-speed signal. In addition to the use of rotation-speed signals for misfire recognition, “Verbrennungsdiagnose von Ottomotoren mittels Abgasdruck und Zonenstrom” [Combustion diagnosis of Otto-cycle engines by means of the exhaust-gas pressure and zone flow] by M. Willimowski, Shaker Verlag, Aachen proposes a method for misfire recognition based on exhaust-gas back-pressure sensors, using FFT and Wavelet transformation.

In contrast to fault recognition based on signal models, in the case of the variant based on process models, a mathematical process model is compared with the actual process, for example as described in “Detection of instrument malfunctions in control systems”, by R. N. Clark, D. C. Fosth and V. M. Walton, EEE Transactions on Automatic Control, 1984. The use of parameter estimation methods or of state-variable estimators is described, for example, in “Modellgestützte Fehlererkennung und Diagnose am Beispiel eines Kraftfahrzeugaktors” [Model-based fault recognition and diagnosis using the example of a motor-vehicle actuator] by T. Pfeufer, Fortschrittberichte VDI, Series 8, No. 749, VDI-Verlag, 1999.

In addition to model-based approaches, blackbox models, for example in the form of neural nets, are also being used ever more frequently. The work “Modellgestützte Fehlererkennung mit Neuronalen Netzen—Überwachung von Radaufhängungen und Diesel-Einspritzanlagen” [Model-based fault recognition using neural nets—monitoring of wheel suspension systems and diesel injection systems] by S. Leonhardt, Forschungsberichte, VDI Series 12, No. 295, VDI-Verlag, Dusseldorf, 1996, describes, for example, a method by means of which the injection amount and the injection time can be reconstructed from the pressure signal by means of neural nets on the basis of diesel-engine cylinder pressure measurements. The work “Entwicklung und Verifizierung eines neuronalen Netzwerkmodells zur Beschreibung des Verhaltens von PKW-Partikelfiltersystemen in Bezug auf Beladung und Regeneration” [Development and verification of a neural network model to describe the behaviour of passenger-car particle filter systems with respect to boosting and regeneration] by Sven Fritz, Diplomarbeit 2002, Darmstadt Technical University and “Entwicklung und Applikation eines virtuellen Sensors zur Bestimmung der Beladung von Partikelfiltern” [Development and application of a virtual sensor for determination of the load of particle filters] by Christian Landgraf, Dissertation 2005, Darmstadt Technical University, describe the implementation of a virtual carbon-black mass sensor based on neural nets.

The examples mentioned above describe the use of fault diagnosis for technically completely described or measured systems. In contrast to systems such as these, the situation on test rigs is considerably more complicated. For time and cost reasons, there is interest in achieving corresponding utilisation of this test facility. Different test tasks or experiments therefore frequently result in changing constraints. In consequence, data-based or model-based approaches generally do not work for a diagnosis system, since there is generally no freedom of action for system identification.

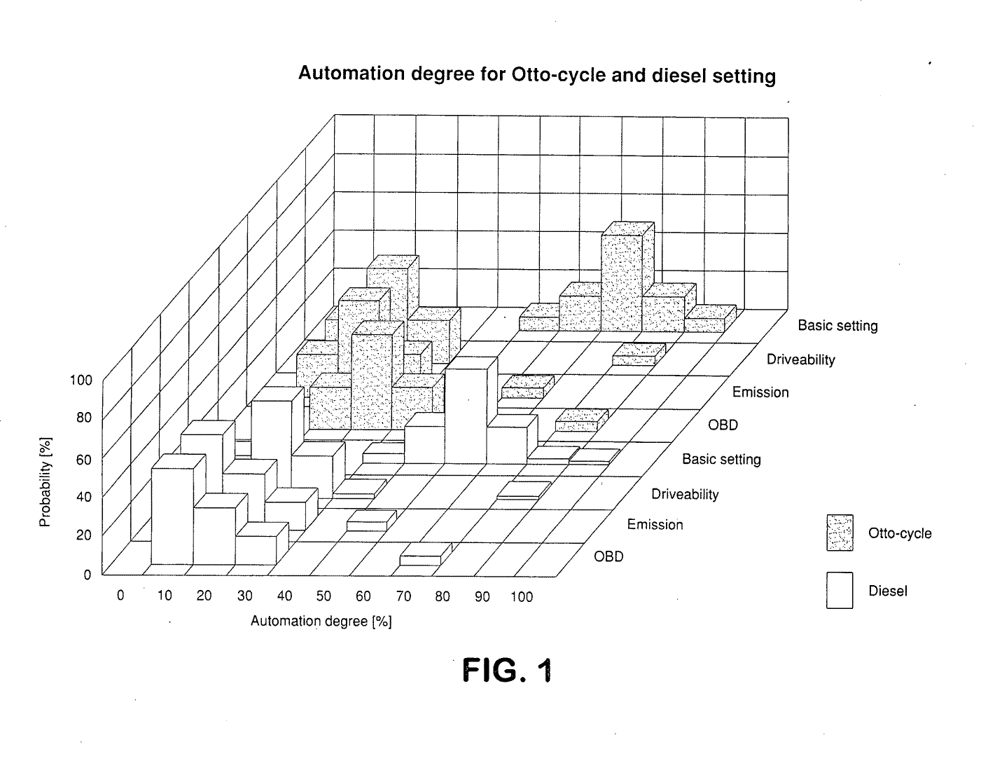

On the other hand, modern test panels are distinguished by proven procedures with a continuously increasing degree of automation. In this context, FIG. 1 shows the result of a study relating to the subject of use of methodology for engine development, which was carried out in the course of the work “Motorsimulation in Echtzeit” [Engine simulation in real time], by Timo Combe, Dissertation 2006, Darmstadt Technical University. It is evident from this that automated processes are being increasingly used over wide areas of engine and drive-train development. An automated process in this case also frequently involves unmanned or partially manned operation. This fact in its own right justifies the requirement for measurement data diagnosis for test rigs.

However, even during normal operation, the increased amount of data and more complex test runs lead to a situation in which simple online plausibility checking by the test rig personnel is virtually impossible. Furthermore, the checking of the measurement data by the test rig personnel includes human beings as a fault source, and therefore cannot be considered to be an optimum solution approach. System monitoring solutions developed by test rig operators are generally highly specialised and can therefore be transferred to new tasks only by experts. Test-panel-wide use is accordingly difficult.

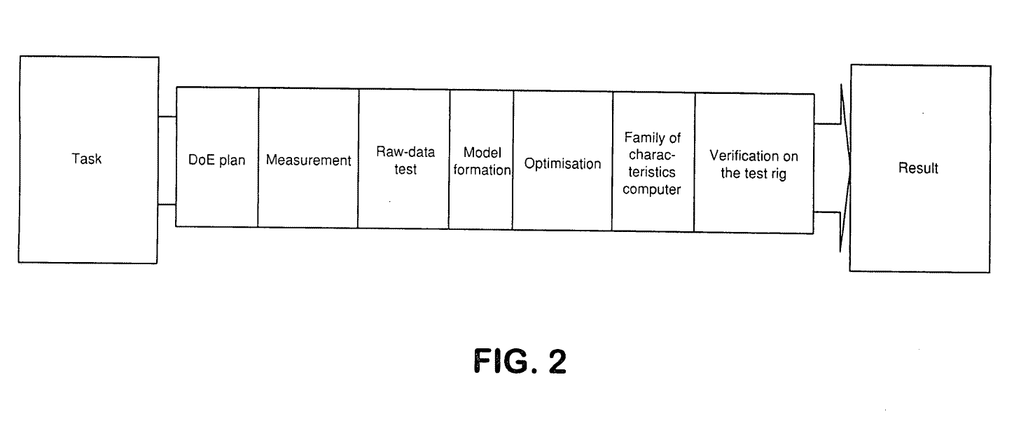

Using the example of the DoE workflow (FIG. 2), it even becomes clear that raw data plausibility checking is normally carried out only after measurement. If faults which are not detected by limit-value monitoring of the automation system or by the DoE software occur during the test run, then the test run continues to the end using this faulty data. Since a test run can often also last for several days, a fault or sensor failure that is not recognized can lead to considerable time and cost penalties.

Measures such as good test equipment, high quality in signal processing or a robust overall system admittedly improve the fundamental system robustness, but in the end do not provide any conclusion about the actually existing measurement quality, signal quality or plausibility of the acquired data.

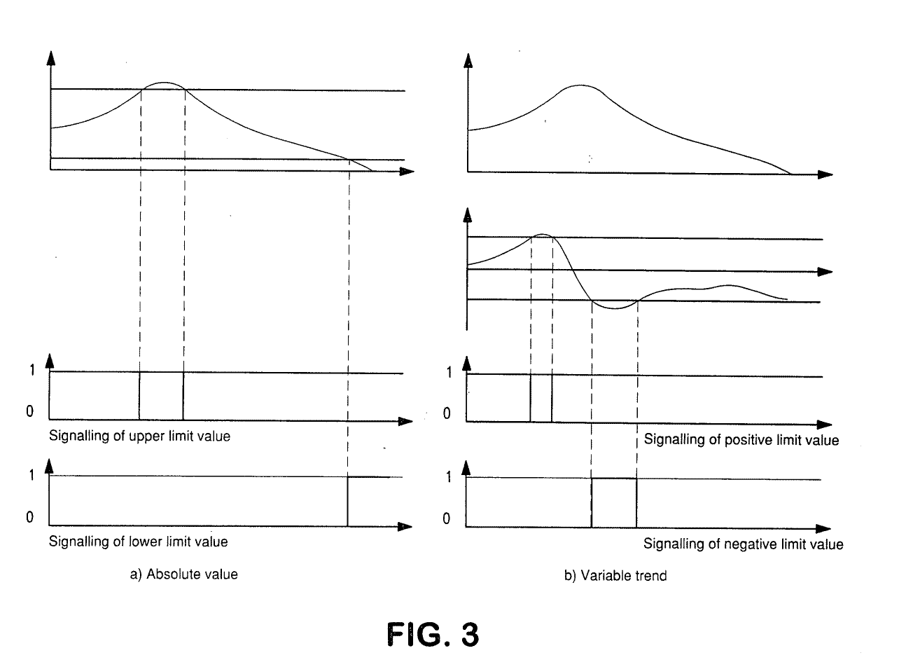

However, modern test rig systems already have a number of mechanisms for fault recognition and limit-value monitoring for selected measurement values (FIG. 3). These mechanisms test whether measurement values are within a defined validity range. The monitoring is generally matched to the current objective by the user, by means of limit values for the test rig, unit under test or experiment.

In the case of a DoE test run, for example, the so-called “hard limits” are monitored by the limit-value monitoring for the automation system. “Hard limits” protect the operational safety of the unit under test and experimental facility and, if a limit value is infringed, generally lead to a system switch off (for example oil-pressure or rotation-speed limit values). In contrast, the “soft limits” are monitored in the DoE test run. They are used to define the experimental area and to control the experiment strategy.

Limit-value monitoring is frequently also used in conjunction with a nominal/actual comparison. One classic example is the comparison of reference points with current measurement data. Specific databases are used for this purpose, for which corresponding nominal values at defined reference points are known. However, in general, this method does not check the measurement data quality but the engine response.

One fundamental precondition for this method is the measurement recording of the process variable at a steady-state operating point, and a corresponding nominal value. It is just as important for the actual state to be associated with the corresponding data reference. By way of example, the limit-value monitoring is carried out using the relationship 2.1

Nominal value−tolerance≦actual value≦nominal value+tolerance [relationship 2.1]

The trend monitoring (FIG. 3, right-hand diagram) is a particular type of limit-value monitoring and is generally used for signals which vary slowly, in order for example to recognize in good time when critical system states are reached. This method is used individually on test rigs to monitor the long-term behaviour of test equipment (for example exhaust-gas instrumentation) or for analysis of engine reference points (for example blowby).

Apart from limit-value monitoring, most test rig systems also allow calculation of simple formulae. This results in the so-called computation variables on the test rig. This functionality is used, for example, to calculate the specific fuel consumption or other typical characteristic values. These variables are used as a measure of the process quality and provide important information about the state of the overall system. Normal characteristic values are, for example, the efficiency, the specific fuel consumption, the lubricant consumption or blowby.

The calculation of formulae also allows simple plausibility analyses. One classic example is the calculation of λ-Brettschneider and the subsequent comparison with a redundantly determined lambda (for example from the ECU). However, in general, this relates to specifically adapted solution approaches.

Surveys of the test panel operators and engineers from the test panels have shown that a number of approaches are already in use for assessment of the measurement data. However, the questions also showed that, with regard to the assessment of the measurement data, the assessment of the engine (unit under test) is in fact more important than the quality of the measurement data. In many cases, for example, methods for limit-value monitoring or for reference-point checking are used only to assess the unit under test. In individual cases, trend analyses or lambda comparisons are also carried out. In most cases, pressures and temperatures are assessed visually by the test rig personnel. The survey also showed that regular plausibility tests using a predetermined procedure represent the exception. In this field, use is made of the competence and experience of the test rig personnel and the experimental engineers.

In recent years, various approaches for implementation of automated measurement data diagnosis have therefore been worked out in the special field of internal combustion engines.

According to the “Visionen zu einem Motorenprüfstand für das 21. Jahrhundert” [Visions for an engine test rig for the 21st Century] by G. Hohenberg, Haus der Technik, Conference, Essen, 1999, diagnosis for engine test rigs can in principle be split into three functional columns. In this case, it must be noted that, strictly speaking, this relates only to fault recognition and not to fault diagnosis since diagnosis means finding the cause of the fault.

The appliance check (column 1) is split into the sensor diagnosis level (for example cable break recognition) and self-diagnosis of the special-tool-type test equipment. The sensor diagnosis (level 1) is carried out using directly measurable signals of the automation system. Use is made of the feedback from the individual appliances for the self-diagnosis of special-tool-type test equipment. VDI/VDE 2650 (requirements for self-monitoring and diagnosis in field instrumentation) describe the self-diagnosis of test equipment and the corresponding status signals. One precondition, of course, is adequate communication between the test rig system and the connected special-tool-type test equipment.

The signal quality column (level 3) deals with the signal profile and the statistical analysis of the signal behaviour (for example noise).

The third column (levels 4 and 5) deals with the plausibility of measurement values. The formation of analytical and empirical redundancies makes it possible to test whether the current measurement value matches the currently selected engine operating point. Analytical redundancies are in this case formed by physical or empirical relationships, with computation values being linked directly to measurement values. Empirical redundancies are in contrast based on the analysis of reference points, with the current measurement values being compared with defined references.

An analysis of the most frequent faults on engine test rigs has been carried out in the work “Konzept and Umsetzung einer Messdatendiagnose an Motorenprüfständen” [Concept and implementation of measurement data diagnosis on engine test rigs] by Andreas Flohr, Dissertation 2005, Darmstadt Technical University, and for the first time provided a comprehensive concept for measurement data diagnosis, for example in DE 10 2006 048730 A and in DE 10 2005 052921 A. However, the concept relates essentially only to the third column of fault recognition (plausibility) and ignores the signal quality and the appliance check.

The approach by Flohr is based on the assumption that all the necessary measurement variables are available and, by appropriate configuration, can also be recognized as such and associated correctly by the system.

In addition to fault recognition, an algorithm was also incorporated for identification of faulty channels, representing an effective aid for the diagnosis of the actual fault cause. However, this approach can be extended only with difficulty, is relatively complicated and is computation-intensive. Furthermore, the fault significance is not considered. In consequence, even individual extreme values can lead to a corresponding indication.

Finally, it can be noted that the approach according to Flohr can be used well for analysis of fundamental relationships, based on chemical and physical relationships. The disadvantage is that the developed software can be used only in conjunction with one specific interface, and that there is no assessment of the signal quality.

The field of physically-based fault identification has been covered, inter alia, in the course of the EU research project AMPA (Automatic Measurement Plausibility and Quality Assurance). The aim of the project was redevelopment and optimization of existing methods for fault diagnosis. One particular aim was to introduce application-oriented test rules and models, and to combine these with a generic test methodology in a prototype. A further aim was then to carry out an everyday trial on the test panel in order to provide the verification that the aims of “shortening effective engine test times and test costs” and “improved and verifiable data quality” have been met. For this purpose, fault diagnosis was considered to be a process in which the sub-steps model value calculation, fault recognition and fault result matching were carried out taking account of a plurality of measurement channels for each measurement point. Automatic modelling and model adaptation were added for tests by means of models that were learnt automatically. The aim was to develop a strategy which allows the best possible synergy between human expertise and automatically learnt empirical values. Physical, configurable models were used in the same way as parameter estimators or black box models, on the basis of this aspect. Various statistical and fuzzy-logic approaches were investigated and implemented for modelling. In contrast, the black box models were intended to map models based on families of characteristics, for the fault-free system behaviour.

The described approach was intended to link fault recognition and physically configurable expert modules with automatically trained neural net modules in order to include a large number of measurement channels in the diagnosis, without any further configuration effort.

The object of the present invention was therefore to ensure consistency with the more stringent requirements of modern test panels and to develop central and generally applicable measurement data diagnosis for engine test rigs. The aim of the present work is therefore also to develop a diagnosis system which can monitor any desired number of measurement channels at the same time, with little effort.

In addition to robust and early fault recognition, it must be possible to adjust the system quickly for different test rigs, units under test or test tasks.

The linking of the measurement values to the diagnosis results is in this case just as important as early fault recognition and definition of the faulty measurement channels.

From this aspect, the object of centralisation is automatically to bundle, and to include in the diagnosis, information which is known that is distributed in the test rig system, such as the engine type, fuel type or operating mode.

User acceptance is also of major importance, in addition to technical functionality, for widespread use in the test panel. This means that user-specific aspects such as easy operability and good result presentation must be taken into account in the implementation of the diagnosis tool.

The aim of the present work can thus be subdivided into four subareas: concept development, method development, configuration and data management and result management.

In the concept phase, it is necessary to investigate how a central diagnosis system can be integrated in a test rig system. For the chosen approach, an analysis of possible bottlenecks must then be carried out, with regard to system resources, data access and system reliability, safety and security.

From the methological point of view, the most important object of this work is to develop methods for assessment of the signal quality and of the appliance check.

If necessary, appropriate enable conditions must be formulated for the methods for fault recognition. The identification and control of the enable conditions is likewise a component of method development.

It is particularly important for the fault recognition to be designed such that new methods can be incorporated in the existing diagnosis system without any problems. This also applies to the evaluation of the fault recognition. The decision logic for evaluation of the fault recognition must lead to a reliable and easily interpretable diagnosis statement, and must represent an aid for definition of the fault cause.

The configuration and the data management are important for handling and flexible use of the diagnosis system. The configuration effort must be kept as low as possible, for time and acceptance reasons.

In addition to the selection of the measurement channels to be monitored, automatic selection of the methods which can be carried out is just as important as the manual deactivation of individual methods by the user.

Appropriate data management must be designed in order to manage the diagnosis data. Visualization of the diagnosis result is likewise a component of data management. With regard to the presentation of results, care must be taken to ensure that the user is provided with the information precisely in order to make it possible to correctly interpret a fault and the corresponding fault cause.

With regard to archiving, care must be taken to ensure that the diagnosis results are stored together with the measurement data and the constraints. User actions such as deactivation of individual fault recognition methods must likewise be documented. This ensures that information relating to data quality will always be available, even for subsequent evaluation of the measurement data.

The implementation of the task elements mentioned above leads to an objective and automatic overall assessment of the test rig system. The increase in the test rig availability is achieved by appropriate reactions by the test rig personnel. At this point, automatic intervention of the diagnosis system is expressly undesirable.

The implementation of the stated tasks leads to a planned and objective quality assessment of measurement data and test rig systems. A standardised quality seal for the measurement results can be derived from this.

In order to solve the problems defined above, the method for analysis and assessment of measurement data of a measurement system is characterized in that the raw data of the measurement channel is supplied to a fault isolation stage and then to a fault classification stage, and in that a measure is then determined for the quality of the measurement data of the respective measurement channel.

One advantageous embodiment provides that in the fault isolation stage, the raw data is first of all supplied to a fault recognition stage.

A further variant provides that, after being processed in the fault isolation stage, the data is supplied to a fault identification stage within the fault classification stage.

The raw data is advantageously recorded at the correct time and is supplied as required to the fault isolation stage and to its fault recognition stage.

In this case, it is furthermore advantageously possible to provide that the fault isolation stage, or its fault recognition stage, carries out a high-frequency signal analysis on the raw data.

According to a further advantageous inventive feature, the method is characterized in that the current measure for the quality of the measurement data of any desired measurement channel is compared with a predeterminable limit value, whose undershooting is indicated.

In any case, it is also possible to provide that a chronological record is generated over the profile of the measures for the quality of the measurement data, and is indicated.

One preferred embodiment of the invention provides that the current status of the fault isolation stage is read and is indicated.

Operating modes of stationary fault recognition, cyclic online fault recognition (ZOF) and measurement-synchronous fault recognition (MSF) are advantageously provided.

In this case, one particularly advantageous variant provides that the operating modes can be provided individually or in parallel, in particular the cyclic online fault recognition (ZOF) and the measurement-synchronous fault recognition (MSF).

In order to solve the problem described above, the apparatus for analysis and assessment of measurement data of a measurement system, comprising a unit for the assessment of the measurement data of at least one measurement channel of the test rig at any desired time on the basis of a plurality of predeterminable criteria, is characterized by an input for the raw data of the measurement channel, a unit in which a fault isolation stage and then a fault classification stage are implemented, and an output for a measure for the quality of the measurement data of the respective channel.

One embodiment is advantageously characterized in that a fault recognition stage with an input for the raw data is implemented in the fault isolation stage.

A further advantageous embodiment of the invention is characterized in that the output of the fault isolation stage is connected to an input of a fault recognition stage which is characterized in that implemented within the fault classification stage.

It is also possible to provide that a cyclic buffer is provided for recording the raw data at the correct time and is connected to the input of the fault isolation stage and/or its fault recognition stage, for checking by this stage or these stages.

If need be, it is also possible to provide that a high-frequency signal analysis device for the raw data is provided in the unit with the fault isolation stage and its fault recognition stage.

A further embodiment of the invention is characterized in that a freely selectable limit value for the measure for the quality of the measurement data of any desired measurement channel is stored, and in that comparison logic is provided which compares the current measure with the limit value and signals its undershooting, with this signal preferably driving an indication device.

According to a further variant of the invention, a memory area which can be read can be provided for a chronological record over the profile of the measures for the quality of the measurement data.

Finally, it is also possible to provide that visualization is provided for the current status of the fault isolation stage, and can be called up.

Signal-based measurement data diagnosis for assessment and documentation of the measurement quality on engine test rigs has been developed using statistical and physical methods. The method comprises the areas of signal quality, plausibility and appliance check and it has been possible to implement this as a virtual appliance in the Puma Open test rig system. The method development in the areas of signal analysis and appliance testing as well as approaches for non-stationary fault recognition were in this case primary factors in the work, since no useable approaches were available in these areas.

The method worked out for assessment of the signal quality resulted from a combination of statistical hypotheses tests with the analysis of the signal-to-noise ratio. Since statistical methods are predicated on independent and normally distributed random samples, these constraints had to be checked by means of a correlation analysis and by position and adaptation tests. The actual assessment of the signal quality is then carried out by means of the signal-to-noise ratio and by quality control charts. At the end, all the result elements are combined by means of logic developed specifically for this purpose, to form signal quality as the overall result.

During the course of the present work, it was also for the first time possible to propose an observer system for non-stationary fault recognition on the basis of neural nets (ARTMAP), and to implement this in a prototype. The trial was carried out offline using simulated NEDC exhaust-gas test cycles. After just a single presentation of a new data pattern, the observer system was in this case able to learn this. When a similar pattern was presented again, corresponding classification took place, which led to good results for the prediction of the expected target variable.

A new mathematically-based method has been developed for the automatic overall evaluation of the fault recognition, by means of which it has been possible to feed back the result of the fault recognition to the observed measurement signals. A characteristic variable (the method separation sharpness) had to be defined for this purpose, and determines how well a method can identify faulty measurement channels. The combination of stochastics and method separation sharpness leads to the result of fault isolation. The combination of fault identification and fault classification then resulted, by means of a debouncing algorithm, in a clear statement relating to the fault significance.

The development of the evaluation logic and the introduction of the fault debouncing led to a clear fault representation and documentation. In this context, the quality seal which is introduced for tested measurement data is particularly important. This seal is attached to all the tested measurement data. This allows reliable, redundant data use. In addition, the manner in which the data is tested is transparently and reproducibly documented.

The invention will be explained in more detail in the following description, with reference to the attached drawings.

In this case,

FIG. 1 shows a diagram of the degree of automation in the present application.

FIG. 2 shows, schematically, the currently normal process for experiment planning.

FIG. 3 shows, schematically, a normal limit-value check,

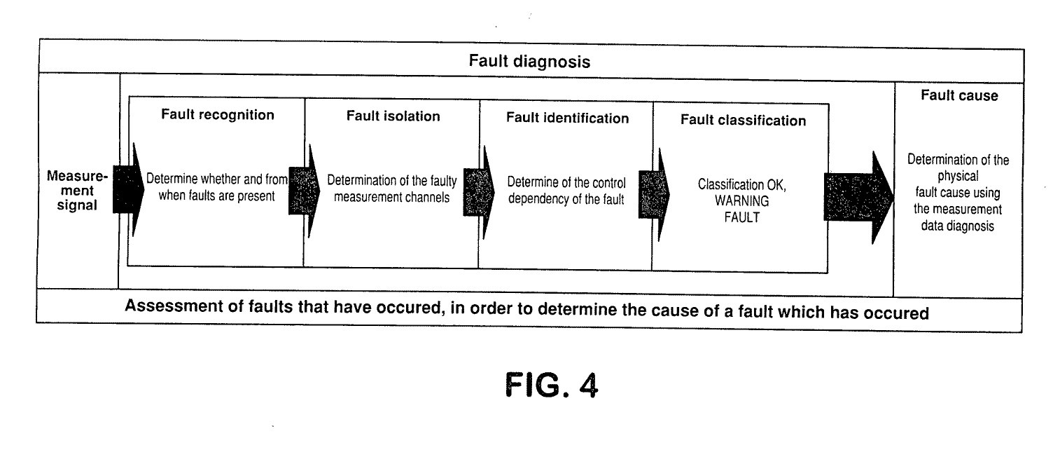

FIG. 4 shows a schematic illustration of the procedure for data diagnosis according to the invention,

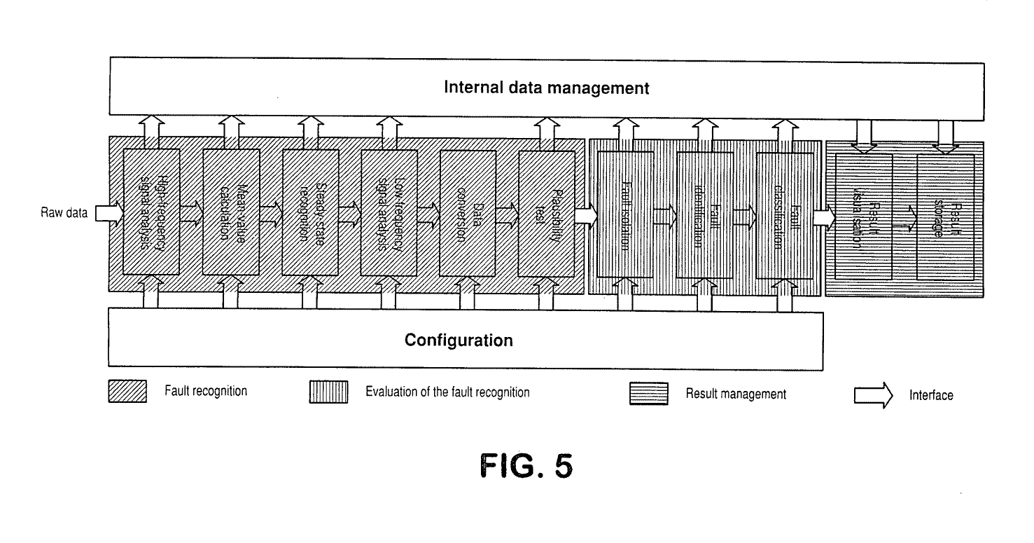

FIG. 5 shows a schematic illustration of the interaction of the main components of the data diagnosis according to the invention,

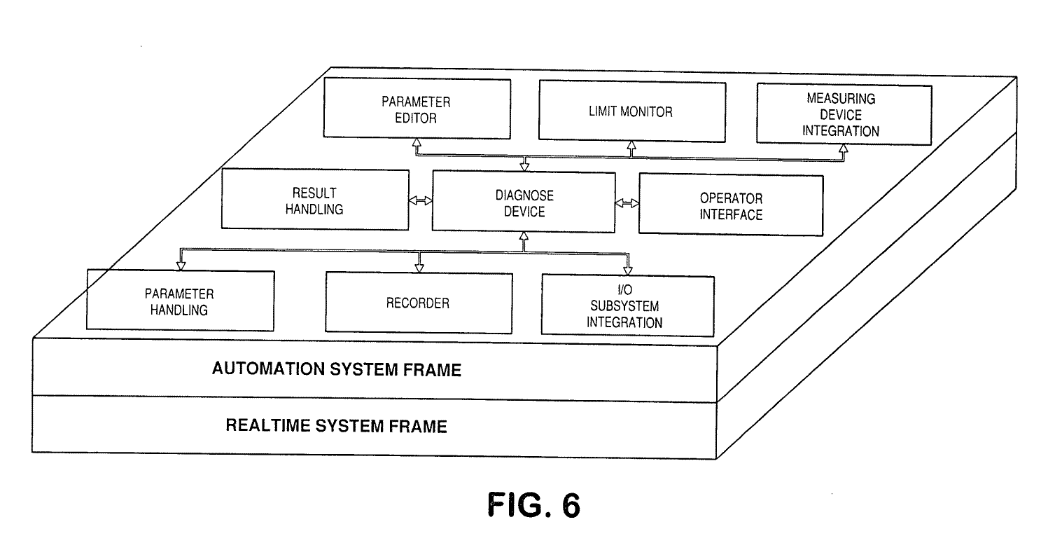

FIG. 6 shows the concept for inclusion of the measurement data diagnosis in a test rig system,

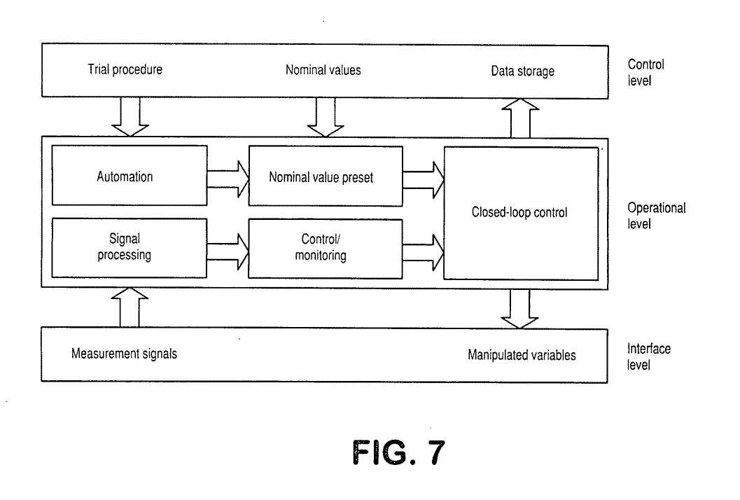

FIG. 7 shows the function of the operational level of a real test rig system,

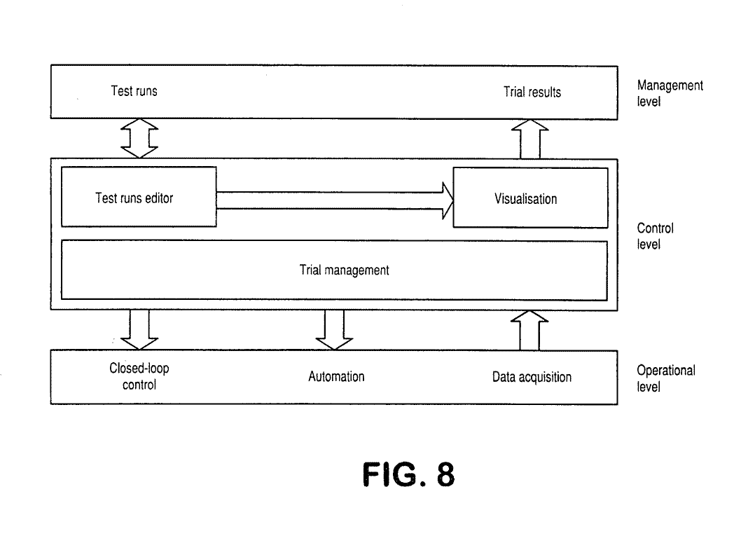

FIG. 8 shows that for the control level,

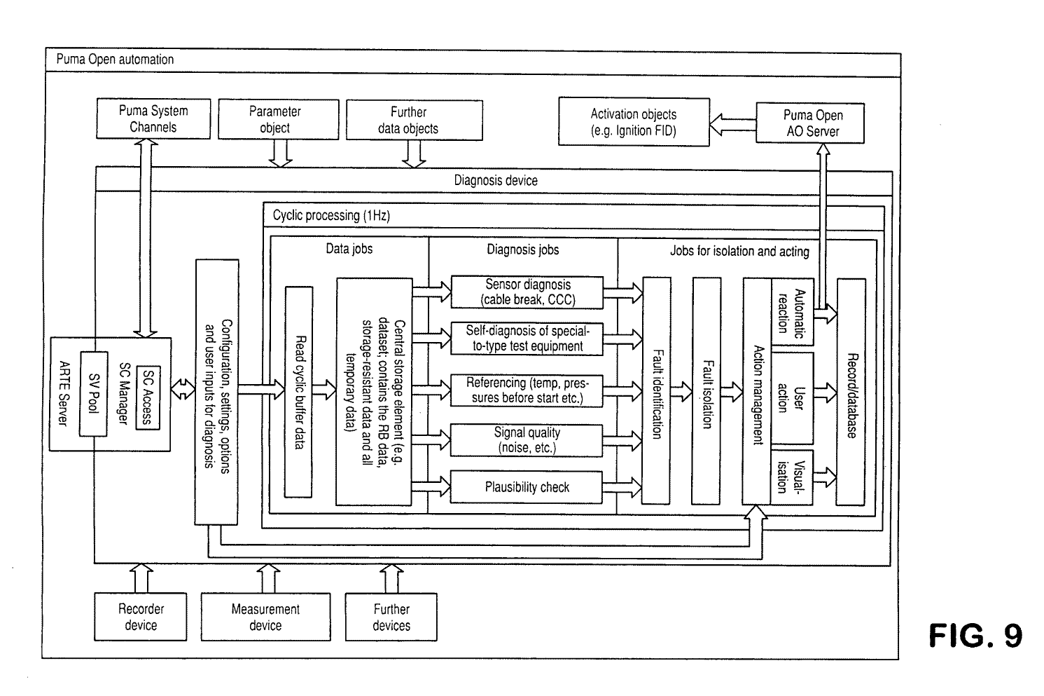

FIG. 9 shows a scheme relating to the implementation of the test rig diagnosis in the framework,

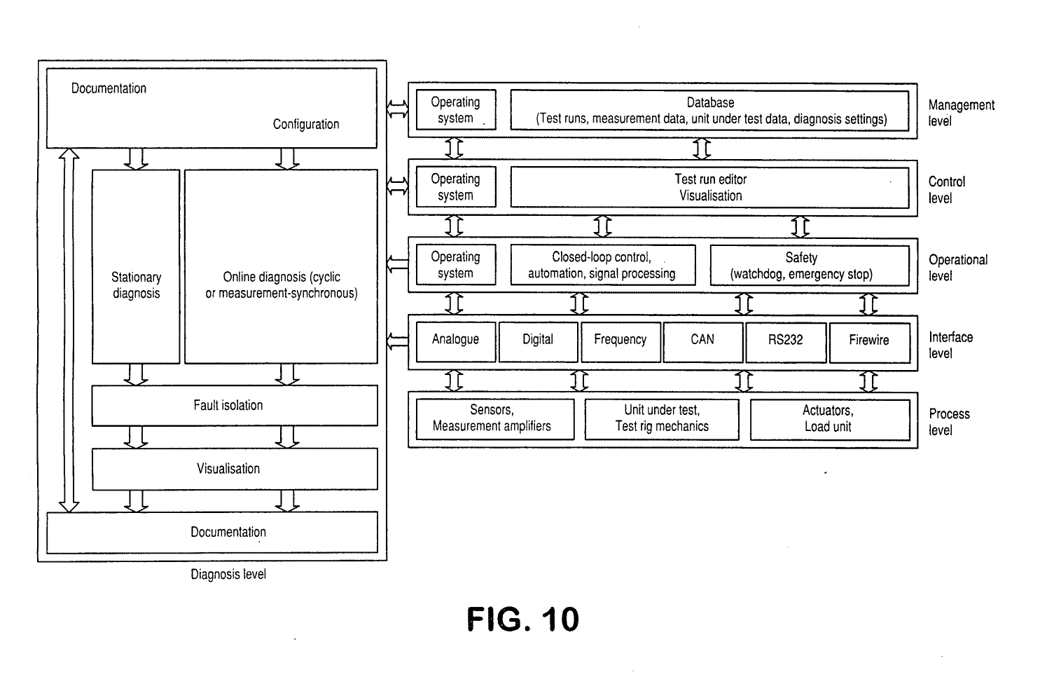

FIG. 10 illustrates the basic logic structure of the test rig diagnosis,

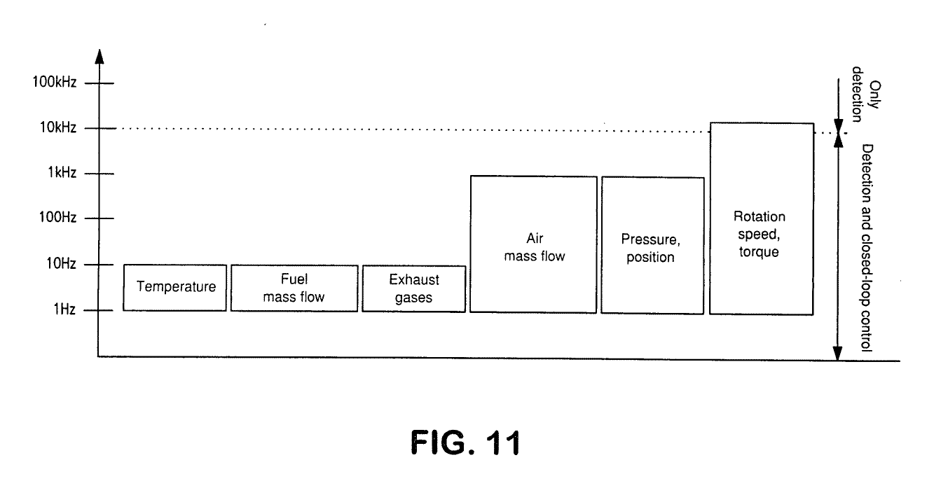

FIG. 11 shows typical detection rates for analogue and digital signals,

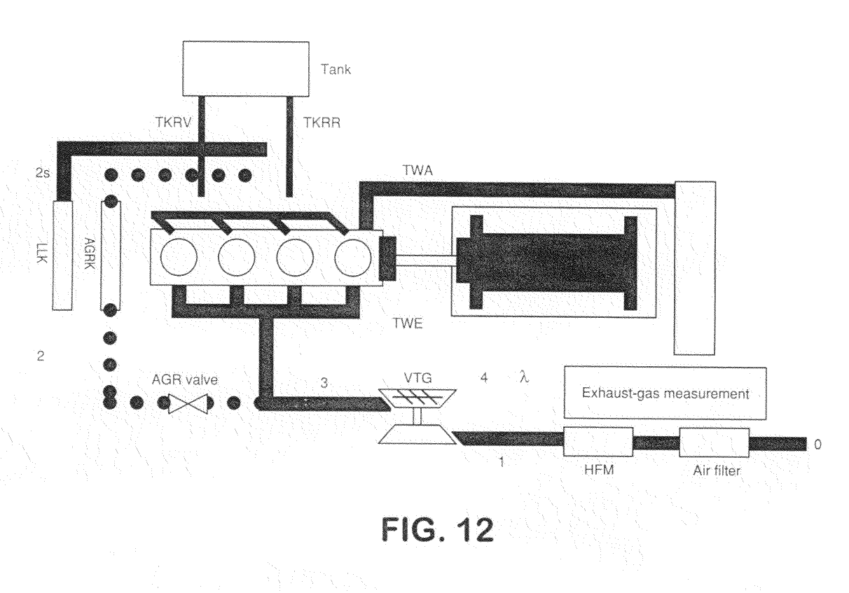

FIG. 12 shows the typical measurement points during a test rig for turbodiesel engines,

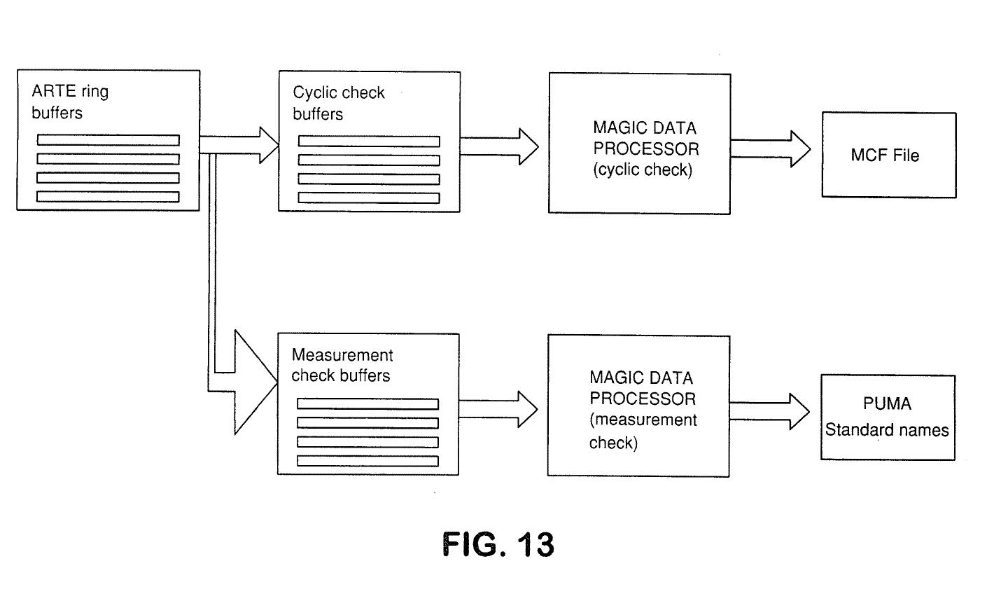

FIG. 13 shows a schematic illustration of the cache memory for the cyclic and measurement-synchronous fault recognition,

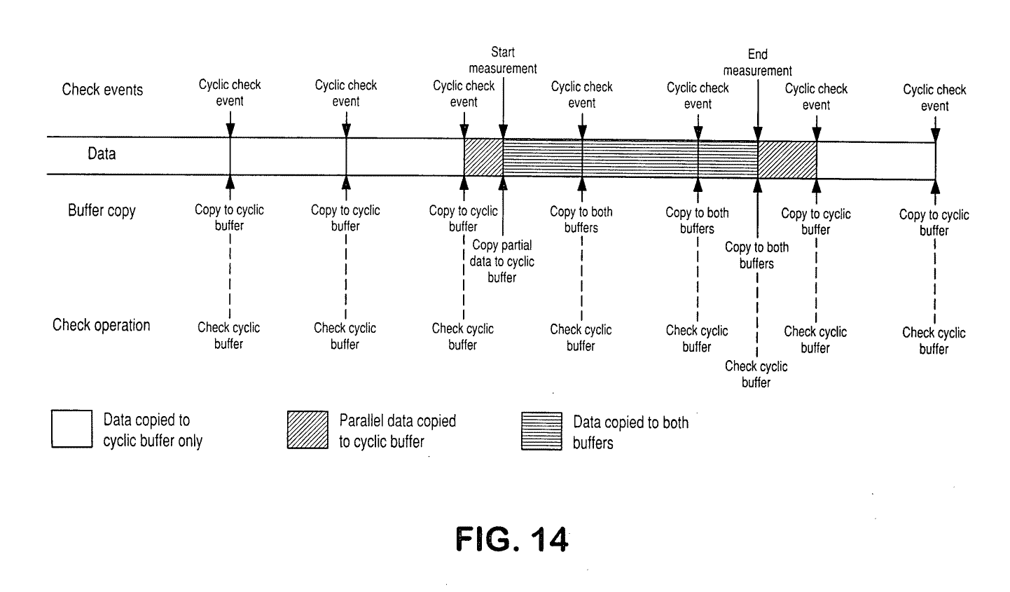

FIG. 14 shows the event manager,

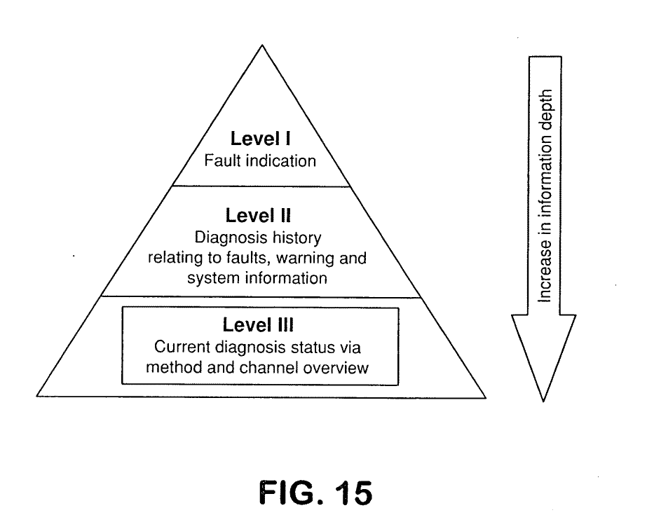

FIG. 15 illustrates the pyramid structure for visualization,

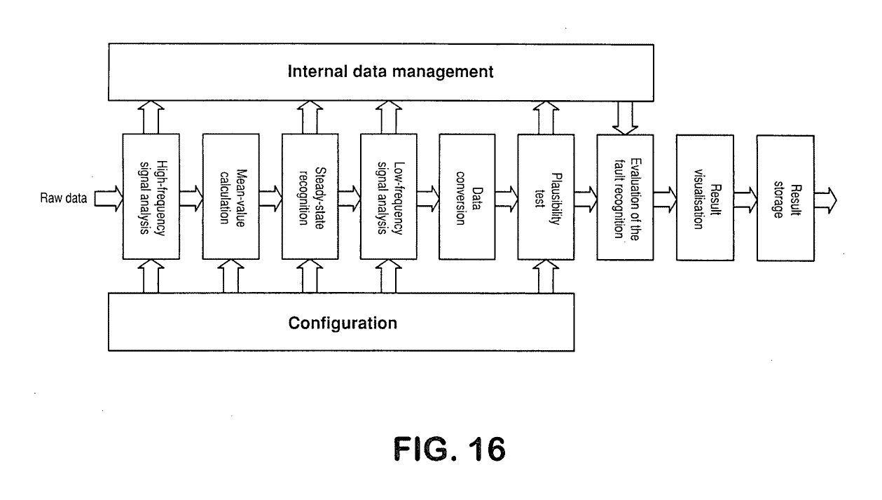

FIG. 16 shows a schematic illustration of the overall process for data diagnosis according to the present invention,

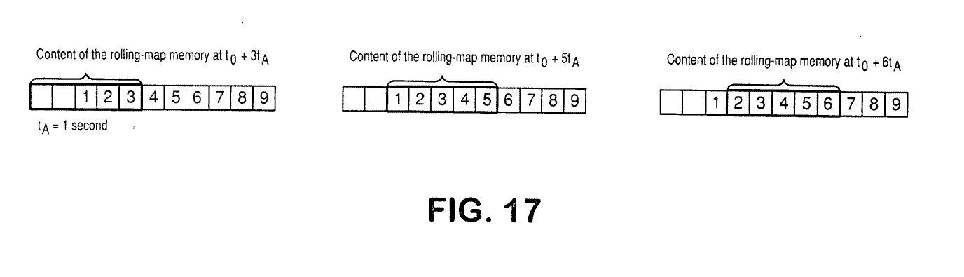

FIG. 17 shows the rolling-map memory scheme,

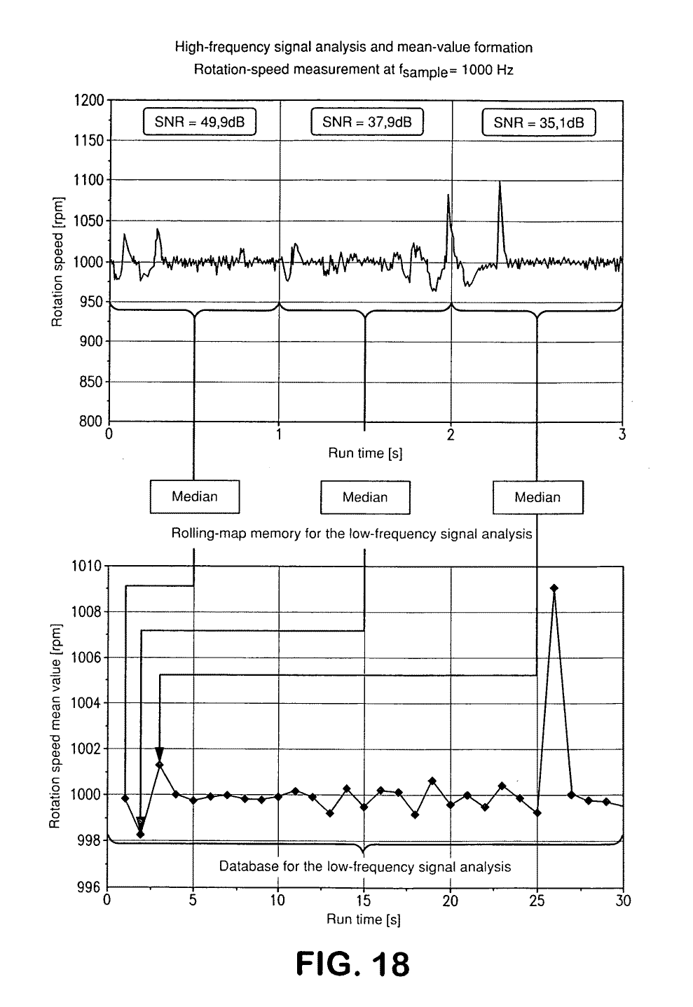

FIG. 18 shows an illustration, for example for the processing of the raw data using the example of the rotation speed,

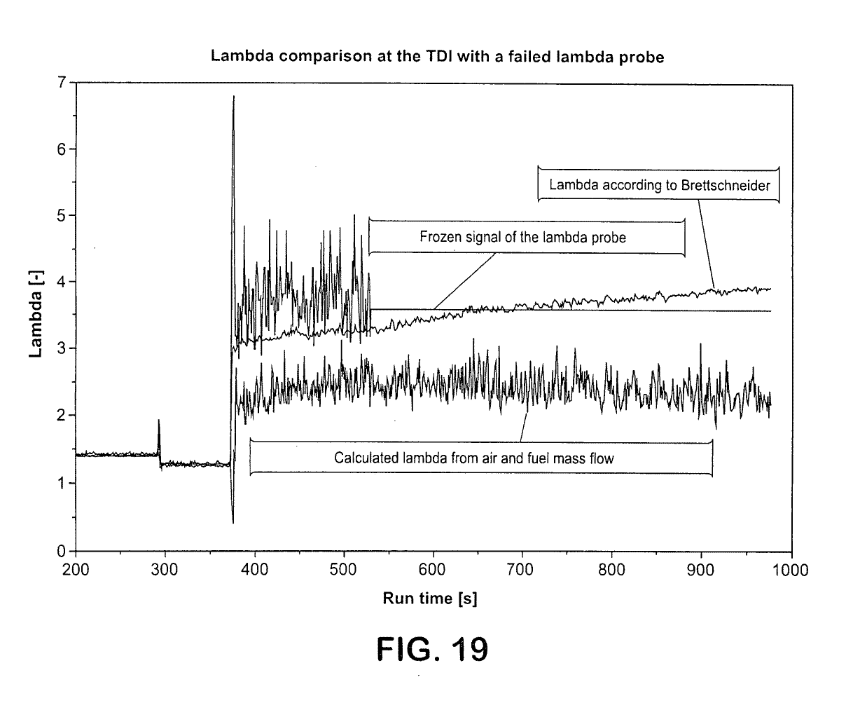

FIG. 19 shows an example for fault recognition by means of the antifreeze method,

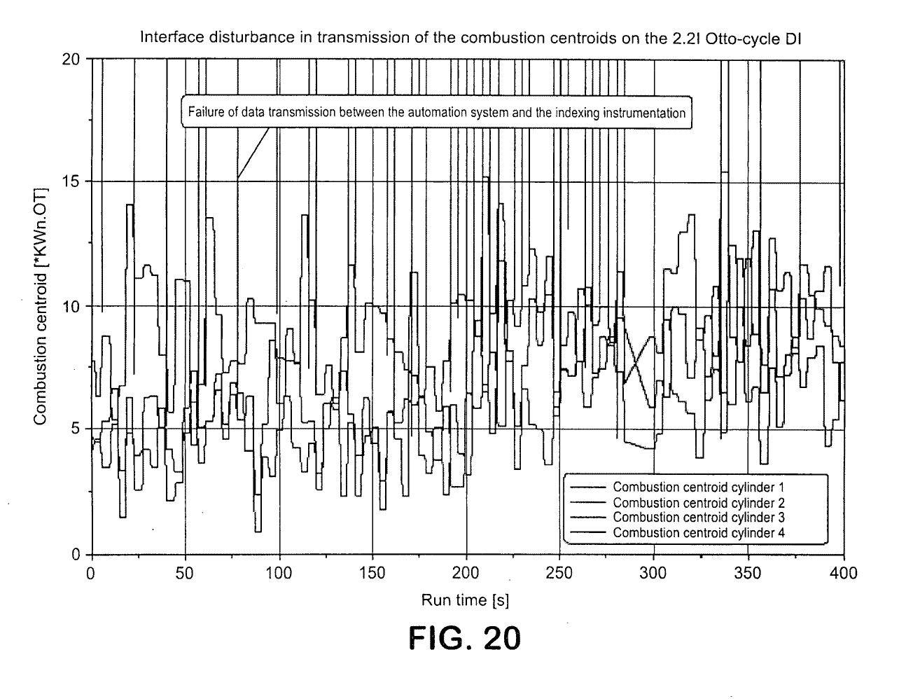

FIG. 20 shows an example of recognition in the event of data transmission failure,

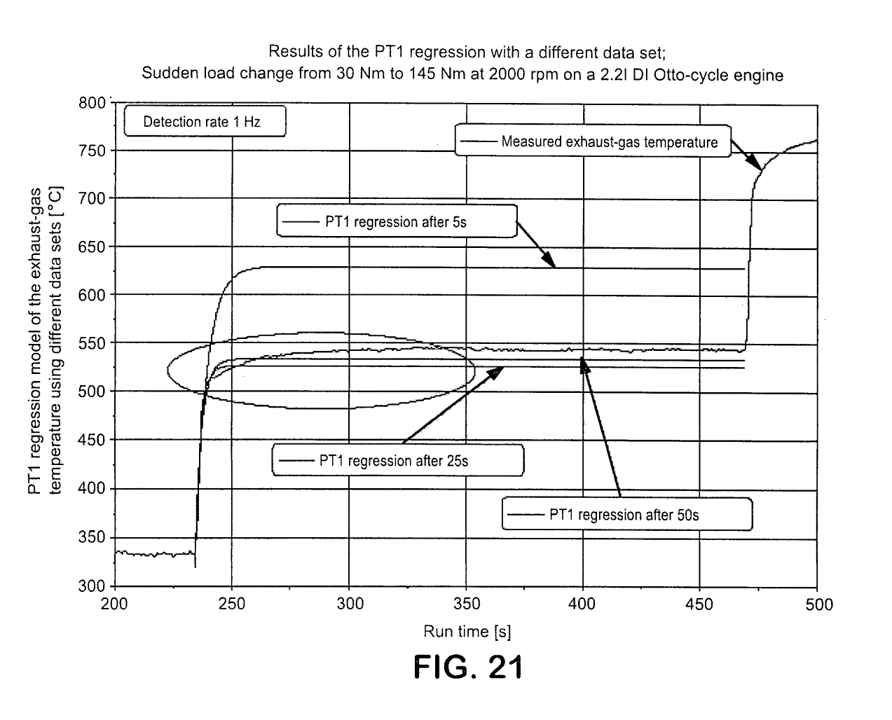

FIG. 21 shows a diagram with the result of PT1 regression for the exhaust-gas temperature in the case of sudden load change of a unit under test,

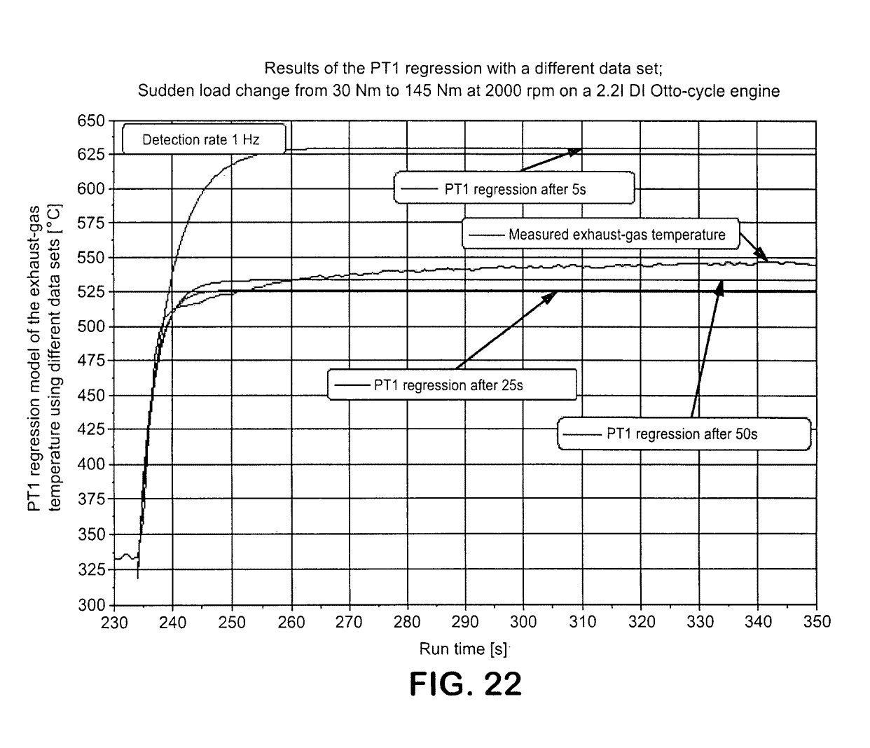

FIG. 22 shows a result of the same method but with a different dataset,

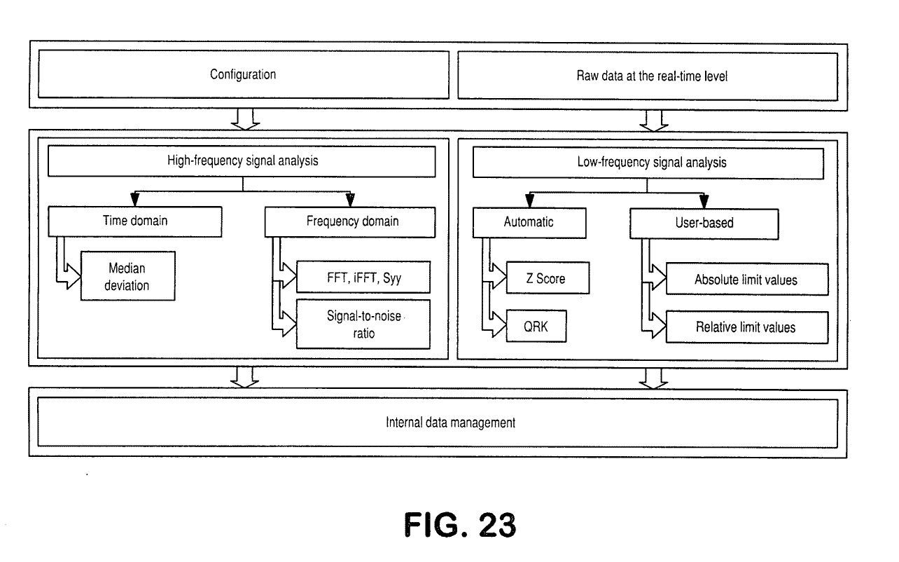

FIG. 23 shows a schematic illustration of different paths for assessment of the signal quality,

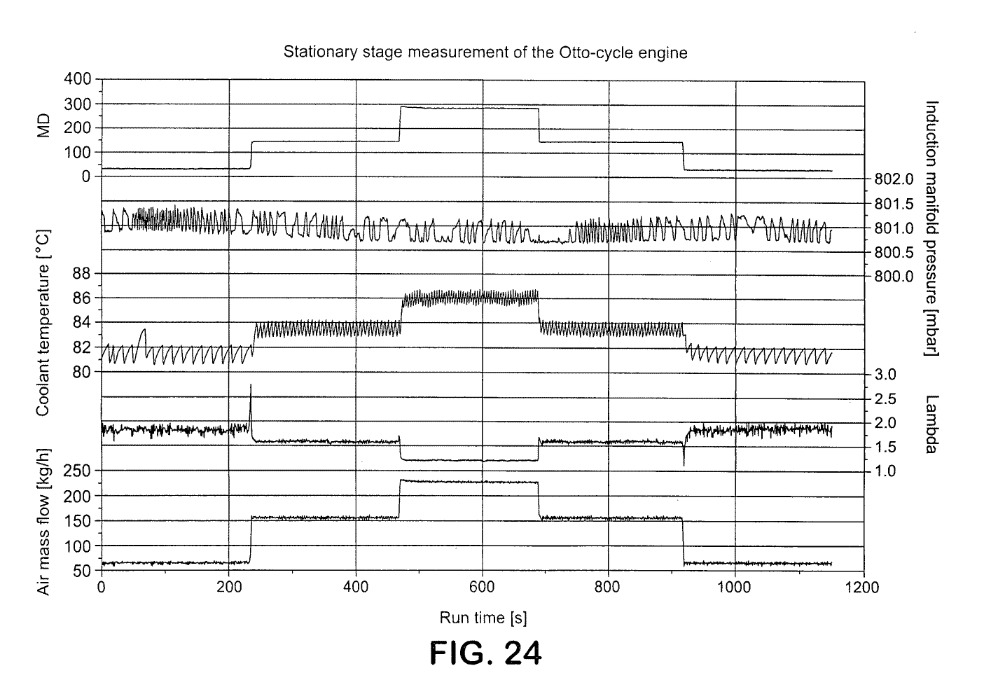

FIG. 24 shows a diagram relating to a stationary stage measurement on a unit under test for determining a practicable signal-to-noise ratio,

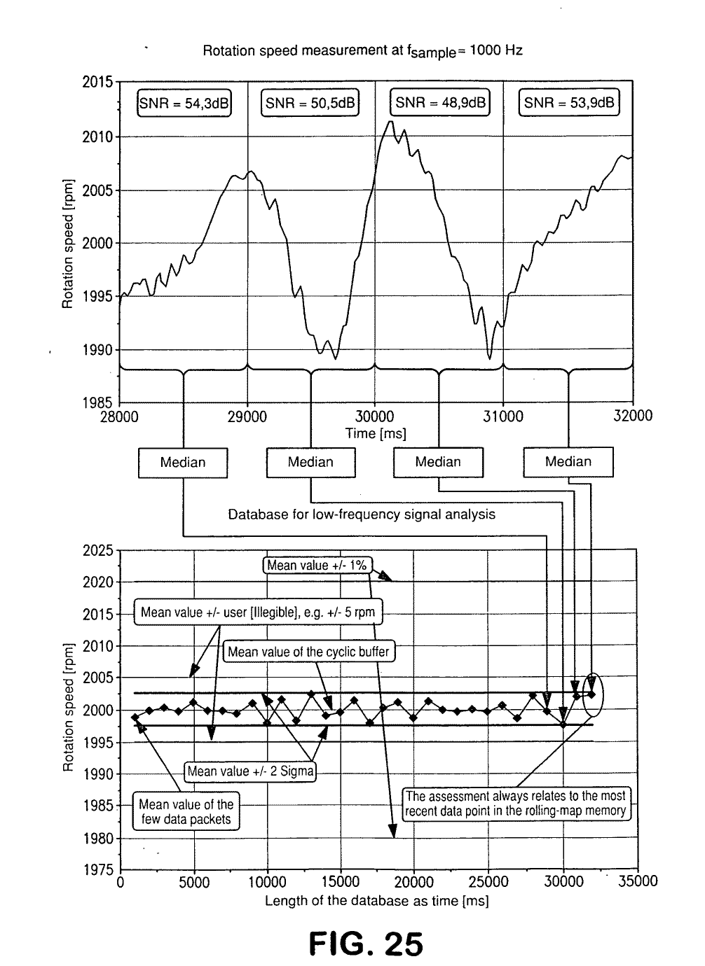

FIG. 25 explains the formation of the database from the real-time data for the low-frequency signal analysis,

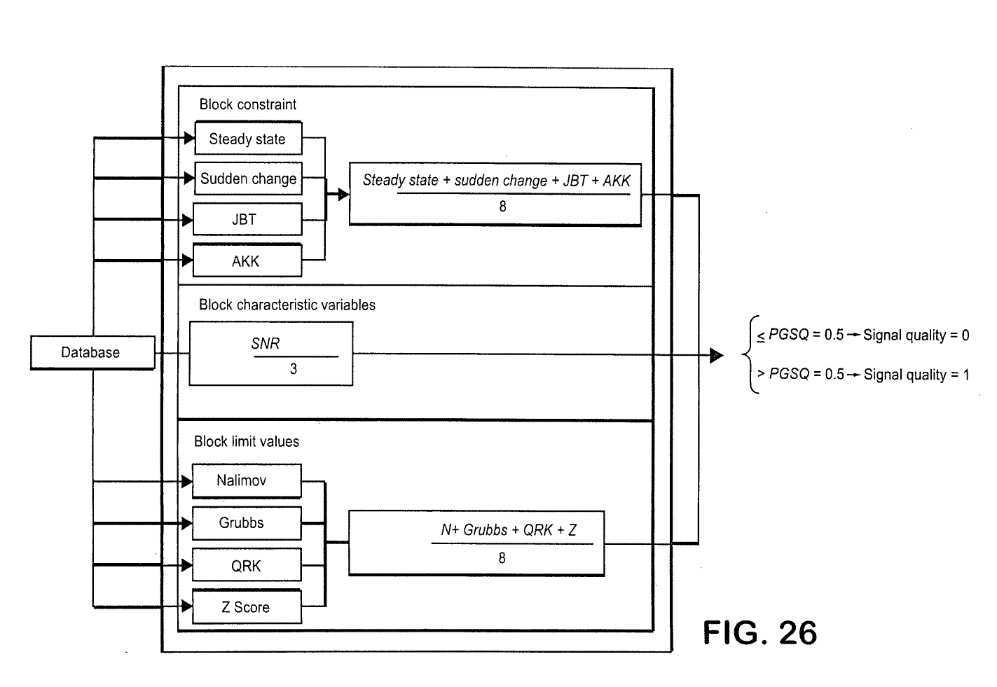

FIG. 26 shows, schematically, the logic for determination of the signal quality,

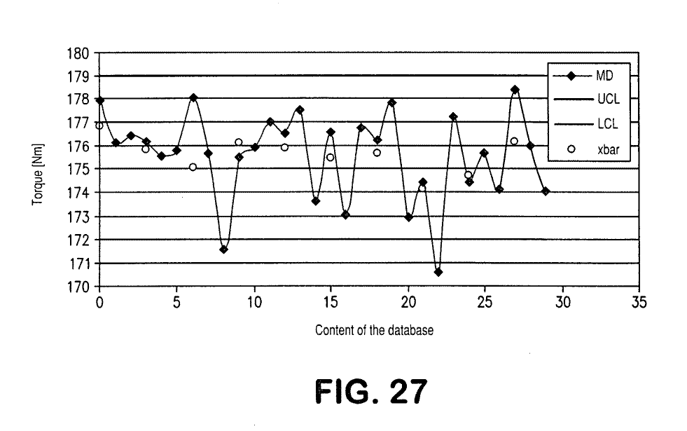

FIG. 27 is a diagram of a mean-value quality control chart, using the example of a rotation-speed measurement,

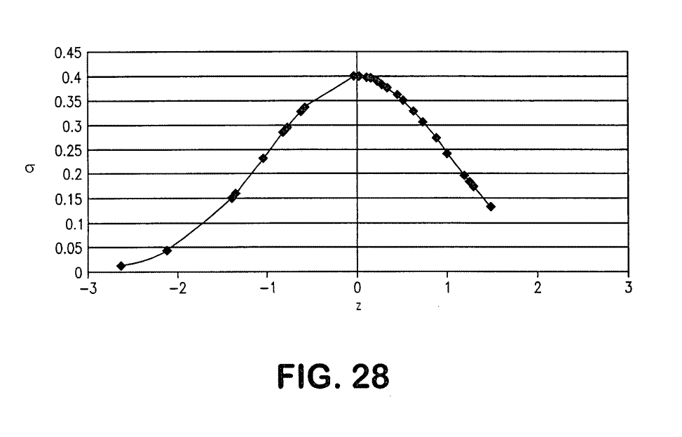

FIG. 28 shows the distribution function of the database for the example shown in FIG. 27,

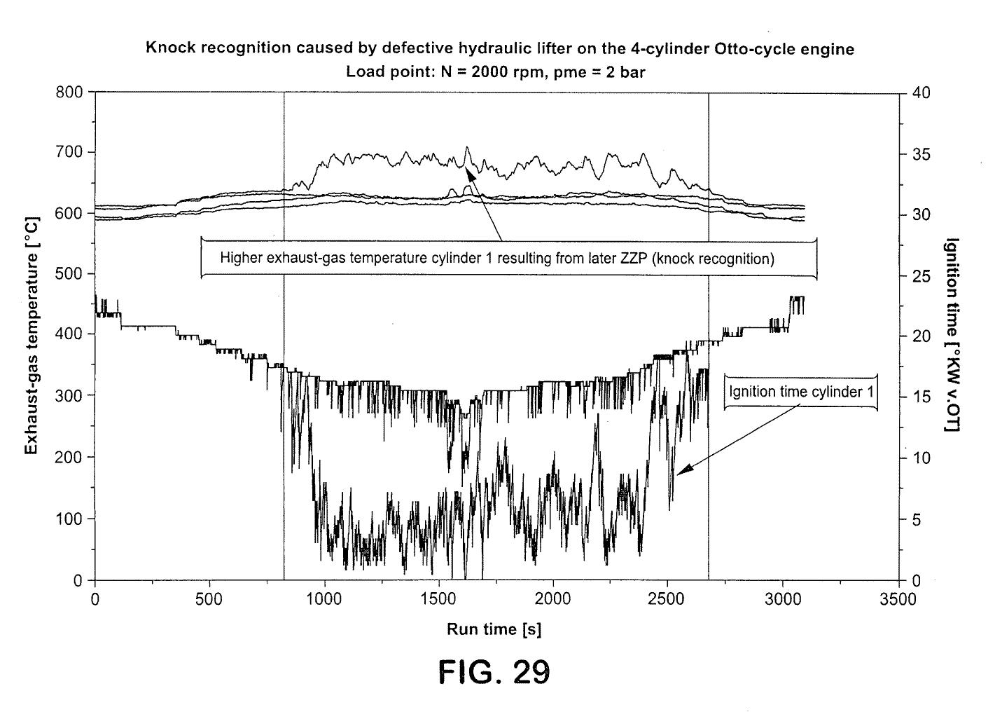

FIG. 29 is a diagram for fault recognition by means of median comparison using the example of knock recognition,

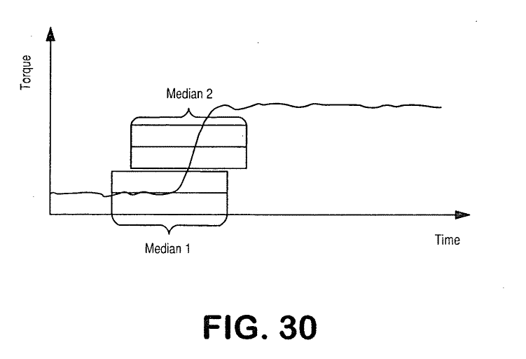

FIG. 30 shows the scheme of operating point change recognition by median calculation,

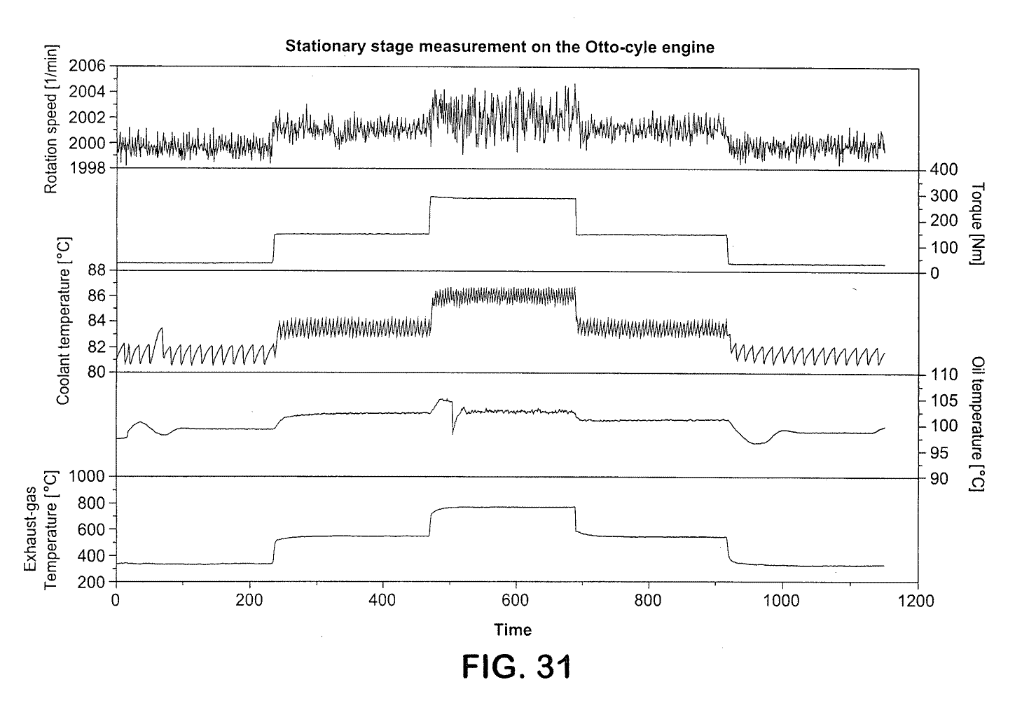

FIG. 31 is a diagram of a stationary stage measurement of a unit under test,

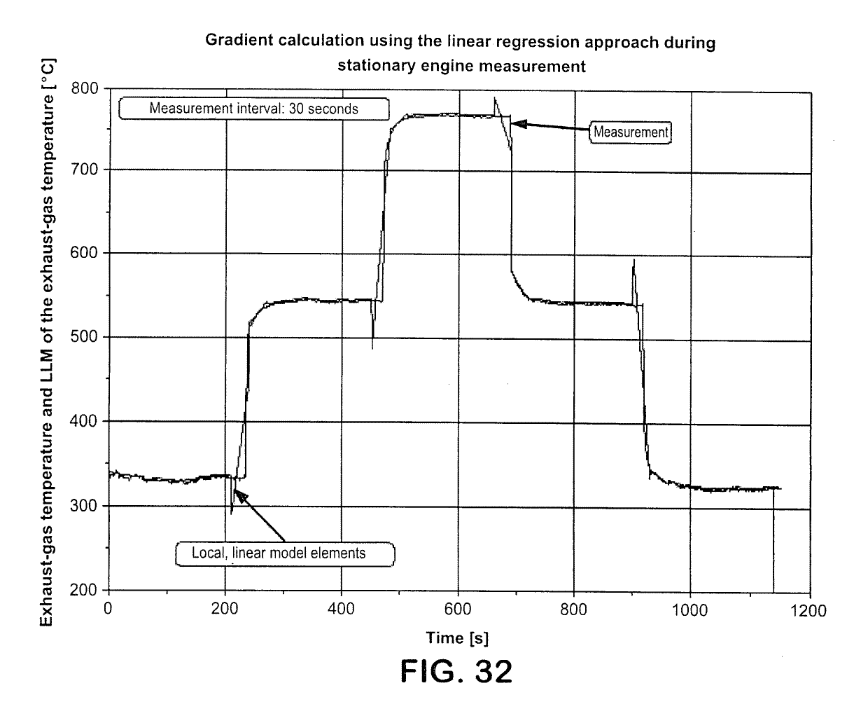

FIG. 32 is a diagram of a gradient calculation with linear regression during a stationary stage measurement,

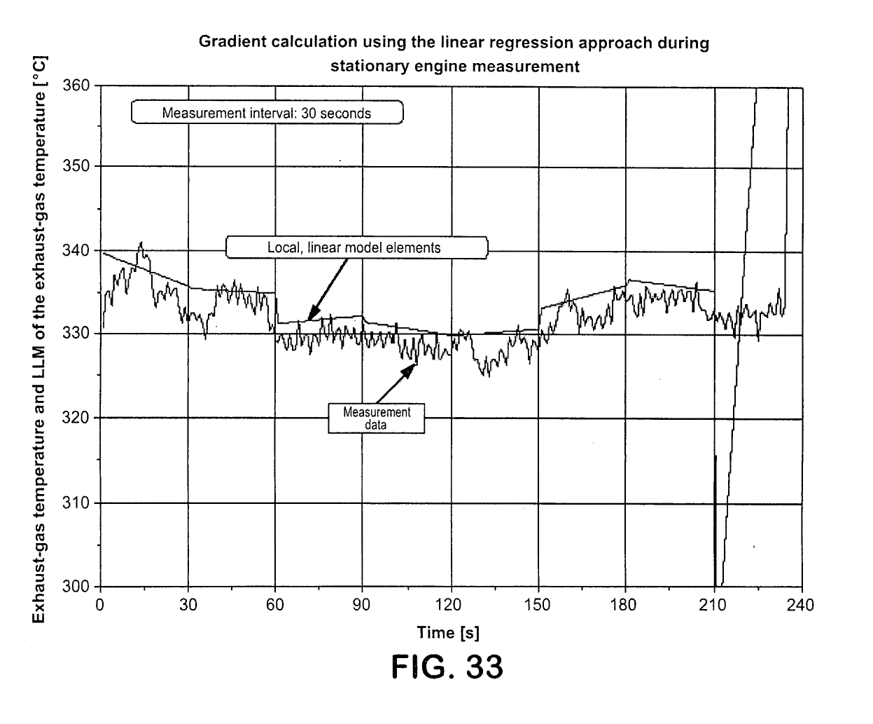

FIG. 33 shows a detail from FIG. 32 on an enlarged scale,

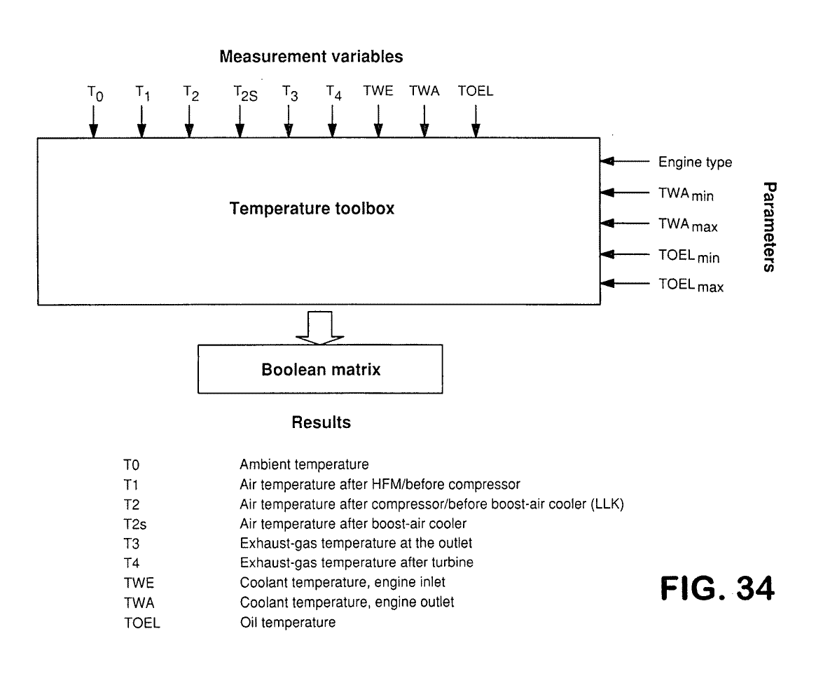

FIG. 34 shows, schematically, the configuration of the temperature toolbox for plausibility determination,

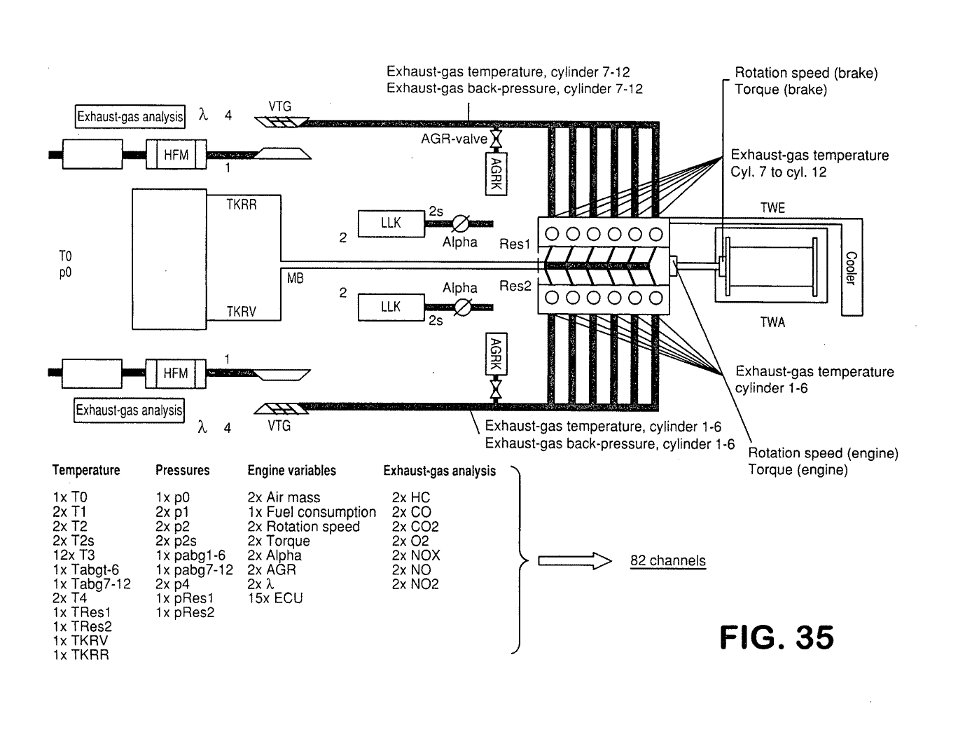

FIG. 35 is an illustration of a measurement point plan for a specific unit under test,

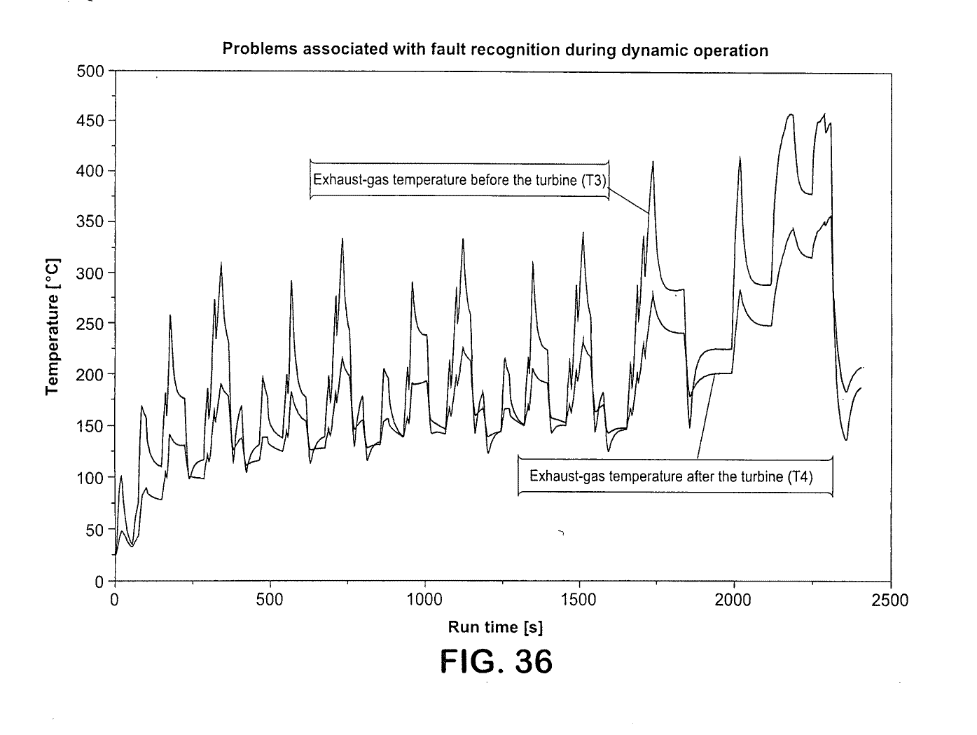

FIG. 36 shows a diagram relating to the problems of fault recognition with dynamic operating response,

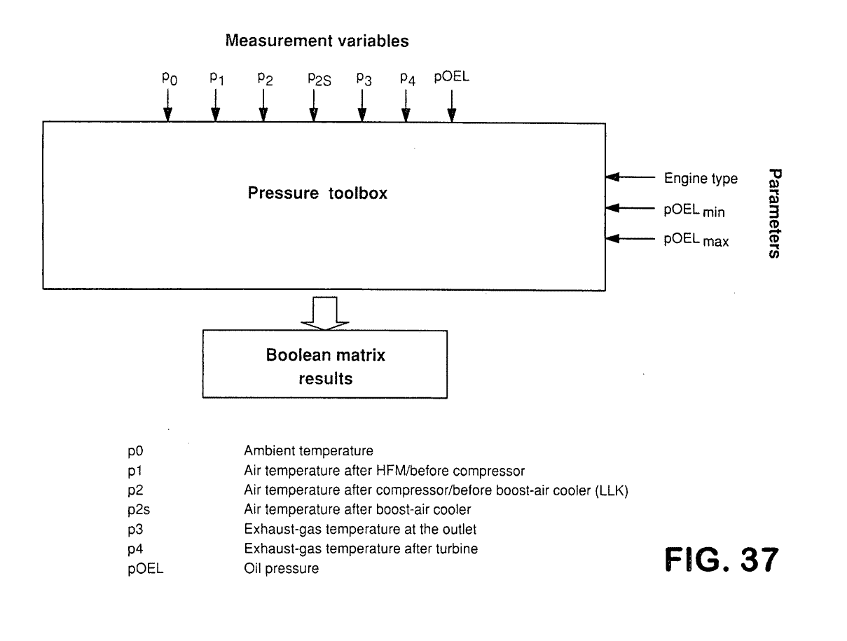

FIG. 37, analogously to FIG. 34, shows the configuration of the pressure toolbox for plausibility determination,

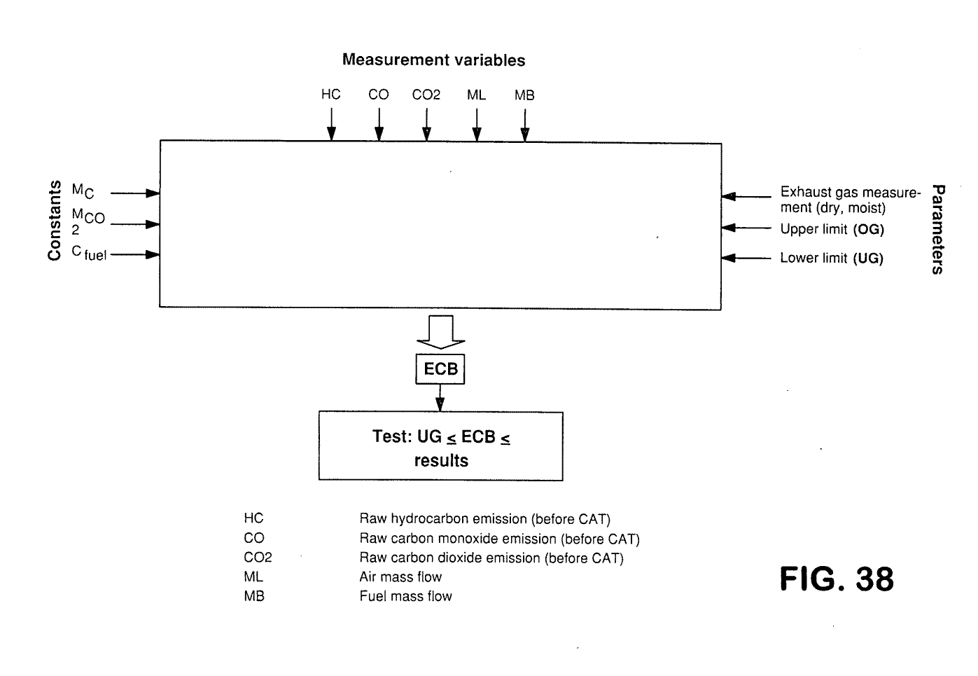

FIG. 38 shows, schematically, the C-balance or exhaust-gas toolbox,

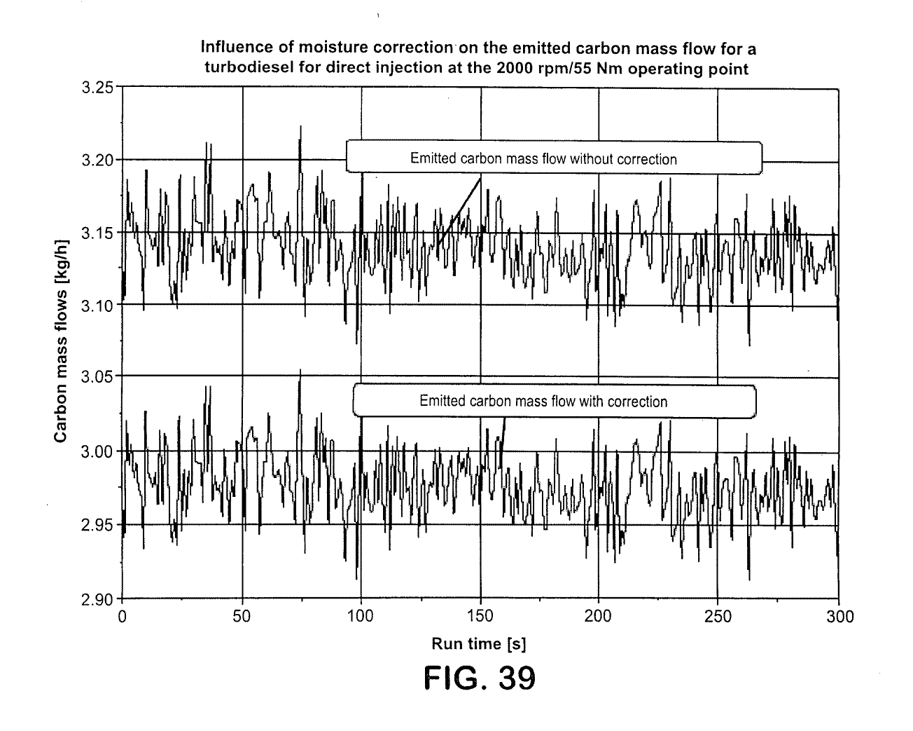

FIG. 39 is a diagram showing the influence of moisture correction,

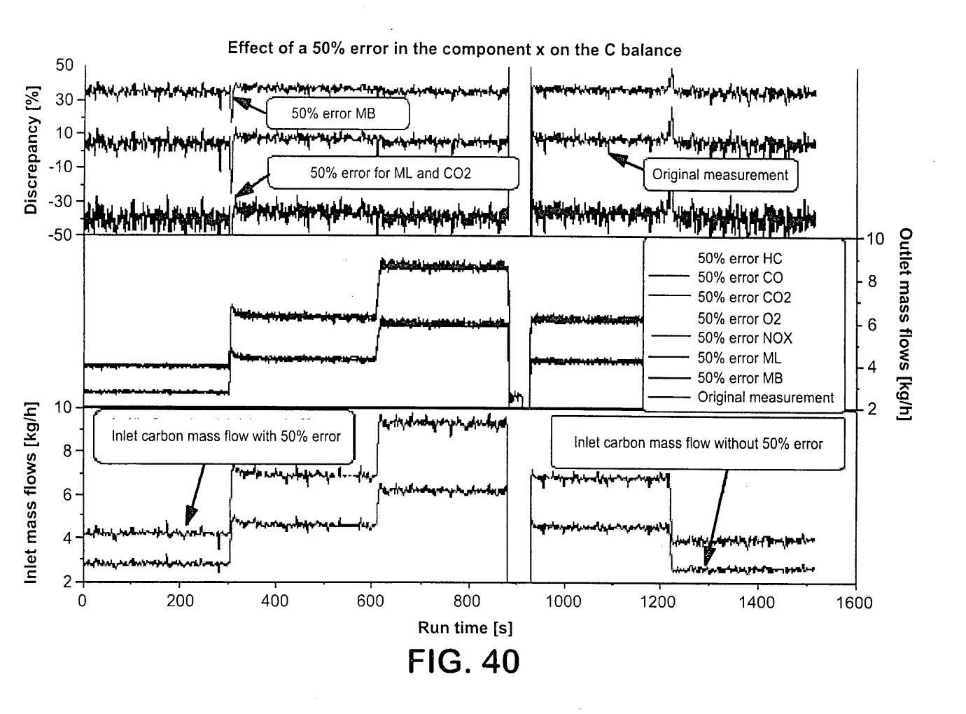

FIG. 40 shows a diagram relating to the determination of the effect of different faults on the C-balance,

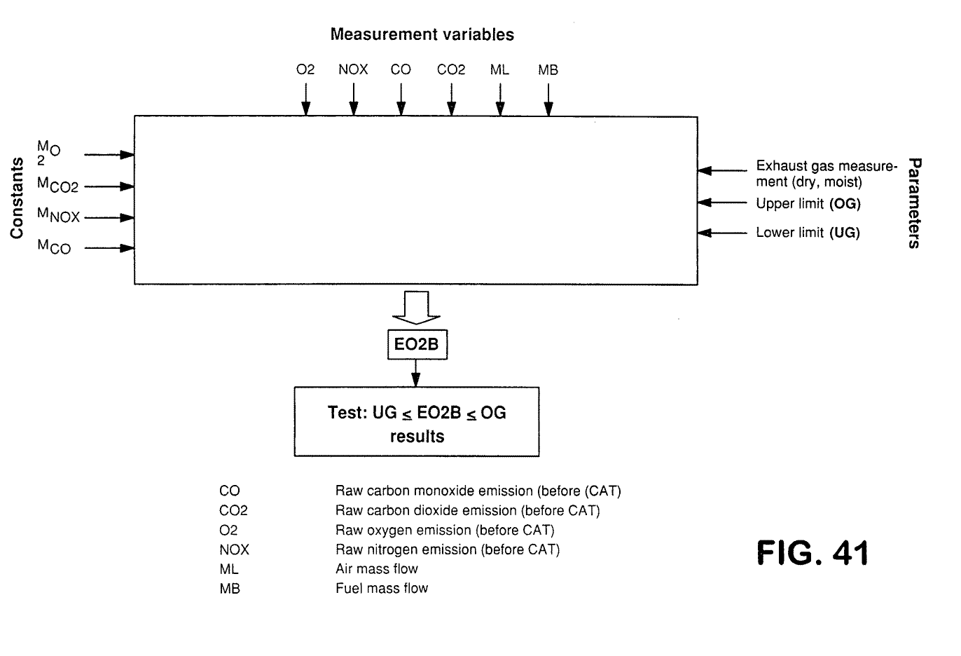

FIG. 41 shows, schematically, the O2 balance toolbox,

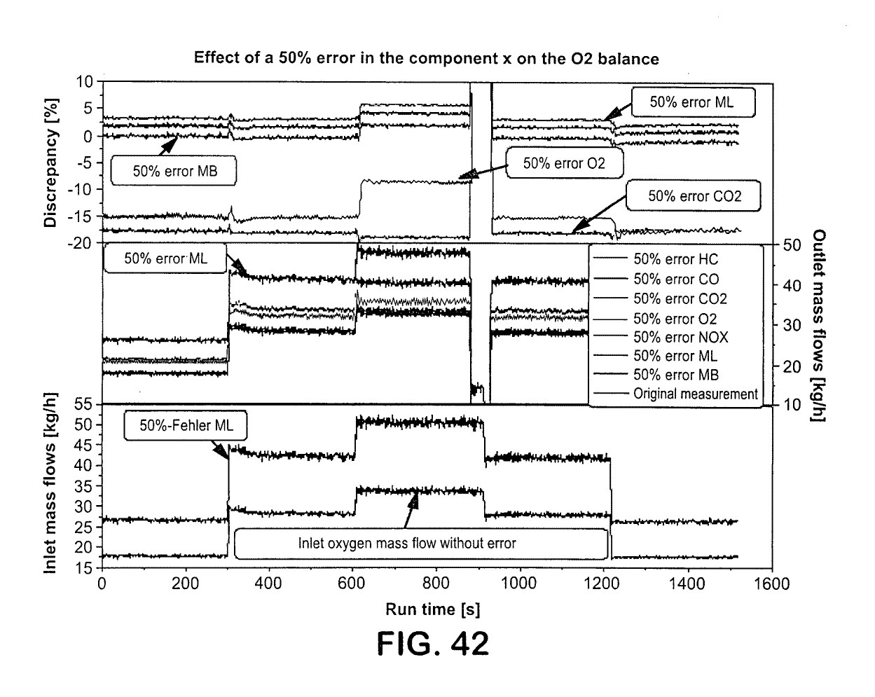

FIG. 42 shows a diagram relating to the determination of the effect on different faults on the O2 balance, in a similar manner to FIG. 40,

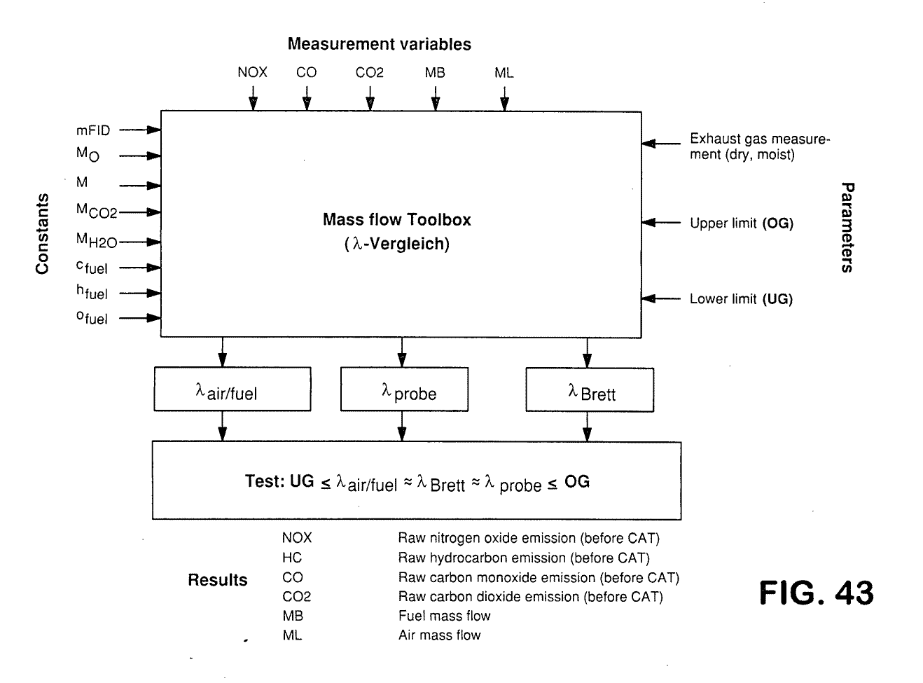

FIG. 43 shows, schematically, the lambda toolbox,

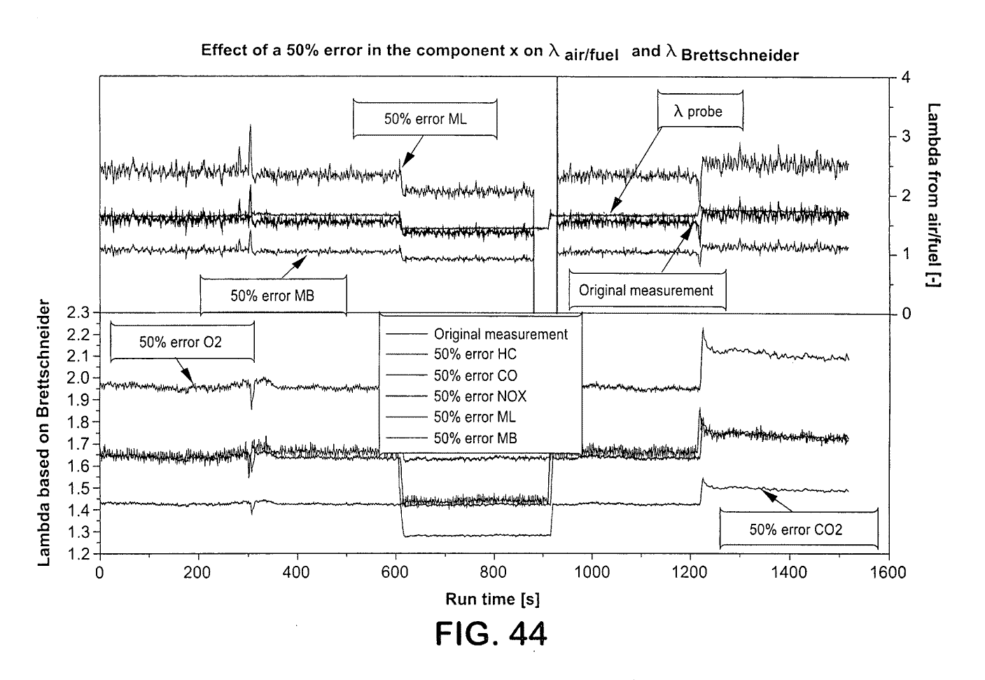

FIG. 44 shows a diagram relating to the determination of the effect of various faults on the lambda determination,

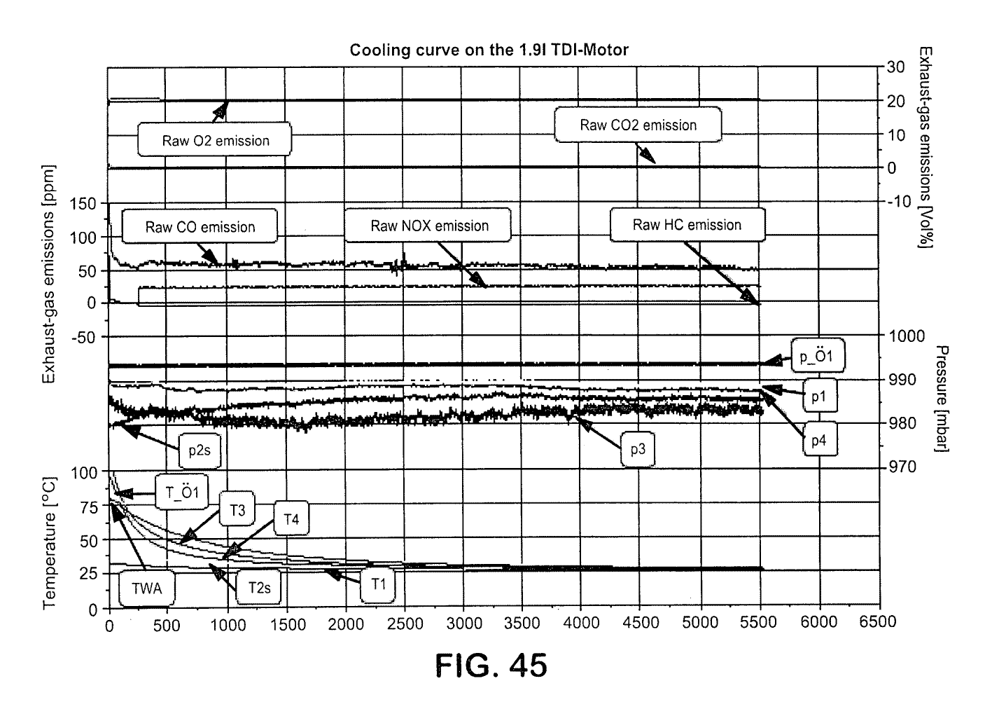

FIG. 45 is a diagram showing the cooling curves of a unit under test,

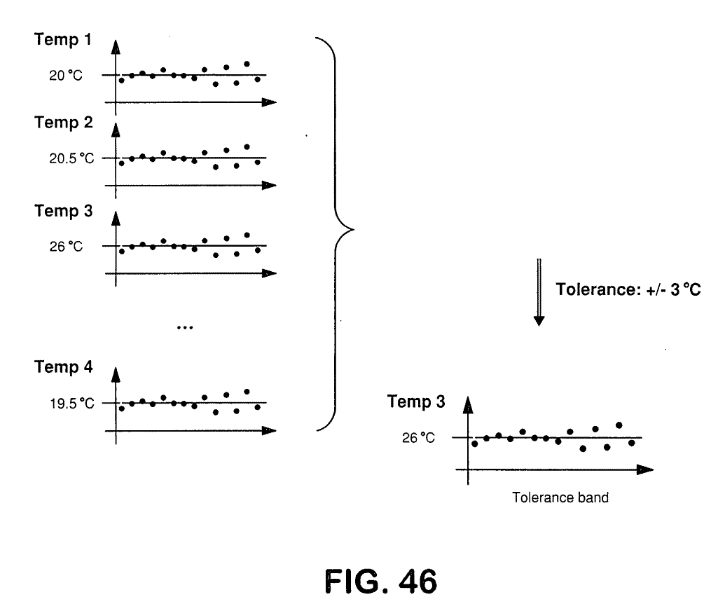

FIG. 46 shows a value comparison with the unit under test stationary, with median comparison,

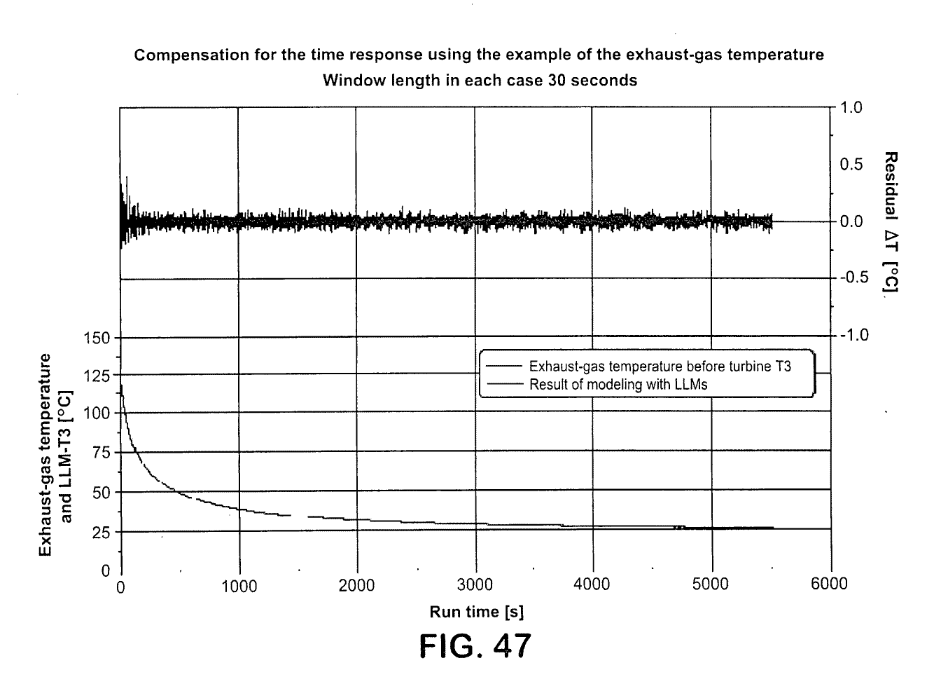

FIG. 47 shows an illustration relating to the compensation for the timing response using the example of the exhaust-gas temperature,

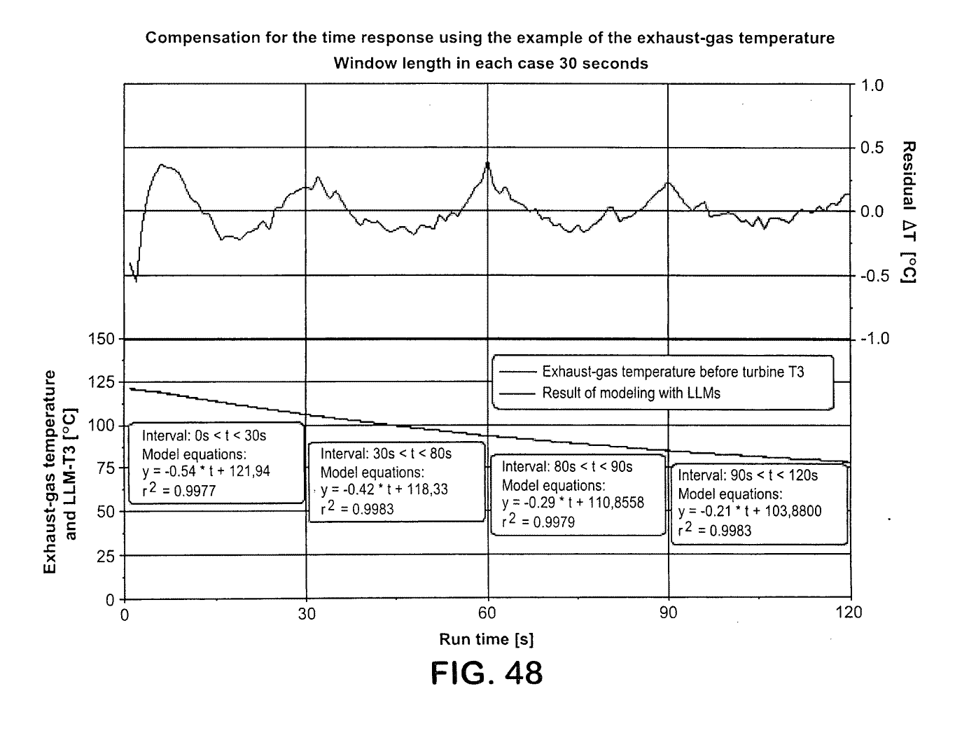

In this context FIG. 48 shows the characteristic variables of individual local, linear models,

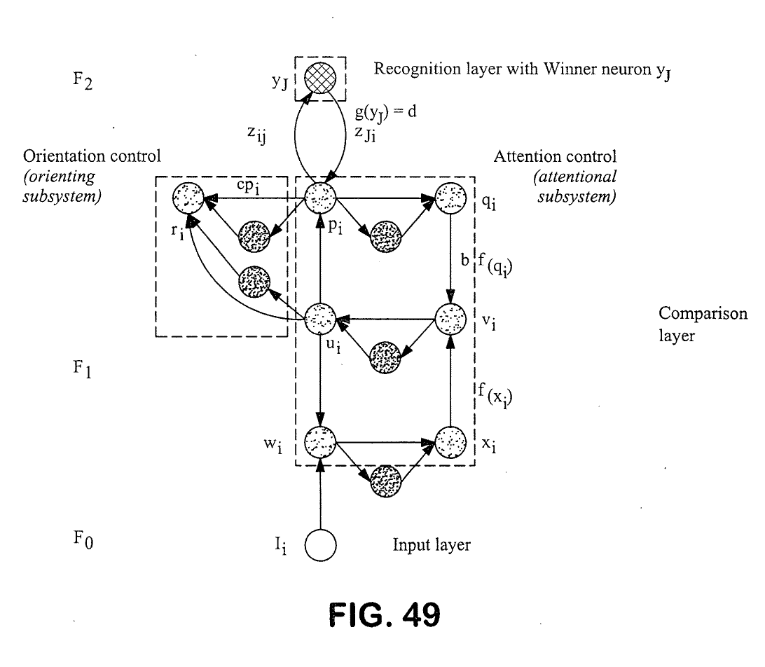

FIG. 49 shows a section through an ART-2 network,

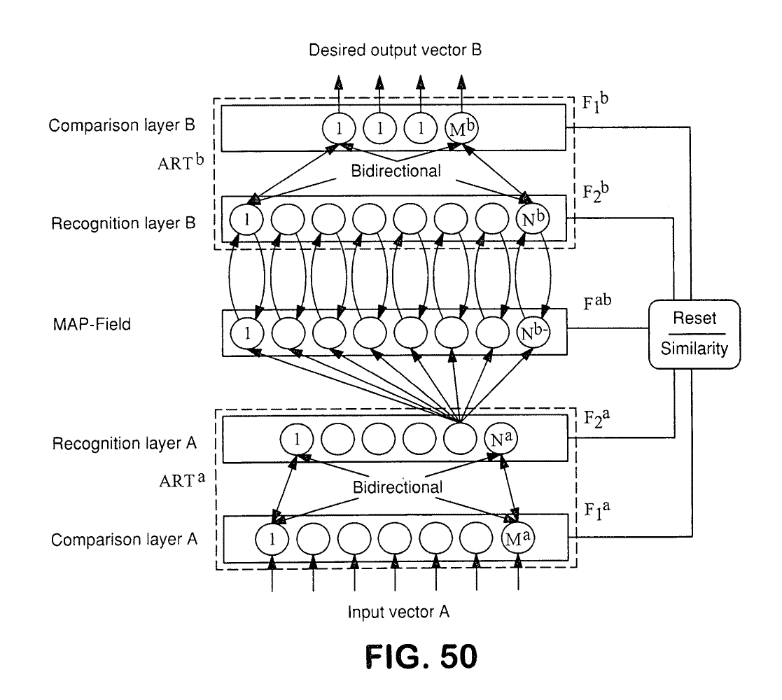

FIG. 50 is a schematic illustration of an ARTMAP network,

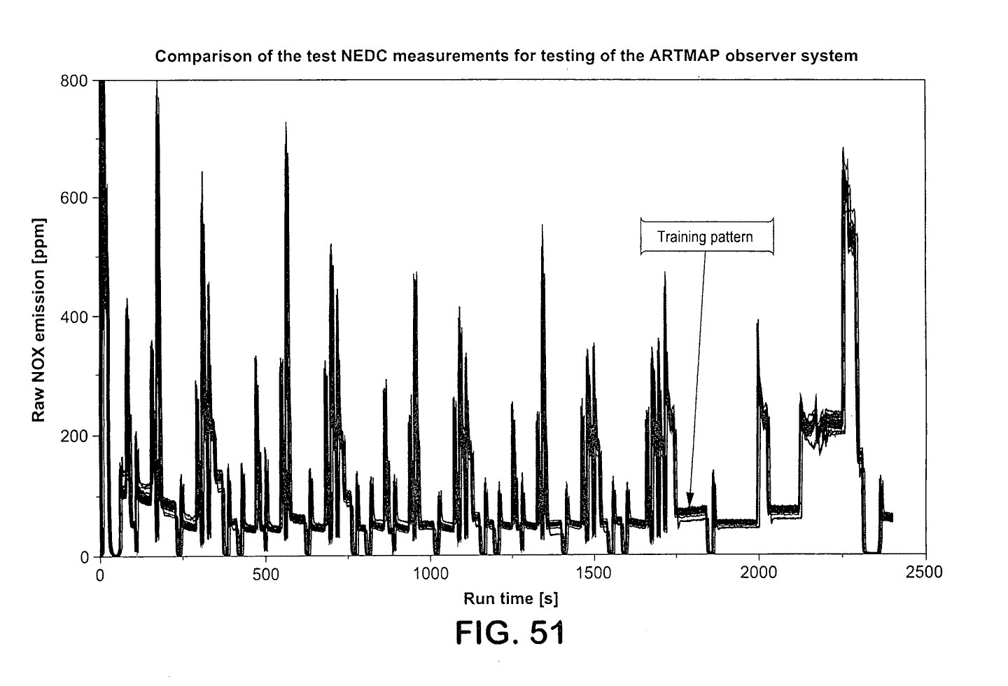

FIG. 51 shows the scatter band of the NOX measurement data during a trial of an ARTMAP observer system,

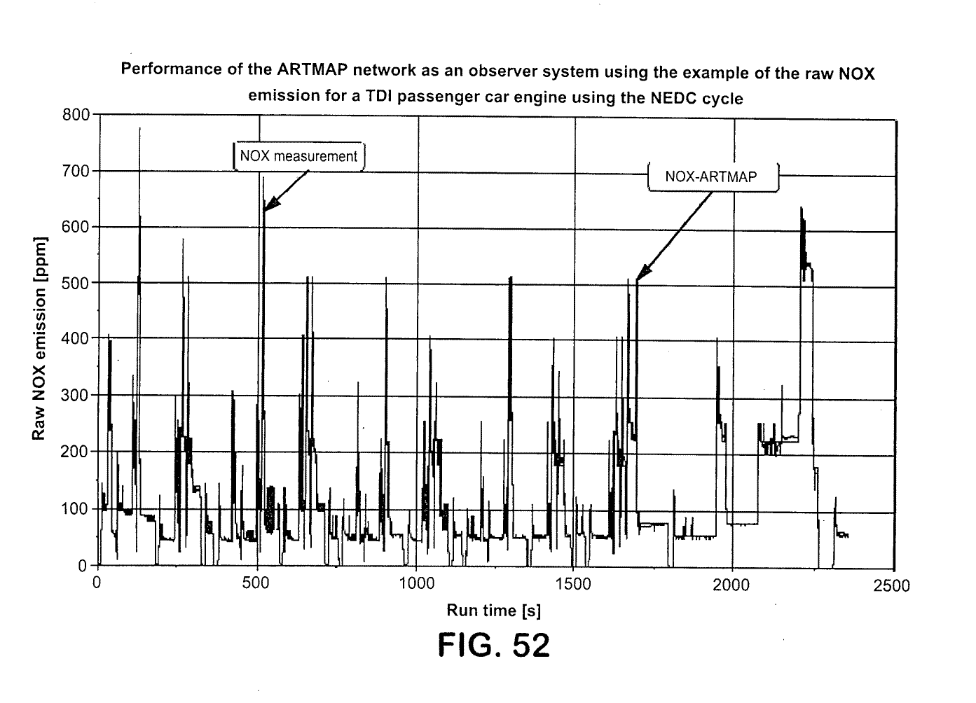

FIG. 52 shows the result of a randomly chosen NEDC cycle against the reference measurement from an ARTMAP network,

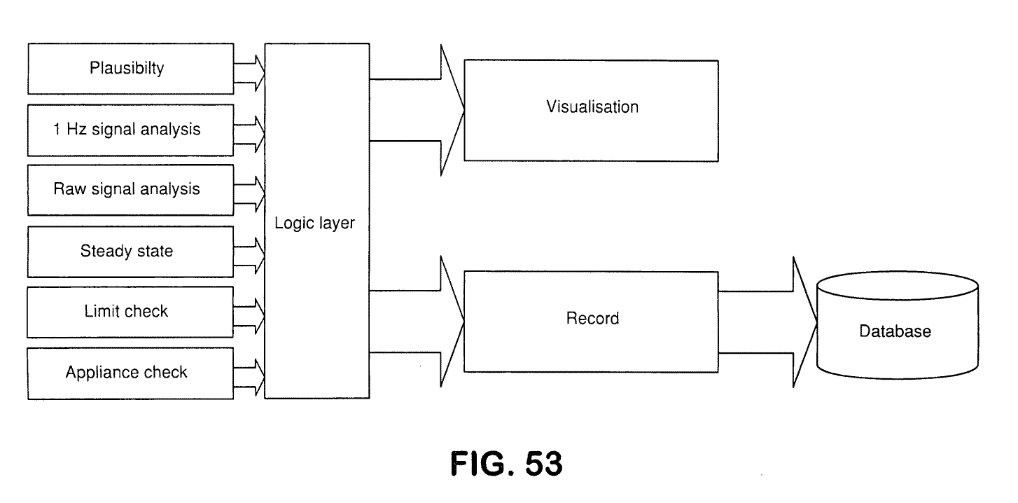

FIG. 53 shows the basic concept of fault isolation and fault classification according to the invention,

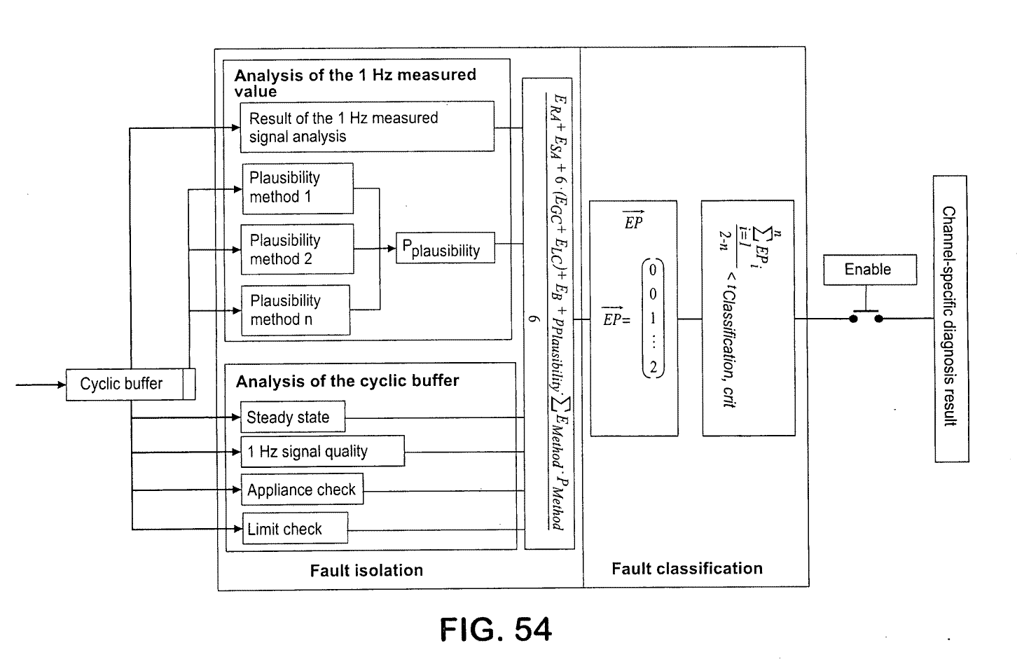

FIG. 54 shows the basic configuration of the logic layer according to the invention for fault isolation and fault classification,

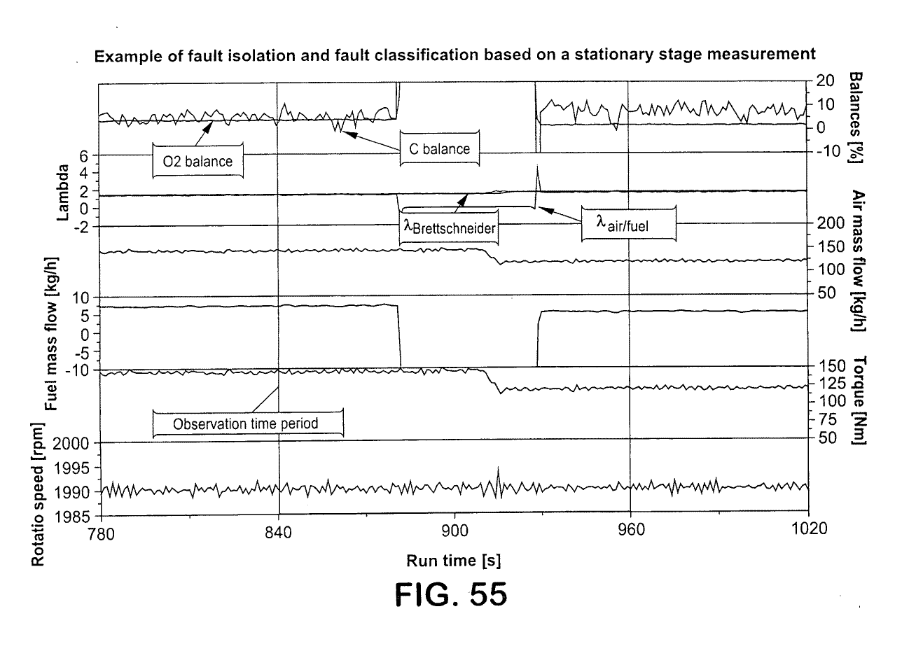

FIG. 55 shows an example relating to fault isolation and fault classification on the basis of a stationary stage measurement,

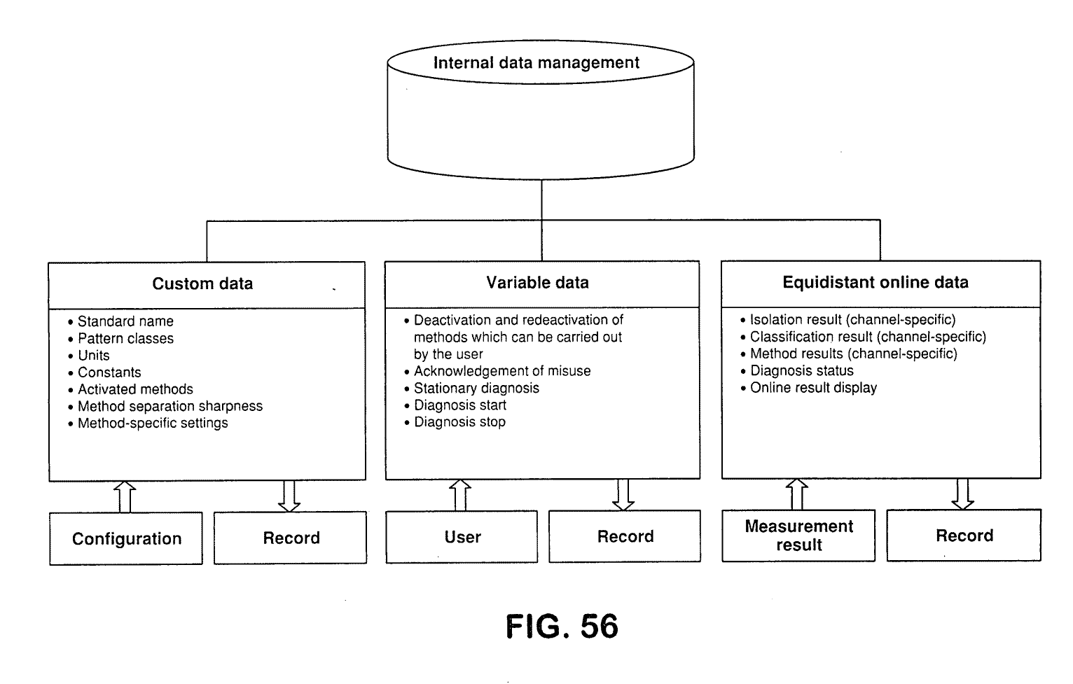

FIG. 56 shows, schematically, the configuration and the function of the internal data management,

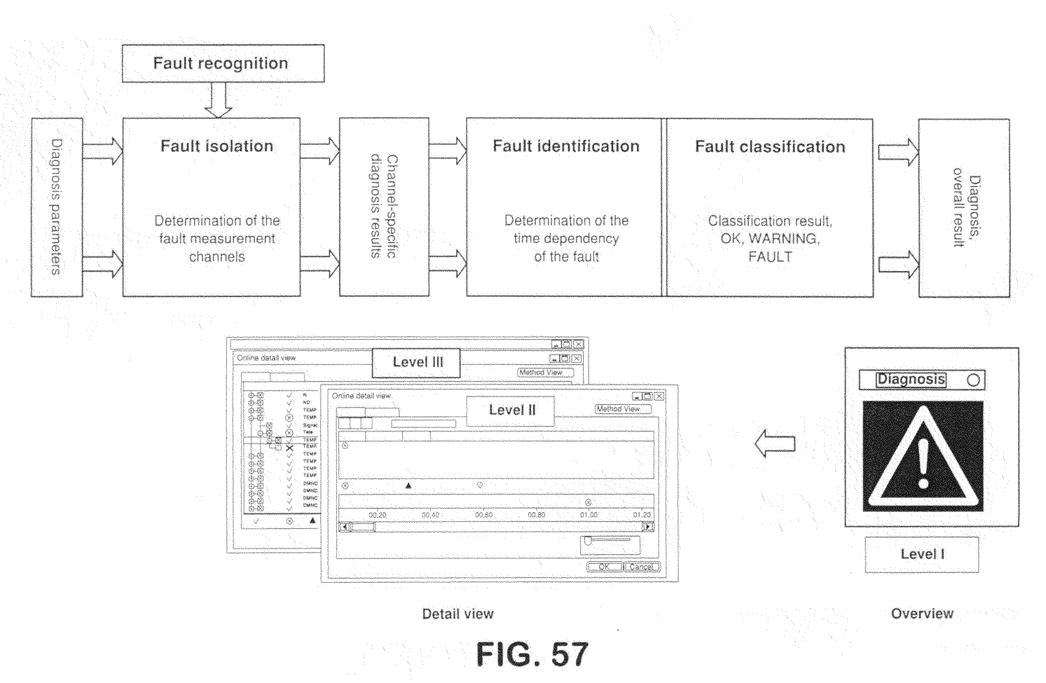

FIG. 57 shows a schematic illustration of the levels for event visualization,

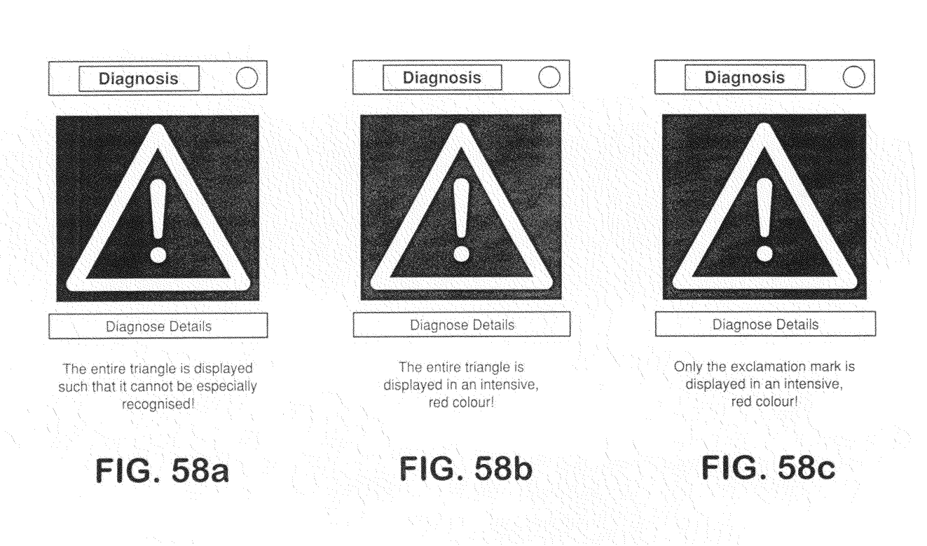

FIGS. 58a to c show advantageous symbols for a different status of the measurement data diagnosis,

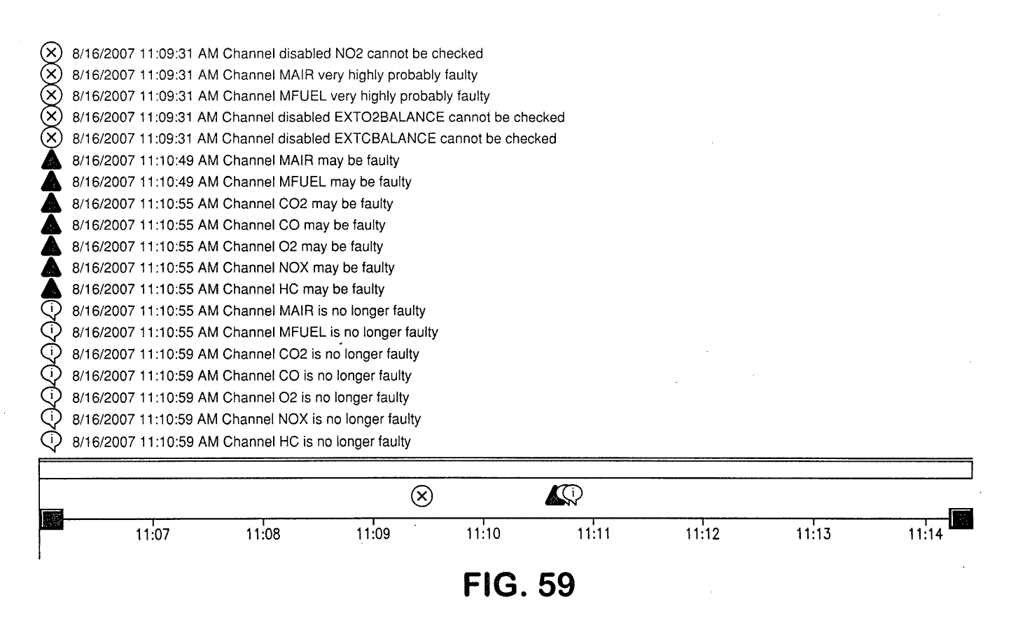

FIG. 59 is an example illustrating the diagnosis history,

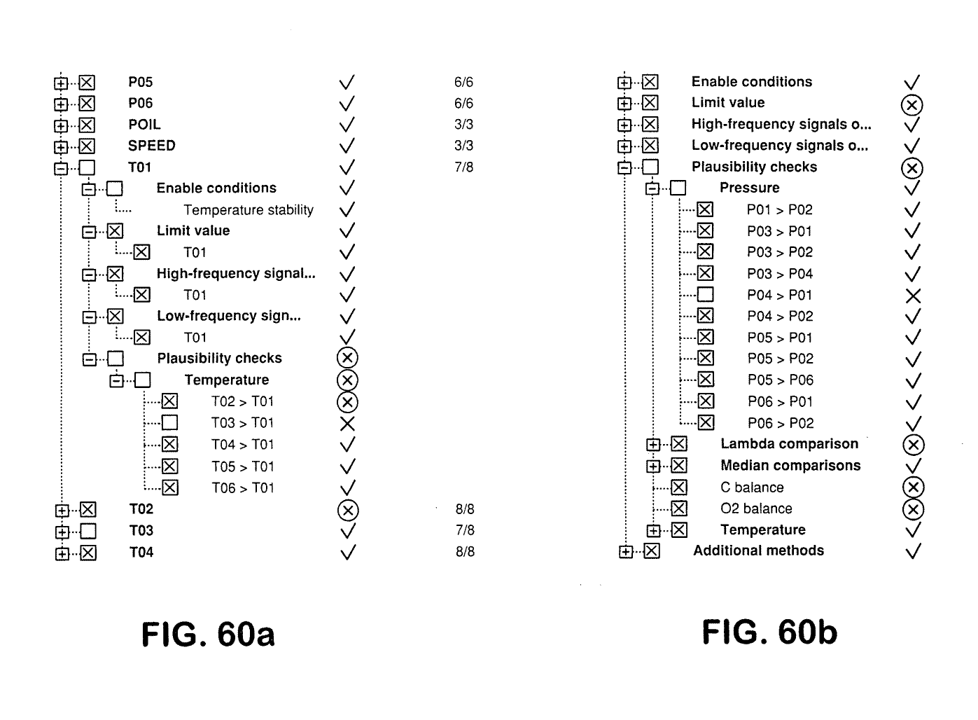

FIGS. 60a and 60b show examples of views relating to the scope and status of the fault recognition corresponding to the third level of the result visualization,

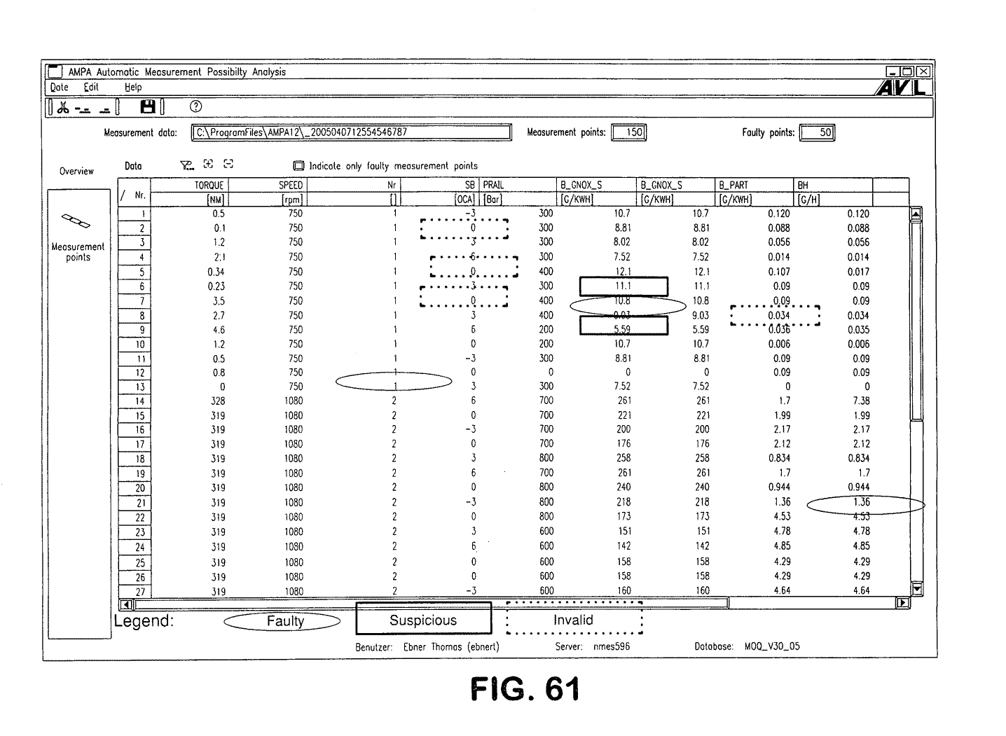

FIG. 61 shows an example for marking measurement data with a quality seal.

The early recognition of malfunctions, failures and faults is of central interest for the reliability and safety of technical processes, and is therefore also a motivation for fault diagnosis on engine test rigs.

The following conclusions for the development of centralised measurement data diagnosis can be drawn from the prior art:

The data interchange between test rig systems and external diagnosis tools is restricted according to the present prior art since the available interfaces, inter alia, restrict the operating frequency to a maximum of 1 Hz or less, and in general allow only restricted access to information of the test rig system (for example measurement channel list, operating mode, unit under test description, etc.) and therefore cannot provide all the information required for measurement data diagnosis, do not allow bidirectional communication, and can be addressed only in specific operating modes.

External diagnosis tools require additional resources in the form of PCs or Notebooks, and thus increase the test rig complexity.

Model-based approaches are unsuitable for general test rig use because the mathematical model description of the overall test rig system is complicated and complex and/or the unit under test or the test rig configuration is not maintained for long enough to justify appropriate system identification.

The tasks in the field of measurement data diagnosis indicate the requirement for a diagnosis tool which makes it possible to analyse a large number of measurement variables automatically, with little complexity.

It follows from the analysis of the described approaches that direct interaction between measurement data diagnosis and the test rig system appears to be necessary in order to solve the problem.

The stated conclusions and the continuously increasing use of statistical experiment planning were the drivers for an approach in which fault recognition was implemented with AVL Cameo DoE software. This approach was chosen since Cameo already has the necessary interfaces for data interchange with the most widely used test rig systems. In addition, it is possible to implement dedicated algorithms via a specific interface in the software.

Conceptually, the approach comprised signal-based stationary and online fault recognition. At the project level, there is a requirement that there should not be any further user inputs in addition to a standard configuration.

The test run readiness for a CAMEO test run is determined on the cold, stationary engine, by stationary fault recognition. Simple statistical methods such as median comparison and confidence intervals are used for this purpose.

After successful stationary diagnosis, the test rig was enabled for the actual DoE test run. Online fault recognition is started automatically by the test run. Irregularities during the measurement are indicated online depending on the selected measurement variables.

This approach made it possible to use simple algorithms for signal-based, physical fault recognition online. However, the implementation showed that the described approach could not be considered to be optimum. This was because of the fact that the interface that was used is actually intended for integration of user-specific experiment strategies. This situation requires the combination of experiment strategy and fault recognition methods for each new test run, with specific software knowledge being required for the implementation. In addition, Cameo does not have dedicated data acquisition and must therefore access the data of the test rig system. However, this access takes place only via the selected measurement mode (mean-value or current-value measurement). In the case of Cameo measurements, this is normally a mean-value measurement. For this purpose, Cameo starts a so-called stationary stage measurement (mean-value measurement) on the test rig system and at the end returns the mean value of the stage measurement as a measurement value. Only a single measurement value is therefore available per measurement for the measurement data diagnosis. There is no access to the data material which is used to form the mean value. The complete area for assessment of the signal quality therefore fails completely and a large number of information items are “thrown away” unused. Furthermore, it was found that the necessary configuration for fault recognition was extremely complicated.

The stated disadvantages lead to the conclusion that the Cameo approach is unsuitable for general test rig use. One positive assessment is that this approach indicated the fundamental feasibility of online fault recognition on engine test rigs, and it was possible to obtain important knowledge for optimization with regard to structure, configuration, enable conditions and result representation.

The empirical values of the Cameo approach were implemented in a new approach for online measurement data diagnosis. The approach on this occasion is based on the link to the

When measurement data diagnosis is mentioned in the course of the present work, this should always be understood as meaning a signal-based method for recognition and designation of discrepancies, disturbances, faults or failures in data acquisition on engine test rigs. A planned and objective procedure is required for this purpose, and this is referred to in the following text as diagnosis workflow. As can be seen in FIG. 4, diagnosis workflow, as a scheme for data diagnosis according to the present invention, comprises the steps of fault recognition, fault isolation, fault identification and fault classification.

The diagnosis workflow is implemented as an integrated component of the Puma Open test rig system. The necessary actions on the architecture of the test rig system in this case demand a universal concept which extends from configuration to result documentation.

With regard to the overall diagnosis concept, this means that all the main components and their interaction must first of all be defined. In this case, measurement data diagnosis includes, for example, the components of configuration, stationary early recognition, online fault recognition, using the Puma 5.5 variant measurement-synchronous test rig system from the AVL company. In this case, the fault recognition methods were implemented using an autonomous program.

The program is activated automatically on starting the test rig system, and is connected to the appropriate services of the test rig system. Puma provides a specific interface (CAPI) for this purpose. In addition to the measurement data, information can also be checked and analysed for the first time via this interface from the test rig system at a maximum operating frequency (foperate=1 Hz). The fact that the interface can also transmit information to the automation system for the first time made bidirectional communication between the diagnosis system and the test rig system possible. By way of example, the diagnosis result can thus be indicated directly in the user window of the test rig system. This has the advantage that the diagnosis information is displayed to the user in his normal system environment.

In addition to physical and logical approaches, it has also been possible for the first time to introduce the assessment of the signal quality and a simple appliance check as a permanent component of the fault recognition. The core is formed by quality control charts (QRK) for the standard deviation and mean value.

In summary it can be stated that the Puma approach makes it possible to implement a functional concept for online fault recognition. It is also worth mentioning that this approach for the first time made it possible to use measurement data diagnosis over wide areas in test panels.

Although the Puma approach has produced considerably better results than the Cameo approach, the performance of the interface must once again also be regarded as a disadvantage here. In addition to a maximum operating frequency foperate=1 Hz, only a very restricted scope of commands is available in this solution, as well. The raw data plausibility before filtering or high-frequency signal analysis thus fail.

It has therefore not been possible to provide a standardised interface with any of the normal test rig systems, which complies with the requirements for measurement data diagnosis, although this is essential for successful implementation of measurement data diagnosis. This measurement data diagnosis can be operated as a closed-off program either on the test rig PC or on an additional computer. The use of a dedicated diagnosis computer has the advantage that this does not cause any additional system load on the test rig computer and that the diagnosis tool can be used flexibly on different test rigs.

For an external solution, reliable data transfer must be guaranteed between the test rig computer and the diagnosis computer. The disadvantage in this case is that there are no standard interfaces for the normal test rig systems (for example USB) and that the financial outlay also rises, with an additional computer.

If the measurement data diagnosis is carried out on the test rig computer, strict attention must be paid to ensure that the resultant system load does not adversely affect the test rig operation. The integration of the measurement data diagnosis in the test rig system has the advantage, however, that it is possible to access all the internal information in the test rig system.

Both the external and the internal approach lead to new requirements for the framework (frame structure of the software) of the test rig system. These must be implemented by new functions and interfaces. Elementary actions on the system structure of the test rig system are necessary for this purpose, and these can be carried out only with the assistance of the appropriate manufacturers.

The conclusions can be implemented with the assistance of the system manufacturers both for an external interface and for an internal solution.

However, for an external interface, a large proportion of the internal data flow must be passed to the exterior. The transparency which is required for this purpose is undesirable by most manufacturers, for competition reasons. This transparency is not necessary for an internal solution.

In the following text, the fundamental concept of the centralised measurement data diagnosis based on Puma Open will first of all be introduced and discussed. In order to avoid retrospective changes in the architecture, careful formulation of all the known requirements for measurement data diagnosis is absolutely essential. Particular attention must be paid to the answering of questions relating to diagnosis scope, diagnosis depth and result processing. A feasibility assessment is then carried out, as well as the analysis of the system architecture required for this purpose.

The requirements which are known according to the current prior art will then be discussed, relating specifically to the detection sharpness, robustness and diagnosis depth, the operating frequency of the measurement data diagnosis, the monitoring scope according to the concept of the present invention, the operating modes for fault recognition, the association between the measurement channel and the computation algorithm, the requirements for configuration of the measurement data diagnosis, the visualization concept, the concept for result management, the constraints and enable conditions, as well as the data flow, in the same way as the fault recognition or cyclic fault recognition, internal data management, evaluation of the fault diagnosis, comprising fault isolation and fault identification with a significance statement, the visualization and/or the documentation of the diagnosis result, and the linking of measurement and diagnosis data.

In contrast to earlier works in the field of measurement data diagnosis on engine test rigs, maximising fault recognition methods is a secondary priority in this work. In this case, precisely in the same way as fault isolation or fault identification, fault recognition is only one subfunction of the diagnosis workflow, which contributes to ensuring and documentation of the measurement data quality.

In this context, the expression main component in each case describes a closed-off functional unit which may itself have any desired number of sub-functions.

The fundamental concept of integrated measurement data diagnosis comprises two groups of main components. The first group comprises the main components fault recognition, fault isolation, fault identification and fault classification and describes the actual diagnosis workflow. In this case, the fault identification and the fault classification can be combined to form fault identification.

The second group carries out the communication with the surrounding world. These components are necessary for efficient and flexible use. They allow the necessary data interchange with the user and are implemented by the main components of configuration, internal data management and result management.

At the same time, the priority of concept integration results in the requirement for a functional structure which can be upgraded within the main components. This is important in order to allow retrospective implementation and evaluation of new fault recognition functions.

In information technology, this strategy is referred to as generic programming. This means a method for development of reusable software libraries. In this case, functions are designed to be as general as possible in order to allow them to be used for different data structures. One essential feature of generic programming is that the algorithms are not written for one specific data type and, instead of this, specific requirements are just placed on the types. A generic model can be adapted to specific circumstances in a particular situation. In this context, FIG. 5 schematically illustrates the data flow and the interaction between the individual main components. The interfaces between the individual main components are designed such that information is transmitted in encoded form by means of defined numerical values.

An investigation was carried out on the basis of the Puma Open System from AVL List GmbH to determine how the data flow and the necessary interfaces can be implemented in an actual test rig system. For this purpose, the system architecture of Puma Open was investigated first of all, which is designed using a device structure as illustrated in FIG. 6, which in turn is placed on an operating system structure that is split in two.

The process level in this case carries out the information interchange between the test rig and the environment. In addition to the unit under test and the load unit, all the sensors, actuators as well as measurement and charge amplifiers and the test rig mechanism are also included in this level. The interface level ensures signal conversion between sensor and information processing and, possibly, the linking of further subsystems.

The operational level carries out the central functions, as illustrated in FIG. 7, of the test rig and thus forms the core of the automation system, as is also described in “Modellbasierte Methoden für die Validierungsphase im Produktentwicklungsprozess mechatronischer Systeme am Beispiel der Antriebsstrangentwicklung” [Model-based methods for the validation phase in the product development process of mechatronic systems using the example of drive-train development], by Christian Schyr, Dissertation 2006, Karlsruhe University.

The input/output level (I/O level) is normally a component of a hardware and a software platform with a real-time capability. In this case, the digitized measurement values of the interface level are processed by means of appropriate algorithms for closed-loop control, open-loop control, monitoring and for data storage. At this point, for example, filter methods are also used to reduce the interference signal influence or classification methods for data reduction. Some measurement values (for example engine rotation speed or oil pressure) are used not only as measurement values but also in parallel as an actual value for closed-loop control systems or safety facilities.

On the other hand, the operational level also communicates with the control level. In this case, experimental procedures defined by the user are carried out in real time, in which case the individual process steps can be carried out on a time-controlled or event-controlled basis. In order to achieve the maximum dynamics, the experimental procedure is processed synchronized in time to the signal detection. The nominal value preset for test rig control can in this case be implemented both manually by the user or automatically by an appropriate experimental plan.

The control level (FIG. 8) includes all the editors for test run creation, visualization and for experiment management. It is therefore the linking element between the operational level and the management level.

The management level offers a platform for networking of test runs and experimental results, which are in general based on a central database. This is responsible for management of test runs and experimental results of the individual test rigs when there is more than one test rig in a test panel (a host system). ASAM-ODS is nowadays often used for the management of experimental results. ASAM-ODS defines a generic data model for the interpretation of data, interfaces for model management, data storage, data accesses and data interchange.

Each device (appliance or service) is subdivided via the so-called real-time system interface into a real-time part and a non-real-time part.

The data flow starts at the sensor in the process level and passes via the interface level to the real-time frame where the data is recorded by a real-time I/O handler and is conditioned for further processing by the real-time system channel interface.

The individual processes in the real-time frame are not relevant to the implementation of the measurement data diagnosis and will therefore also not be described in any more detail.

The data flow in the automation system frame is described via a model comprising appliances (device) and system channels. A system channel may in this case operate as a data channel or message channel.

A data channel is comparable to a channel which receives values of a physical measurement variable. The system channel stores values with the aid of so-called system variables (for example online value, minimum value, maximum value, mean value). In contrast, message channels contain status and message information.

The system variable contains the data of a system channel, that is to say the information from the data and message channels. Since this data describes the system channel in more detail, it is referred to as characteristics of the system channel.

Puma Open generates a multiplicity of these system channels which, for example, may be allocated a standard name. Standard names in this case denote precisely the names of the measurement channels, which the user sees as channel names.

A system channel has at least one system variable and may have an indeterminate number of further system variables (minimum, maximum, mean value, standard deviation, filter or cyclic buffer).

The quantity is the description of an online variable such as a name, type, digits after a decimal point, etc. However, it does not have any current measurement values. When the online system is started, one system channel is produced for each actually used quantity. In contrast, a device (appliance) can produce a system channel at any time.

In the case of Puma Open, a distinction is drawn between three appliance groups: measurement devices, for example a fuel balance, replaceable and customer-specific I/O, so-called I/O devices, and artificial appliances (virtual devices), such as regulators or formulae.

A supplier/consumer model is used for connection of the individual appliances. Physically, the appliances are connected via system channels, in which case each system channel may have a plurality of consumers but only one supplier.

One function which is essential for the integrated measurement data diagnosis is the access to the unfiltered raw data. The framework architecture makes it possible to use cyclic buffers for online visualization (graphics) and for recorders for defined system channels in Puma Open. The background to this is that the non-real-time operating system is continually interrupted by the real-time operating system. In order nevertheless to see the data, cyclic buffers are required in order to transfer data without any losses from real time to non-real time. In the process, the data is recorded at the correct time, but is not indicated at the correct time.

The cyclic buffer in this case corresponds to a minirecorder which records a “time track”. The starting time of the cyclic buffer is defined by the clock master tick from the real-time level. The time intervals for data acquisition are constant. This results in the values being recorded at an accurate time. The present invention provides that this cyclic buffer be included in the measurement data diagnosis. This for the first time makes it possible to carry out a high-frequency signal analysis on the unmanipulated raw measurement data.

For the purposes of the Puma Open architecture as described above, the integration of the measurement data diagnosis is implemented as shown schematically in FIG. 6 in the form of an additional device. This is because of the fact that the necessary interfaces for a new device already exist in Puma, or can easily be added. This allows access to all the diagnosis-relevant data in the test rig system. FIG. 9 shows how the architecture of the necessary framework accesses to the system channel manager, to the test rig management, to the data acquisition or to the limit monitoring appears, and FIG. 10, finally, also shows the interfaces and data flows between the test rig system and the measurement data diagnosis. The process starts with the reading of the necessary information for the configuration from the management level. The unit under test data and the test run data as well as the measurement channels available on the system are in this case particularly important.

The fault recognition for the required input information must interact with the interface level and must have access to the control level, in order to visualize the diagnosis results. Once again, the documentation of the diagnosis results requires access to the management level.

In addition to the fundamental feasibility, the formulation of the expectation from the measurement data diagnosis is a major aspect of concept development. This means that it is necessary to answer the question as to which faults and what diagnosis depth can and should be covered by the integrated measurement data diagnosis. The fundamental aim is to detect states which lead to unusable measurement results.

One essential feature in this case is the fact that there are directly measured signals on test rigs and that in general no time can be made available for complex identification attempts relating to the system behaviour. This is because of the signal-based approach for fault recognition. In this case, it must be remembered that a fault must differ significantly from the fault-free system behaviour. The significance difference to be recognized in this case depends both on the process and on the potential of the methods or models used.

One measure for this significance is the detection sharpness. This is both a method characteristic and a parameter, and is therefore a measure of the smallest fault which can be detected reliably.

Because of simplifications or assumptions, the detection sharpness must be regarded as a method characteristic, since these assumptions and simplifications do not allow any more accurate statement from the corresponding method.

By way of example, simplifications relating to the carbon balance lead to a maximum detection sharpness of 10%. This means that the carbon mass flows flowing in and out must differ from one another by at least 10% in order to recognize a significant discrepancy from the expected system behaviour.

The detection sharpness must be configurable in order to allow the measurement data diagnosis to be optimally matched to a defined test task. The user therefore has the capability to himself define his expectation for fault recognition. For this reason, the detection sharpness can be considered not just a system characteristic but also a parameter.

The detection sharpness is thus an important characteristic which quantifies the expectations for fault diagnosis. The maximum possible detection sharpness must be specified for this purpose, for every fault recognition method that is used. The expectation that a discrepancy of 5 ppm in the raw HC emission can be recognized as implausible or even as a fault is, for example, not possible to achieve. In contrast, it is necessary to ensure that an exhaust-gas temperature of, for example, 100° C. where the engine is hot during operation will be reliably recognized as being implausible.

Furthermore, attention must also be paid to a clear distinction between the terms fault and fault cause or fault source. In practical terms, for example, the appliance state “not ready to measure” is a fault which is detected by the signal-based measurement data diagnosis. The fault cause may, for example, be a lack of auxiliary power (for example fuel gas for the FID).

However, the signal-based fault diagnosis is not able to derive the fault cause “no fuel gas for the FID” from the fault “exhaust-gas analysis not ready to measure”.

On the basis of this example, it can quickly be seen that signal-based fault recognition can determine the fault and/or the effects of the fault on corresponding measurement signals. The deduction of the fault cause from the recognized fault is, in contrast, possible only in exceptional cases. However, the measurement data diagnosis sensitizes the user by an appropriate indication of conspicuous measurement signals and may at the same time be a valuable tool for identification of the actual fault cause.

However, in certain circumstances and as will be explained in more detail further below in conjunction with fault recognition methods, there may be a discrepancy of balances or redundancy comparison between signals or computation variables which are dependent on the exhaust gas and those which are independent of the exhaust gas. In individual cases, appropriate information relating to the fault cause can then be provided in a downstream fault tree and then allows, for example, the conclusion “exhaust-gas measurement implausible”.

In principle, the diagnosis sharpness is always in contrast to the robustness of the diagnosis. The robustness is likewise a system characteristic which, in the case of fault diagnosis, relates to the reliability of the diagnosis statement in the event of uncertainties and disturbances. Diagnosis that is set to be very sharp with narrow confidence ranges and small tolerances can actually be referred to as being robust when it is also reliably possible to resolve less significant differences and discrepancies from the system noise. However, no incorrect messages may be produced in this case. On the other hand, diagnosis which is set to be too loose may possibly not identify significant differences, or may identify them too late. In both extremes, confidence in a correct diagnosis result will be lost if they occur frequently. Diagnosis sharpness, diagnosis depth and robustness are characteristics which will be discussed and quantified in more detail in conjunction with fault recognition methods.

One important question relating to use of measurement data diagnosis is how quickly irregularities in the data can and must be recognized. The definition of the operating frequency foperate is thus a further important point in concept development. FIG. 11 shows the sampling frequencies normally used on test rigs for the most important measurement variables.

As can easily be seen, all the major test rig measurement variables can be sampled in a range between and 10 Hz. In general, higher sampling frequencies are reserved for special applications. At the same time, it is also necessary to take account of the CPU load resulting from the measurement data diagnosis.

The speed of recognition will be discussed as a third criterion. Measurement data diagnosis is not considered to be a monitoring facility for system-critical states. Operating states which relate to the safety of the test facility or of the unit under test are monitored by appropriate checking mechanisms in the test rig system. There is therefore no requirement for real-time fault recognition. On the other hand, irregularities should be recognized as quickly as possible.

Analysis of daily test rig operation shows that the measurement data recording is normally carried out at 1 Hz, and in some cases at 0.1 Hz during long-term experiments. An operating frequency of foperate=1 Hz is therefore normally adequate for general test rig use. Higher operating frequencies are not used, for system load reasons. Taking account of lead times for iterative methods and an operating frequency of 1 Hz, the measurement data diagnosis should be able to reliably detect a fault within 30 to 60 seconds from the occurrence of the fault.

With regard to the extent of monitoring, there may in principle be any desired number of measurement variables to be monitored. This is limited by the computation complexity, the memory capacity and the framework of the test rig system. FIG. 12 shows the typical measurement points using the example of a TDI configuration. The typical measurement channels for engine test rigs can be derived from this.

All mass flows entering and leaving the engine as well as all relevant temperatures, pressures and exhaust-gas raw emissions are taken into account for measurement data diagnosis. ECU variables or additional lambda values are not available on every test rig. These variables are particularly important for fault recognition in the area of mass flows and in the case of exhaust-gas analysis, and should therefore be taken into account, as far as possible.

A so-called master class is assigned to each selected measurement channel during the configuration process, for clear identification of the corresponding measurement points. These represent the variables of the programmed fault recognition algorithms and thus link measurement variables and calculation formulae. The measurement variables are distributed between the master classes on the basis of position and the nature of the measurement variable. The measurement point positions are numbered successively from position 0 to position 4 on have the abbreviation of the corresponding physical variable added to them (for example, T0=temperature at the measurement point 0).

The following master classes and measurement points are used for the following embodiments of the invention:

TABLE T4.1
master classes for integrated measurement data diagnosis

| Master class | Physical | Measurement point |
|---|---|---|
| T0 | Temperature | Ambient temperature |
| T1 | | Air temperature after HFM/before |
| | | compressor |
| T2 | | Air temperature after compressor/before |
| | | boost-air cooler (LLK) |
| T2s | | Air temperature after boost-air cooler |
| T3 | | Exhaust-gas temperature before turbine |
| T4 | | Exhaust-gas temperature after turbine |
| TWE | | Coolant temperature, engine inlet |
| TWA | | Coolant temperature, engine outlet |
| TKRV | | Fuel temperature, inlet |
| TKKK | | Fuel temperature, return |
| TOEL | | Oil temperature |
| p0 | Pressure | Ambient pressure |
| p1 | | Air pressure after HFM/before compressor |
| p2 | | Air pressure after compressor/before |
| | | boost-air cooler (LLK) |
| p2s | | Air pressure after boost-air cooler |
| p3 | | Exhaust-gas pressure before turbine |
| p4 | | Exhaust-gas pressure after turbine |
| pOEL | | Oil pressure |
| Rotation | Operating | Engine rotation speed, booster rotation |
| speed | point | speed, other rotation speeds |
| Torque | | Torques |
| Alpha | | Accelerator pedal position |
| HC_v_CAT | Exhaust | Raw hydrocarbon emission |
| | gases | |
| CO_v_CAT | | Raw carbon monoxide emission |
| CO2_v_CAT | | Raw carbon dioxide emission |
| O2_v_CAT | | Raw oxygen emission |
| NOX_v_CAT | | Raw nitrogen oxide emission |
| NO_v_CAT | | Raw nitrogen monoxide emission |
| NO2_v_CAT | | Raw nitrogen dioxide emission |
| ML | Mass flows | Air mass flow measurement |
| MB | | Fuel mass flow measurement |
| MW | | Cooling water mass flow |
| lambda probe | ECU | lambda signal from an additional lambda |
| | | probe |
| lambda ECU | | lambda signal from the ECU |
| ALPHA_ECU | | Throttle valve position from the ECU |
| MD_ECU | | Torque from the ECU |
| ML_ECU | | Air mass flow from the ECU |
| MB_ECU | | Fuel mass flow from the ECU |

The measurement values of the stationary stage are obtained at the end of the measurement phase from the mean value of the individual measurements. However, an MSF can be carried out only when the start and end of the stage are known. This information is obtained from the test rig system.

In the case of a stationary stage measurement, Puma recognizes the MSF as an autonomous virtual test set, and gathers the data to be analysed over the measurement window. An appropriate event manager (device handler) has had to be developed for implementation, and controls the events cyclically, start and end. The cyclic fault recognition and the measurement-synchronous fault recognition can be carried out both in parallel and individually. The activations that are required for this purpose take place during the configuration process.

The start event and end event of a measurement are set by Puma at the start of the corresponding stationary stage measurement and must be monitored by the event manager, which then starts or ends the MSF. In order to minimize the system load, the real-time cyclic buffer is read only once per process step. To do this, the data is copied into two separate internal cache memories (FIG. 13). FIG. 14 shows the event control of the cache memories and the implementation of the corresponding fault recognition modes. The generic structure which has already been described makes it possible to include further master classes at this point.

From initial investigations and by exchange of experience with test engineers, it has been possible to determine that there is a need for different operating modes for measurement data diagnosis. For this reason, the integrated measurement data diagnosis has the three operating modes stationary fault recognition, cyclic online fault recognition (ZOF) and measurement-synchronous fault recognition (MSF).

The stationary diagnosis carries out a simple system test even before the engine is started. By way of example, this allows a simple comparison of the temperature measurement variables, which can no longer be carried out in this way when the engine is running.

A further important point is experiments which require conditioned start conditions. Stationary diagnosis is particularly worthwhile in this case since, in the event of a fault, no unnecessary waiting times will be incurred until the necessary constraints are reached. Stationary diagnosis makes use of specific fault recognition methods which are initiated manually by the user before starting, with the engine stationary. This will be described in detail further below, in conjunction with stationary diagnosis.

Cyclic online fault recognition is self-explanatory and is justified by the objective itself. However, cyclic online fault recognition results in correspondingly large amounts of data in long test runs.

Differentiated analysis between cyclic and measurement-synchronous fault recognition is also justified by the fact that stationary stage measurements (with the actual measurement phase after a transient phase and a stabilization phase) are carried out frequently during daily test rig operation. Measurement-synchronous fault recognition analyses the measurement data only when a corresponding stationary stage measurement is initiated by the system. In this case, for transparency and time reasons, it is worthwhile carrying out the measurement data diagnosis with the data recorded synchronously during the measurement. It should also be noted that these operating modes have become possible only by integration in the test rig system. Before integration, it was impossible to make the start and the end of the stationary stage “visible” for measurement data diagnosis.

In the case of cyclic fault recognition and when no measurement has been activated, the data in the real-time cyclic buffer is copied at the operating frequency to the cache memory for the cyclic fault recognition. If, in contrast, the “measurement start” event occurs, data which has already been gathered in the real-time cyclic buffer must be partially copied to the cache memory for the measurement-synchronous fault recognition, for cyclic fault recognition. Precisely the opposite situation occurs when a cyclic event occurs during measurement-synchronous fault recognition. The real-time data is then written to both cache memories, precisely as in the case of the end event. In this case, the cyclic cache memory is evaluated using the corresponding operating frequency. In contrast, the measurement-synchronous memory is only ever evaluated at the end of the measurement.

For the plausibility methods, the physical meaning of each individual channel is important since this must be linked to corresponding methods and equations. This association process is referred to as standard name mapping and is carried out during the configuration process. This is done by first of all activating all those channels for which a plausibility test is intended to be carried out. A corresponding master class is then assigned to each standard name. By way of example, this informs the system that the standard name T_Zyl1 is a measurement channel for the master class T3. The diagnosis system can automatically determine all the methods which can be carried out, using the information from the standard name mapping.

In order to ensure that the physical equations are calculated correctly, it is worthwhile converting the channel-specific physical units to SI units. In this case, z.E5 temperatures are converted from ° C. to Kelvin.

A further conversion may be required for pressure measurement since, in this case, both absolute pressures as well as relative or differential pressures can occur. In addition, pressures are frequently quoted in different units, such as mbar, hPa, MPA or bar. In order to avoid errors, all pressures are converted to absolute pressures and to the SI unit Pascal. The information required for data conversion is obtained from the configuration process.

Information relating to the physical units can also be taken directly from the standard name table of the automation system, by means of appropriate interfaces in the framework.

The configuration process allows the measurement data diagnosis to be matched to any desired test tasks. In this case, particular attention has been paid to the configuration process being carried out quickly, clearly and centrally. In order to comply with this requirement, a dedicated configuration concept has been developed. As already explained, measurement variables and physical formulae must be linked via the standard name mapping. In contrast, the physical meaning of a channel is irrelevant for signal analysis since, in this case, only data-based analysis is carried out. The primary factors in this case are limit values and probabilities. The functions of the appliance check are dependent on corresponding information from the special-to-type test equipment. Diagnosis parameters must therefore be available which are freely configurable in order to allow the diagnosis to be matched to specific requirements. Since interaction with the user is also necessary, in addition to appropriate presets, for inputting the data of the free parameters, a corresponding parameter component must be integrated.

The configuration process in this case has the major functions of access to all parameters which allow test-run-specific adaptation, and the development of generally applicable presetting of all diagnosis parameters. The following configuration groups have been formed for test-run-specific adaptation: standard name management, stationary diagnosis, operating point change recognition, steady-state recognition, signal quality, plausibility, archiving. These individual groups ensure a good overview and rapid access to the desired setting.

For example, the selection of the measurement channels (standard names) to be monitored is carried out in the standard name management. Only the selected channels then still appear in the further groups.

In contrast, in the case of operating point change recognition or steady-state recognition, measurement channels may be stated which describe a specific system behaviour.

The configuration of the signal quality and the plausibility in contrast define the scope of fault recognition. In this case, the maximum possible method scope is defined automatically on the basis of the selected standard names.

The individual parameter groups will be discussed further below together with the corresponding functions of fault recognition.

One of the most important and demanding tasks is evaluation of the fault recognition and the recognition of actual faults. In the diagnosis workflow, this corresponds to the main components of fault isolation, fault identification and fault classification. Generic output logic must be developed for this purpose, taking account of the individual fault recognition methods and the fault significance. This ensures that the user will not be overloaded with a flood of information. At the same time, this logic must be linked to appropriate visualization, which provides different information levels for different users. This is implemented by using the pyramid structure illustrated in FIG. 15.

Information relating to the functional status and fault status of the diagnosis is indicated in level I. If required, information relating to the diagnosis history is made available to the user in level II. The current status of all fault recognition functions can be seen in level III. With regard to the output logic, it is likewise necessary to also ensure that retrospective inclusion of individual functions is possible. This means that a generic process for evaluation of the fault recognition must also be designed for retrospective implementation of individual functions. This component will be described later in conjunction with fault isolation and fault classification.

Objective data management is necessary for smooth running of the measurement data diagnosis. This relates both to the internal data management and to the result management per se. The internal data management is implemented in the form of a mini-database. This database contains the following data groups: configuration data, information relating to the methods used, intermediate results, fault messages, user actions.

Some of this information is written to the database at the start of the diagnosis, and some online. At the end of each diagnosis run, the fault isolation and the fault classification then access the data, and produce the diagnosis result online. The diagnosis result is stored at the end of the diagnosis, together with documented user actions and the configuration process, in specific files which are referenced appropriately in the test rig system database.

Enable conditions are an important control element for measurement data diagnosis, in order to correctly interpret process-dependent or appliance-dependent special features. Examples of this are the filling of the fuel balance or an operating or variation point change. In addition, method-specific requirements must also be considered since, for example, most fault recognition methods apply only to the steady-state operating point. This applies in particular to signal analysis and plausibility. The reasons for the individual enable conditions will likewise be explained further below for the individual methods. However, the major enable conditions for measurement data diagnosis relate to steady-state recognition, appliance enabling and special enabling such as low-load or sudden-change recognition.

Consideration of the above facts results in the overall diagnosis procedure illustrated in FIG. 16. At the real-time level of the test rig system, the raw data is written to cyclic buffers, in order to transfer the data without any losses from the real-time level to the non-real-time level. The size of the cyclic buffers is dependent on the selected recording frequency for the corresponding channel. This configuration process is carried out in the test rig system and is not a component of the measurement data configuration process. However, the information about the appropriate interface is available for diagnosis.

The cyclic buffers are read at a configurable operating frequency (for example foperate=1 Hz) and form data packets with n elements, which are used as raw data for the diagnosis process. If, for example, the rotation speed is recorded using a sampling frequency of fsample=1 kHz, then the data packet comprises n=1000 values.

For system performance reasons, these packets have until now generally been supplied without further analysis to data reduction by filtering or averaging, as a result of which, even at this stage, important information relating to the signal quality has been lost without being used. As a result of the present work, this data will in future be analysed by high-frequency signal analysis (HFA). Furthermore, HFA provides the option for use of methods for the frequency domain. At the end of the HFA, the channel-specific result is transferred to the internal data management.

The unmanipulated raw data packets are now supplied to the data reduction of the test rig system. This reduces the data packets to one measurement value in each case and stores this in a dynamic memory element with a configurable length. This memory element is referred to throughout the rest of this work as a database.

The database acts like a rolling-map memory or shift register. In this case, a window of defined length is shifted over a time period, as can be seen in FIG. 17. When all the elements in the rolling-map memory have been filled, the entire content of the cyclic buffer is shifted by one element in the next process step. In consequence, the first (oldest value) falls out of the memory, as a result of which, at the end, the current mean value from the data compression can be written to the rolling-map memory.

When using an operating frequency foperate=1 Hz, a memory length of, for example, 30 values at the same time represents an observation time period of 30 seconds. The content of the database is the data basis for subsequent functions such as operating point change recognition, steady-state recognition or low-frequency signal analysis (NFA).

Operating point change recognition has been developed for so-called reference variables or manipulated variables (for example rotation speed, torque or ignition time) since the precise time of a change in the process behaviour is important for some fault recognition functions. This is because of the fact that a sudden change in a reference variable generally leads to a response (for example PT1 response) which can be described mathematically in the output variables. In the case of temperature signals, for example, signal analysis can be started even before the steady state is reached, by elimination of the time response. A modelled function profile can be defined for this purpose by means of non-linear regression. Since this is an iterative process, the starting point must be defined as accurately as possible.

The steady state of each individual channel must be determined because many of the fault recognition functions that are used may be used only for steady-state operation, since they are predicated on a normal distribution and independence.

When a steady state has been reached for the individual channel, the database is also used at the same time for the low-frequency signal analysis, for example as illustrated for the raw rotation-speed data in FIG. 18. The results of the operating point change recognition, of the steady-state recognition and of the low-frequency analysis are likewise transferred, in the same way as the high-frequency signal analysis results, to the internal data management.

Once the steady state has been recognized, the current measurement values of the channels to be monitored are passed to a plausibility test by means of physical, logical and empirical fault recognition functions. The scope of the test depends on the available information and measurement variables. All the individual functions which can be calculated using the available information can be selected from the function pool by means of the configuration process. In this case as well, the individual results are once again transferred, at the end, to the internal data management.

The result elements are assessed in the main components fault isolation and fault identification. The result elements are linked to one another here and are fed back via various logic blocks to the measurement channels to be monitored. The fault significance is assessed in a further logic block. That is to say this determines for how long a fault state or implausible state was present for, and how pronounced it was, and whether this state infringed defined time and magnitude limit values. The result of the evaluation, the fault classification, is visualized and documented in parallel.

In the case of the documentation, particular care must be taken to ensure that, in addition to the diagnosis result, all the settings from the configuration process and all the user reactions are also recorded and stored, together with the measurement data. This allows the diagnosis result to be reproduced at any time.

By way of example, those individual functions which have been investigated and implemented for the implementation of the integrated measurement data diagnosis will be described and explained in the following text. In the process, particular attention is paid to aspects such as detection sharpness, separation sharpness, free parameters and constraints for the application.

The appliance check is amongst the methods with the highest separation sharpness since exact (100%) identification of a faulty channel or instrument is always provided by this method. In this case, the test can be carried out either directly or indirectly, or by means of both paths.

In the case of a direct appliance check, the so-called status channel is used, which each instrument should supply as a return value. According to VDI/VDE 2650 sheet 1, an appliance's own status signals contain information about the status of an appliance. In this case, information is available relating to a failure, maintenance requirement, functional check or operation outside the specification. Specific channels which provide corresponding information relating to special-to-type test equipment can likewise be checked in the test rig system. These fault channels (message channels) are checked at configurable intervals in the same way as measurement values, and provide the following information:

| Value | Fault type |
|---|---|
| 0 | No error |
| −1 | Communication timeout |
| −2 | Port Error |
| −3 | Parsing Error |
| −4 | Overrun |

The request status for synchronization can be checked by Puma for the interface connection (0=Busy/< >0 . . . Not Busy).

If a fuel balance, for example, is considered, then the fuel mass flow can be used for diagnosis only if the fuel balance is in the measurement mode and does not have any faults. If the balance is in the filling mode, no fault recognition should be carried out since no assessment is possible in this mode. The corresponding control is likewise carried out via the appliance status and via enable conditions.

The indirect appliance check takes account of the fact that only measurement signals, without further information, are available to the corresponding instrument. An antifreeze function and a so-called NaN check are introduced for this situation. Both methods relate to specific data characteristics in the event of a fault.

The antifreeze function can be used both for the high-frequency signal analysis and for the low-frequency signal analysis. The probability of a plurality of successive values being precisely the same when the communication via an interface is intact is very low.

This fact forms the basis of the antifreeze function. Mathematically, this situation can be checked via the standard deviation since technical processes are generally subject to natural noise, as a result of which s≠0. Conversely, the case in which s=0 is improbable, provided that the process noise is not concealed by the digital resolution. FIG. 19 illustrates the example of a defective lambda probe in this context, which was identified by the antifreeze function. This example relates to an external lambda probe on a TDI engine. The OBD of the engine therefore cannot identify this fault. In the case of this example, the physical methods also fail since “plausible” measurement values are still present. This fault can therefore be recognized only by means of the antifreeze function, or by means of specific statistical approaches.

In the case of the antifreeze function, a configurable number of values recorded at equal intervals are checked to determine whether they are the same and for the condition s≠0. In the situation in which s=0, the interface to the corresponding appliance is regarded as being frozen and a fault at the highest priority level (appliance failure/sensor failure) is emitted.

In contrast to the antifreeze function, the NaN function makes use of the fact that appliance faults frequently return “defined fault measurement values” such as *****, 1EXP10 or #####. This often relates to non-numerical values, which have given the method the name (NaN=not a number). FIG. 20 shows this using the example of indexing. In this case, it was possible to detect a data transmission failure repeatedly during the measurement.

The NaN function checks whether a configurable number of critical values is exceeded in the database. If this number is exceeded, this likewise results in an appliance fault or sensor fault of the highest priority, as in the case of the antifreeze function. The simple function and the small amount of computation effort likewise make it possible for the method to be used both for high-frequency signal analysis and for low-frequency signal analysis. In the case of the high-frequency signal analysis variant, the real-time cyclic buffer is then, however, used as a database. All that is necessary in the configuration process is to state the maximum permissible number of NaN values and the maximum permissible number of identical values.

The limit check is used in the course of the high-frequency signal analysis and corresponds to classic limit-value monitoring. Channel-specific limit values are quoted for this purpose in the configuration process (for example HC>0). This simple function can be used to assess individual channels for which either no explicit fault recognition methods exist or for which specific limits are known from the start.

For example, it can be stated that all raw exhaust-gas emissions must be >0. In the same way, the efficiency can be limited by ηe<40% or the specific consumption on an experiment-specific basis to be, min>160 g/kWh.

The limit check therefore has the same separation sharpness as the appliance check, since a fault and measurement channel are assigned directly in this case as well. In a corresponding manner, a fault of the highest priority level, with p=1, is also emitted in the event of a limit infringement. The parameters are the channel-specific minima and maxima.

For test rig data, the assessment of the signal quality means that it should be free of spurious values, unacceptable noise, drift or other disturbances which lead to misinterpretations and to false conclusions. The assessment of the signal quality is focussed precisely on the stated data-related irregularities. The aim is to detect conspicuous features in any desired signals, without physical system information.

The assessment of the signal quality is in this case subdivided into the three areas of signal form analysis, high-frequency signal analysis (HFA) and low-frequency signal analysis (NFA). The object of this is to detect specific functional profiles in the measurement data. This in turn makes it possible to draw conclusions about the current system behaviour.

In the course of the high-frequency signal analysis, classic signal-processing methods (for example, FFT) are applied to measurement data sampled at a high frequency. The aim is to extract information about the process to be monitored and about the quality of the signals which describe it. This is focussed on digital (discrete) signal analysis.

Low-frequency signal analysis is used to analyse the filtered measurement data. This means that data which is normally recorded and visualized on a test rig system. This therefore relates to data at a frequency of 1 to 10 Hz.

The object of analysing the signal profile is to recognize characteristic functional profiles, in order to make basic statements about the process being observed. Once again, this is done on the basis of the database.

The following signal profiles, which are typically used for test rigs and measurement data, are considered in the course of the measurement data diagnosis, for example permanent (sudden change), saturation/decay, in the form of drift, beating/oscillation, intermittent, uncontrolled or subject to spurious values. However, the signal profile will be discussed explicitly only for the first four signal profiles. Intermittent, or uncontrolled signals, or those which are subject to spurious values, are considered in the course of the assessment of the signal quality.

A sudden event generally occurs only in the case of so-called nominal or reference variables. In the case of DoE applications, such variables are also referred to as factors. Examples of this are an operating-point or variation-point change.

The change in the ignition time for the same operating point is referred to, for example, as a variation-point change.

Mathematically, a sudden change is a discontinuous event. This is difficult to describe since classic identification methods such as linear regression do not work. A simple sudden-change or operating point change recognition process will be described further below.

Sudden-change recognition is particularly important for statistical signal analysis since this initiates a non-stationary operating behaviour. Furthermore, the precise time of an operating-point change can be determined by sudden-change recognition. This information is required as the starting time for iterative initial-value methods.

In addition to the nominal variables, so-called responses or response variables also exist. These describe the system response to a sudden change in the reference variables. This behaviour is referred to in control engineering as, for example, a PT1 response and is described by the differential equation

T·y(t)+y(t)=K·u(t) [Equation 5.1]

The step-function response in the time domain is given by the solution to equation 5.1.

$$y ( t ) = K ( 1 - {e}^{- λ t} ) + b where λ = \frac{1}{T} \qquad [ Equation 5.2 ]$$

This knowledge can be used in the opposite sense, and the parameters of the step-function response can be estimated from the database. This is a nonlinear initial-value problem.

By way of example, the parameters can be calculated using the Gaussian Newton method. The necessary partial first derivatives to create the Jacobi matrix are given by:

$$\begin{matrix}\frac{\partial y ( t )}{\partial K} = 1 - {e}^{- λ t} & [ Equation 5.3 a ] \\ \frac{\partial y ( t )}{\partial b} = 1 & [ Equation 5.3 b ] \\ \frac{\partial y ( t )}{\partial λ} = t \cdot K \cdot {e}^{- λ t} & [ Equation 5.3 c ]\end{matrix}$$

The principle is the least error-square method. As in the case of linear regression, this is also based here on a residual equation of the type:

$$F ( x ) = \frac{1}{2} {\sum }_{i = 1}^{m} {( {f}_{i} ( x ) )}^{2} = \frac{1}{2} {‖ f ( x ) ‖}^{2} = \frac{1}{2} {f ( x )}^{T} f ( x ) \qquad [ Equation 5.4 ]$$

Equation 5.2 is used as the approach for a PT1 response.

To solve this, ∥f(x)∥ must be minimized. As can be seen from the relevant specialist literature, the solution of:

$$( {J}_{T} J ) {h}_{gn} = - {J}^{T} f where f = ( \begin{matrix}{f}_{1} ( x ) \\ ⋮ \\ {f}_{m} ( x )\end{matrix} )$$

leads to a unique minimiser. The Jacobi matrix J is first of all calculated for this purpose. This is also referred to as a functional matrix of a function which can be differentiated and is the m×n matrix of all the first partial derivatives (equations 5.3a to 5.3c). Reorganization results in equation 5.6 and thus also in the iteration equation 5.7.

h_{gn}=−J^{T}f(J^{T}J)⁻¹ [Equation 5.6]

x:=x+αh_{gn} [Equation 5.7]

The classic Gaussian Newton method uses α=1.

Since the Jacobi matrix and the vector f for the result x must be recalculated for each iteration step, the iteration is terminated after a maximum of 10 steps.

In addition to the correct starting point, the choice of the start values is also important, and this has led to the development of a corresponding start value search. The start values for the PT1 approach are defined as follows:

K=max(database)−min(database);
λ=0.05;
b=database(1).

The definition measure R² is used as the quality criterion for estimation. If R²>0.8, this is referred to as a good estimate.

FIG. 21 shows the use of the PT1 approach for modelling of the exhaust-gas temperature, based on the example of a sudden load change on the 2.2l DI Otto-cycle engine at 2000 rpm. After the sudden load change, the Gaussian Newton method was in each case used, with ten iteration steps, for this purpose, using the operating frequency foperate=1 Hz. The calculated parameters and the definition measure associated with them are summarized in Table T5.1.

TABLE T5.1
Result of non-linear regression

| Number of | Parameter | Parameter | Parameter | |
|---|---|---|---|---|
| values | K | λ | b | R² |
| 5 | 305.0495 | 0.1993 | 324.8798 | 0.9573 |
| 10 | 207.5942 | 0.4026 | 319.3854 | 0.9626 |
| 25 | 206.8475 | 0.4007 | 319.8225 | 0.9706 |
| 50 | 210.3767 | 0.3574 | 323.1316 | 0.9604 |

The details relating to R² in each case refer only to the calculation interval.

FIGS. 21 and 22 show the extent to which the steady state can be calculated in advance using this method. These figures show the signal response extrapolated appropriately using the parameters from T5.1 and verify that the PT1 model is very highly suitable for describing a discrete interval, provided that appropriate start values are used. The approach is therefore suitable, for example, for compensation for the time response of temperature channels. However, extrapolation cannot be recommended since neither the final value nor the transition to the asymptotes are represented correctly by any of the illustrated profiles.

The expression drift in general means a relatively slow change in a value or a system characteristic. The drift can be mathematically described by a simple straight line according to equation 5.8.

y(t)=a₁+a₂·t [Equation 5.8]

The adequate method for estimation of the parameters is referred to as linear regression. The parameters a1 and a2 are calculated from the measurement data using equation 5.9 and equation 5.10.

$$\begin{matrix}\begin{matrix}{a}_{2} = \frac{n \cdot {\sum }_{i = 1}^{n} {t}_{i} {y}_{i} - ( {\sum }_{i = 1}^{n} {t}_{i} ) ( {\sum }_{i = 1}^{n} {y}_{i} )}{n \cdot {\sum }_{i = 1}^{n} {t}_{i}^{2} - {( {\sum }_{i = 1}^{n} {t}_{i} )}^{2}} \\ = \frac{{\sum }_{i = 1}^{n} {t}_{i} {y}_{i} - n \overline{t} \overline{y}}{{\sum }_{i = 1}^{n} {t}_{i}^{2} - n {\overline{t}}^{2}} \\ = \frac{{\sum }_{i = 1}^{n} ( {t}_{i} - \overline{t} ) ( {y}_{i} - \overline{y} )}{{\sum }_{i = 1}^{n} {( {t}_{i} - \overline{t} )}^{2}}\end{matrix} & [ Equation 5.9 ] \\ {a}_{1} = \frac{( {\sum }_{i = 1}^{n} {t}_{i}^{2} ) ( {\sum }_{i = 1}^{n} {y}_{i} ) - ( {\sum }_{i = 1}^{n} {t}_{i} ) ( {\sum }_{i = 1}^{n} {t}_{i} {y}_{i} )}{n \cdot {\sum }_{i = 1}^{n} {t}_{ii}^{2} - {( {\sum }_{i = 1}^{n} {t}_{i} )}^{2}} = \overline{y} - {a}_{2} t & [ Equation 5.10 ]\end{matrix}$$

Since the linear regression lines are calculated quickly and easily, this method is excellently suitable for simple assessment of the steady state. This approach is therefore also part of the steady-state recognition process, which will be described later.

In order to calculate the free parameters of an oscillation or of a beat from the database, it is likewise possible to use the non-linear regression method. The approach used for this is either the harmonic oscillation according to equation 5.11

y(t)=ŷ·sin(2πf·t+φ) [Equation 5.11]

or a beat according to equation 5.12

$$y ( t ) = 2 \overline{y} sin ( 2 π \frac{{f}_{1} + {f}_{2}}{2} ) \cdot cos ( 2 π \frac{{f}_{1} - {f}_{2}}{2} t ) \qquad [ Equation 5.12 ]$$

The harmonic oscillation is characterized by the parameters amplitude ŷ, the frequency f and the phase shift φ. In contrast to the harmonic oscillation, a beat is understood to be the superposition of two oscillations at a similar frequency. The frequencies f1 and f2 must be defined as well as the amplitude. In this case, for simplicity, it is assumed that this is a pure beat, that is to say that the amplitude of the sinusoidal element is the same as that of the cosinusoidal element. Frequently, however, it was possible to see that the Gaussian Newton method failed for the regression of oscillation models, since det(J′*J)=0 occurred even in the first iteration loop.

The assessment of the signal quality is one of the central tasks of integrated measurement data diagnosis. Both the time response and the ratio of the useful signal to possible disturbances and noise signals are investigated in the signal analysis that is required for this purpose. The device architecture for the first time allows raw data analysis of the real-time data before any data manipulation by means of averaging or filtering. By accessing the raw measurement data, the assessment of the signal quality as shown in FIG. 23 is subdivided into high-frequency signal analysis and low-frequency signal analysis.

In instrumentation, it is normal practice for the detection frequency not to be the same as the operating frequency. This is justified by the Shannon sampling theorem. The sampling theorem states that a continuous signal must be sampled at a detection frequency fdetection≧2*foperate,max in order to allow the original signal to be reconstructed, without any loss of information, from the time-discrete signal obtained in this way. If the theorem is not observed, so-called aliasing effects can occur.

The channel-specific detection and operating frequency can be specified by the user on the test rig system. For example, the user can in this case specify that a rotation-speed signal will be sampled using fdetection=1000 Hz, but will be indicated only with foperate=10 Hz in the system. An appropriate cyclic buffer is used in the system channel for this purpose. This cyclic buffer is the data source for the high-frequency signal analysis (HFA). Access to this data has become possible by the integration of the measurement data diagnosis as a device. The expression high-frequency in this case refers to data which was measured using a detection frequency of more than 10 Hz. This opens new options for integrated measurement data diagnosis in the time domain and frequency domain, which are summarized in the section on high-frequency signal analysis (HFA). In principle, the methods described in this section can, of course, also be used for low-frequency signal analysis (NFA).

High-frequency signal analysis and low-frequency signal analysis therefore differ essentially by the database to be investigated. In the case of high-frequency signal analysis, this in fact relates to the raw measurement data from which the measurement data indicated on the test rig system will later be created by filtering or averaging. The novel feature in this case is that the quality of this measurement data can be assessed by means of the high-frequency signal analysis.

By way of example, the following characteristic values and characteristic functions can be used for the frequency domain: the discrete Fourier transformation (FFT) y(n), the power density Syy(iw) and the autocorrelation function Ryy(τ).

The autocorrelation function is in this case the most important characteristic function, since it describes the correlation of a signal with itself in the event of different time shifts t. Ryy(τ) is calculated for the time signal x(t) in the time window TF using equation 5.13.

$${R}_{YY} ( τ ) = {lim}_{τ -> ∞} \frac{1}{{T}_{F}} \int x ( t ) \cdot x ( t + τ ) d t \qquad [ Equation 5.13 ]$$

Ryy is in this case distinguished by peaks at τ=0 since, there, it has a value proportional to the mean power of the function. The autocorrelation function is generally calculated in digital signal analysis by means of the inverse Fourier transform (iFFT) of the power spectrum Syy (equation 5.14).

R_{YY}(τ)=∫S_{YY}(f)·e^{i2πtr}df [Equation 5.14]

Ryy can be used, for example, to identify periodicities in signals that are subject to heavy noise. However, only the autocorrelation function for large values of □ is considered for this purpose, and the area around τ=0 is ignored since this contains in particular information about the strength of the noise signal. Precisely the opposite evaluation of the autocorrelation function will be carried out for calculation of the signal-to-noise ratio (SNR). When τ=0, the autocorrelation function for power signals represents the square mean value or the signal energy in the case of energy signals. This characteristic is used to calculate the SNR (equation 5.15).

$$SNR = 10 \cdot {log}_{10} ( \frac{{S}_{X}}{{N}_{X}} ) \qquad [ Equation 5.15 ]$$

In this case, SX describes the autocorrelation function without noise at the point 0 (useful signal) and NX describes the level of the noise peak. In practice, this means that, first of all, the Fourier transform y(n) is calculated from the time signal x(t), and the power spectrum Syy is calculated using equation 5.16.

S_{YY}(f)=X*(f)·X(f)=|X(f)²| [Equation 5.16]

The autocorrelation function is obtained via the inverse Fourier transform (iFFT) of the power spectrum. The SNR can now be calculated from this, using equation 5.17.

$$SNR = 10 \cdot {log}_{10} ( \frac{\frac{1}{N} {\sum }_{i = 2}^{N} AKF ( i )}{AKF ( 1 ) - \frac{1}{N} {\sum }_{i = 2}^{N} AKF ( i )} ) \qquad [ Equation 5.17 ]$$

Since the signal power is generally several orders of magnitude greater than the noise or interference power, the SNR is quoted in decibels (dB). It has not been possible to determine from the relevant specialist literature (signal processing and information technology) for measurement data the ranges in which the SNR must lie in order to allow a good signal to be assumed. By way of example, an SNR of about 6 dB is required in order to transmit speech in a manner which can be understood by people. In video technology, a signal is considered to be good if the SNR is greater than 60. This corresponds to a ratio of the useful signal to the noise signal being 1000000/1. By way of example, FIG. 24 shows the result for a 1 Hz stationary stage measurement, and the corresponding values for SNR are summarized in Table T5.2.

TABLE T5.2
Signal-to-noise ratios in dB relating to FIG. 24

| | Time | | | | |
|---|---|---|---|---|---|
| | 0- | 250- | 550- | 700- | 950- |
| Channel | 200 s | 400 s | 650 s | 900 s | 1150 s |
| Rotation speed | 70.5 | 70.0 | 63.8 | 70.4 | 70.9 |
| Torque | 27.8 | 47.0 | 52.8 | 46.8 | 27.9 |
| Coolant temperature | 42.7 | 45.7 | 46.6 | 46.6 | 45.7 |
| Oil temperature | 43.0 | 52.6 | 43.5 | 59.6 | 42.0 |
| Exhaust-gas | 40.2 | 41.5 | 59.9 | 41.1 | 40.7 |
| temperature | | | | | |
| Air mass flow | 29.1 | 36.9 | 44.6 | 36.1 | 28.9 |
| Effective mean | 27.7 | 46.6 | 53.9 | 46.8 | 27.9 |
| pressure | | | | | |
| Induction manifold | 73.3 | 72.7 | 73.5 | 72.9 | 72.8 |
| pressure | | | | | |
| lambda | 28.9 | 36.3 | 43.0 | 35.5 | 28.3 |
| Specific fuel | 27.4 | 41.4 | 46.2 | 42.8 | 28.0 |
| consumption | | | | | |

Table T5.2 reflects the result of the investigation very well. SNR>50 are encountered only rarely in most test rig data. Values are considerably more frequently in the range 30 dB<SNR<50 dB. For this reason, a detailed investigation of randomly selected samples was carried out in order to determine whether the quality of the signal under consideration will be classified as good or poor in an engineering analysis. Adaptation was then carried out between the investigation result and the stated SNR range. This procedure will be described using the example of the effective mean pressure from FIG. 24.

TABLE T5.3
The engineering signal analysis in comparison to the SNR

| | Mean | | | | | Time |
|---|---|---|---|---|---|---|
| SNR | value | Min | Max | | σ in | range |
| [dB] | [bar] | [bar] | [bar] | σ | [%] | [s] |
| 27.7 | 2.07 | 1.89 | 2.27 | 0.08 | 4.10 | 0-200 |
| 46.6 | 9.69 | 9.56 | 9.80 | 0.05 | 0.47 | 250-400 |
| 53.9 | 19.16 | 19.06 | 19.28 | 0.04 | 0.20 | 550-650 |
| 46.8 | 9.72 | 9.57 | 9.85 | 0.05 | 0.46 | 700-900 |
| 27.9 | 2.05 | 1.90 | 2.23 | 0.08 | 4.03 | 950-1150 |

At points where the load is low (pme=2 bar), it is immediately evident that the SNR is considerably poorer than at the higher load points. A fluctuation of 4% in the mean pressure would likewise be considered inadequate by an experienced engineer. At the same time, this statement is coincident with a relatively low SNR of 27.7 dB. An SNR which is approximately twice as good is in contrast achieved with an SNR=53.9 dB at the best point. The following limit values have been defined for the measurement data diagnosis, from the investigations relating to the SNR:

TABLE T5.4
Critical values for the signal-to-noise ratio

| | Detection | |
|---|---|---|
| Tests | sharpness | Tolerance |
| SNR | High | 40 dB |
| | Medium | 30 dB |
| | Low | 20 dB |

A further option for assessment of the signal quality in the time domain is the median deviation. The analysis is carried out by comparison of the median deviation with a defined limit value r (Table T5.5).

TABLE T5.5
Critical values for the signal-to-noise ratio

| | Detection | |
|---|---|---|
| Tests | sharpness | Tolerance |
| Median-Deviation | High | r = 3 |
| | Medium | r = 3.5 |
| | Low | r = 4 |

The median deviation is an extremely robust scatter measure which, in the situation under consideration is calculated from the individual values xᵢ and the median of the cyclic buffer \tilde{x} using equation 5.18.

\tilde{D}=Median{|xᵢ−\tilde{x}|} [Equation 5.18]

The test variable F is in turn, taking into account equation 5.18, as:

$$F = \frac{\tilde{D}}{median ( {x}_{i} )} , \qquad [ Equation 5.19 ]$$

which is then checked against the configured limit value r. In this case, at least ten measurement values from the real-time level are presupposed for calculation of the test variable. At sampling frequencies fsample<10 Hz, a memory procedure is automatically started which temporarily stores a defined number of n data packets depending on the corresponding sampling frequency. This allows the data content of the current real-time rolling-map memory to be filled with data from previous data packets in such a way that a sufficient number of real-time sample values are always available for calculation of the test variable. Depending on the condition:

F>r [Equation 5.20]

a corresponding, binary fault entry is made. In order easily to arrive at a binary result of the high-frequency system analysis, only one of the two proposed methods should be activated. For the purposes of the present work, the process according to equation 5.17 is preferred. The high-frequency system analysis therefore has a separation sharpness of p=1 since the corresponding signal at the time t either satisfies or does not satisfy the test F>R and/or SNR>SNR_{crit}.

In contrast to the high-frequency signal analysis, it is possible to choose between a user-based and an automatic approach for the low-frequency signal analysis.

In the case of the user-specific approach, which will be explained later, the corresponding relative or absolute limits are specified by the user in the course of the configuration process. The methods of the automatic approach, which will likewise be explained later, are in contrast used primarily to calculate limits within which the measurement data should move in order to be statistically inconspicuous.

In this case, the assessment is in principle carried out by limit-value monitoring in which the corresponding limit values are defined either on the basis of statistical methods or by the configuration process. However, this type of limit-value monitoring should not be confused with the previously explained limit check. In contrast to this, the corresponding limits for signal analysis only ever apply to the configurable interval [t−n,t].

Characteristic values, limit values or test variables are calculated from the database during the low-frequency signal analysis (see FIG. 25). The elements of the database are then compared with the calculated limit values. In the process, the determination is made as to whether and how many elements of the sample lie outside the permissible limits. The number of conspicuous values and statistical basic assumptions allow a direct statement to be made relating to the signal quality. Furthermore, it is possible to determine whether the process and/or the corresponding signal has been in a statistical checking state during the monitoring interval.

At this point, it should once again be expressly stated that the statistical signal analysis only provides mathematically justified conclusions, which never provide information about the physical plausibility. It provides only information indicating statistically justified conspicuous features. However, the measurement principle and the physical behaviour at the corresponding measurement point can be considered by means of user-defined limit values (absolute or relative). A comparison must be made between the sample values xi and the limit values for this purpose, in addition to appropriate configuration.

Statistical approaches are preferred for automatic signal analysis. There are a large number of statistical tests and methods for this purpose, in order to determine sample characteristic values, position measures, spurious values or other characteristic variables. In this case, it should be noted that statistical limits can in some cases be calculated to be so narrow that these limits are not feasible physically or from the measurement point of view. Limits which are calculated to be considerably too narrow or too wide are generally, however, an indication of infringement of the already mentioned constraints or the result of signal failures or interface problems. In most cases, this is because the standard deviation of the corresponding signal is too great or too small.

The absolute and relative limit values are calculated on the basis of the median and a configured threshold which is used for checking. The relative discrepancy R for the last measurement data point xi is calculated using equation 5.21.

$${R}_{m i n} < R = \vert \frac{{x}_{i} - \tilde{x}}{\tilde{x}} \vert < {R}_{ma x} \qquad [ Eq . 5.21 ]$$

The test variable R is tested against the user-defined, relative limits Rmin and Rmax (for example +/−5%) around the median \tilde{x}. If the value is above the limit, then the measurement data point is marked as a spurious value.

The absolute discrepancy A is calculated for the last measurement data point xi using equation 5.22.

Aₘᵢₙ<A=|xᵢ−x|<A_{max[Eq.} 5.22]

The A-value is in this case tested by means of a user-defined, absolute limit (for example +/−5 rpm) around the median \tilde{x}. If the value is above the limit, then the measurement data point is also marked as a spurious value in this case.

Various distribution-dependent methods may be used to calculate characteristic variables or limit values for the automatic approach. However, particularly for distribution-dependent methods, it is primarily necessary to check whether the corresponding distribution exists, at least incipiently. This has led to the signal analysis being subdivided into the blocks comprising constraints, characteristic variables and limit values.

In the constraints block, an analysis is carried out to determine whether the current data from the database is free of sudden changes and drift and whether the requirements for a normal distribution and statistical independence are satisfied.

Characteristic variables are calculated in the characteristic variables block. These variables are used as a measure for the statistical signal-to-noise ratio of the database thus making it possible to make a statement about the fundamental quality of the data packet under consideration.

The limit value block is used to recognize spurious values.

A number of methods have been selected for each area from the large number of statistical methods, tests and characteristic variables relating to the blocks mentioned above, and their suitability for integrated measurement data diagnosis has been analysed.

The Jarque-Bera test and the Kolmogoroff-Smirnoff test with the Lilliefors modification (Lillifors test) have been investigated in order to check the normal distribution. The statistical independence test is carried out by analysis of the autocorrelation coefficients and the correlation hypotheses test according to R. A. Fischer, and by successive difference scatter. In the area of characteristic variables, the variation coefficient, the mean square error, the standard error and the median deviation were investigated as characteristic variables for the signal-to-noise ratio. The Z-score test, the spurious-value test according to Grubbs, the spurious-value test according to Nalimov and the quality control chart method were considered for spurious-value checking by means of limit values. The stated methods were selected essentially on the basis of computation complexity and robustness.

The computation complexity is defined by how many new variables and calculations are required for one test. If a method uses variables such as the standard deviation or median and mean values, this method should be preferred since these variables are always calculated as standard.

In contrast, the robustness describes how well a method copes with data that is subject to disturbances. For example, if it is possible to choose between the mean value and the median, the median is always used at this point since this is less susceptible to extreme values. That is to say the median is robust against extreme values. This also applies, for example, to the mean square error. In comparison to the standard deviation, this is likewise robust against extreme values.

In order to allow objective assessment of the suitability of the individual methods for measurement data diagnosis, more than 200 randomly selected measurement files were used as an assessment basis. This data was investigated on a channel-selective basis using individual samples of 30 values each. The rolling-map would not fall continuously, but using the filling and emptying method, for memory and scope reasons.

The test for a normal distribution can be carried out by using various statistical tests. For the purposes of this work, the Jarque-Bera test and the Kolmogoroff-Smirnoff test with the Lilliefors modification (Lillifors test) were investigated, and their suitability for assessment of the normal distribution for the purposes of measurement data diagnosis was analysed.

As can be seen from the relevant specialist literature, the Lillifors test recognizes discrepancies from the normal distribution better than other tests, particularly with small sample quantities. Furthermore, it is considered to be very robust but not very accurate. In contrast to the Lillifors test, the Jarque-Bera test is an asymptotic test which assesses the form of a distribution on the basis of characteristic values for skew and curvature. For comparison of the two tests, it must be remembered that, with regard to the statistical specialist literature: the requirement for a normal distribution is in general regarded as being satisfied when the data to be investigated is “approximately normally distributed”.

The analysis of up to 20,000 channel-selective individual samples showed that the test statistics of the Jarque-Bera tests differed to a considerably greater extent from the test variable for data that is not normally distributed than is the case with the Lillifors test. The null hypothesis is thus rejected considerably “more strongly” (strong decision), which also precludes an approximate normal distribution. In this case, it was found that the Jarque-Bera test makes decisions considerably more conservatively than the Lillifors test when the two tests are compared directly, which is completely adequate for measurement data diagnosis, because of the wording “approximately normally distributed”. The Jarque-Bera test was selected for assessment of normal distribution for these reasons and because of the somewhat reduced calculation complexity.

A total of three different methods were investigated for assessment of statistical independence. In contrast to the calculation of the autocorrelation coefficient (AKK), the successive difference scatter and the correlation test according to R. A. Fischer relate to hypothesis tests.

The test for statistical independence using the autocorrelation coefficient is carried out using the so-called Lag-1 series of the database. A Lag in this context means a value range whose values are shifted through i positions (the autocorrelation function or so-called Lag-i series). The shift results in two data series for which the correlation coefficient is defined. Since this relates to a correlation of the data series with itself, this is referred to as the autocorrelation coefficient. The autocorrelation coefficient can also be calculated by normalisation from the autocorrelation function using equation 5.23.

$${ρ}_{xy} ( τ ) = \frac{{R}_{xx} ( τ )}{{R}_{xx} ( 0 )} \qquad [ Eq . 5.23 ]$$

No explicit value which is defined as an exact measure for independence is mentioned in the relevant specialist literature. However, “Statistical Methods for Quality Improvement”, by Thomas P. Ryan, Second Edition, Wiley & Son Inc; 2000, ISBN 0-471-19775-0, describes analyses using an autocorrelation coefficient of AKK=|0.5|. Furthermore, the following terminology has been implemented:

If ρ_{x,y}=0, then X and Y are said to be uncorrelated,
If ρ_{x,y}≠0, and |ρ_{x,y}|≦0.5, then X and Y are said to be slightly correlated,
If 0.5<|ρ_{x,y}≦0.8, then X and Y are said to be correlated,
If 0.8<|ρ_{x,y}|≦1, then X and Y are said to be highly correlated. By definition, AKK≦|0.5| must be satisfied for independence for signal analysis for the purposes of measurement data diagnosis. In contrast to the hypothesis tests, which produce only a binary result, even any desired threshold can in theory be entered for the analysis of the autocorrelation coefficient. This provides the user with better information about the degree of correlation. The autocorrelation coefficient therefore supplies a quantifiable decision for independence, which the user can easily understand and can configure. Further reasons for the use of the autocorrelation coefficient are that no tabular values need be maintained for the calculation of the test variable and the autocorrelation coefficient is also used at the same time for the correction of the X̅-quality control chart described in this section.

For these reasons, the assessment of the statistical independence is carried out with the calculation of the autocorrelation coefficient with respect to the AKK≦|0.5| limit.

One major statistical tool is the analysis of scatter measures. These are characteristic variables which characterize the variability of a sample or distribution. The standard error, the mean square discrepancy as well as the variation coefficient and the median deviation were investigated for the low-frequency signal analysis.

Particular consideration was given to the variation coefficient since the definition of the variation coefficient corresponds to the reciprocal definition of the statistically formulated signal-to-noise ratio (SNR statistic). The statistically defined SNR statistic is defined as the ratio of the mean value to the standard deviation of the measured signal, and is calculated using equation 5.24.

$${SNR}_{statistic} = \frac{\overline{x}}{s} \qquad [ Eq . 5.24 ]$$

If SNR statistic is quoted in decibels, then this results in the same value as that from equation 5.17. Strictly speaking, this applies, however, only to the steady-state operating point.

$${SNR}_{statisitic} = 20 \cdot {log}_{10} ( \frac{\overline{x}}{s} ) \qquad [ Eq . 5.25 ]$$

This means that the SNR can be calculated using equation 5.25 for the purposes of the low-frequency signal analysis, and assuming a steady state. Since the mean value and the standard deviation are calculated as standard in any case, this results in only a very small amount of additional effort. In addition to the SNR statistic, the other mentioned characteristic values were also investigated, using the same data sets. In this case, the signal quality was assessed by characteristic variables according to equation 5.25, using the SNR statistic.

$${SNR}_{statistic . bin} \{ \frac{0 for SNR < {SNR}_{statistic , crit}}{1 for SNR < {SNR}_{statistic , crit}}$$

The same limit values are used as those for the high-frequency signal analysis:

| | Detection | |
|---|---|---|
| Tests | sharpness | Tolerance |
| SNR_{statistic, crit} | High | 50 dB |
| | Medium | 30 dB |
| | Low | 20 dB |

The decision is justified by the fact that the same function can be used for calculation of SNR statistic as for the high-frequency analysis. This automatically also keeps the configuration effort minimal. At the same time, the computation complexity would also rise if there were a plurality of characteristic variables.

The Nalimov test and the Grubbs test were investigated as typical spurious-value tests for the limit value block. By contrast, the use of methods from process and product monitoring for assessment of the signal quality is novel. Particular attention was paid in this case to the quality control chart method and to the quality rules of Western Electric, the so-called WECO rules.

Quality control charts (QRK) are tools for statistical process monitoring. They are used in an attempt to distinguish between the unavoidable random scatter and the systematic discrepancy resulting from process disturbance. Quality control charts carry out process analysis, following which it is possible to answer the question as to whether the process under consideration is or is not governed with respect to a defined quality feature (for example the mean value). The quality control chart in this case has the task of indicating when the mean value u/o or the standard deviation signal has changed as a result of an undesirable influence. This is also referred to as a stable or undisturbed process, and it is said that the process is under “statistical control”. For the purposes of this work, the analysis is restricted to two quality control charts, specifically the classic Shewhart quality control chart or X̅ chart and to the CUSUM quality control chart.

One of the standard assumptions in statistical process control is the already explained requirement for independent and normally distributed data. In this case, the independence is considerably more sensitive than the normal distribution.

The influence of correlated data on the method of operation of the quality control chart is discussed in detail in “Neue Entwicklungen der statistischen Prozesskontrolle bei korrelierten Daten” [New developments for statistical process control in correlated data] by Schöne, Dissertation 1997, Ulm University. In this case as well, an extensive list of publications relating to this subject can be found in the introduction. At this point, reference will be made only to the works “The effect of serial correlation on the performance of CUSUM tests”, by R. Johnson and M. Bagshaw, Technometrics, or “The use of stochastic models in the interpretation of historical data from sewage treatment plants”, by P. Berthouex, W. Hunter, L. Pallesenu and C. Shih, Water Research 10, 1976, or “Modification of control chart limits in the presence of data correlation”, Journal of Quality Technology, 1978, or “Monitoring sewage treatment plants: Some quality aspects” by P. Berthouex, W. Hunter, L. Pallesenu, Journal of Quality Technology 10 (4), 1978, which all deal predominantly with the Shewhart charts. A comprehensive overview of the problems and effects of correlated data in statistical process control can be found in the works “Time series modelling for statistical process control” by L. Alwan and H. Roberts, Journal of Business and Economic Statistics 6, 1988, or “A multivariate and stochastic framework for statistical process control”, by N. F. Hubele and J. B. Keats and N. F. Hubele (editor), Statistical Process Control in Automated Manufacturing, Marcel Dekker, Inc., New York, N.Y., 1998, or “Statistical process control procedures for correlated observations” by T. Harris and W. Ross, Canadian Journal of Chemical Engineering, 1991, or “Introduction to Statistical Quality Control” by D. Montgomery, John Wiley & Sons, New York, N.Y., 1991, or “Some statistical process control methods for autocorrelated data” by D. Montgomery and C. Mastrangelo, Journal of Quality Technology, 1991, and “Autocorrelated data and SPC” by W. Woodall and F. Faltin, ASQC Statistical Division Newsletter, 1994.

When using quality control charts it is necessary to clarify how often a fault alarm can be expected during the observation and how quickly a systematic fault, for example a mean-value drift, can be recognized.

One measure for an expected fault message is the average run length, which is normally referred to as the ARL. The ARL provides information as to the average length of time for which continuous data points of the undisturbed process must be plotted on a quality control chart before a point outside the monitoring limits is recognized. For a process which is under statistical control, it is therefore desirable to have an ARL which is as high as possible. If the process is not under statistical control, in contrast, it is desirable to have an ARL which is as low as possible since this results in a change in the monitored quality feature being recognized correspondingly quickly. Calculated details relating to ARL from the Shewhart quality control chart and the CUSUM quality control chart are quoted, using the standardised characteristic variables h and k, in NIST/SEMATECH, e-Handbook of Statistical Methods.

TABLE T5.7
Details relating to ARL for CUSUM
and Shewhart quality control charts

| | |
|---|---|
| Mean-value change | h\sqrt{n}/σ |

| (k = 0.5) | 4 | 5 | Shewhart X̅ |
|---|---|---|---|
| 0 | 336 | 930 | 371 |
| 0.25 | 74.2 | 140 | 281.14 |
| 0.5 | 26.6 | 30 | 155.22 |
| 0.75 | 13.3 | 17 | 81.22 |
| 1 | 8.38 | 10.4 | 44 |
| 1.5 | 4.75 | 5.75 | 14.97 |
| 2 | 3.34 | 4.01 | 6.3 |
| 2.5 | 2.62 | 3.11 | 3.24 |
| 3 | 2.19 | 2.57 | 2 |
| 4 | 1.71 | 2.01 | 1.19 |

If k is designed to be 0.5, then the change in the mean value is defined by adding 0.5 to the first column of Table T5.7. In order, for example, to recognize a change in the mean value by 1σ at h=4, the ARL of the CUSUM quality control chart is ART_{CUSOM}=8.38.

The last column in Table T5.7 contains the corresponding ARL for a Shewhart quality control chart for the same mean-value discrepancy. This occurs at ARL_{Shewhart}=1/ρ, where ρ is the probability of a point falling outside the control limits. It is evident from this that, for 3σ limits and an assumed normal distribution, the probability of overshooting the upper limit (UCL) is p=0.00135, and that for undershooting the lower limit (LCL) is likewise p=0.00135. The ARL for overshooting or undershooting the control limits of a Shewhart quality control chart are therefore calculated to be ARL_{Shewhart}=1/0.0027=370.37. This means that, in a controlled process, all 371 values can be calculated with one fault message. However, if the mean value changes by one σ upwards, then the difference between the upper control limit and the offset mean value is now only 2σ (instead of 3σ). It follows from the statistical principles relating to the error components of the standard normal distribution that the probability for exceeding this limit for z=2 is p=0.02275. The difference between the offset mean and the lower limit is now 4σ, and the probability of X̅<−4 of p=0.000032 is so low that it can be ignored. The ARL for the described situation is thus calculated to be ARL_{Shewhart}=1/0.02275=43.96.

One important conclusion resulting from this is that the Shewhart quality control chart is more suitable for perception of major changes, and the CUSUM quality control chart is more suitable for recognition of small changes. In this case, Table T5.7 also shows that the break-even point for this statement is a function of h.

The CUSUM quality control chart is a control chart which also includes previous measurement values for the calculation of the current test variables S_{Hi} and S_{Lo}. In this case, the discrepancy between the sample values and the nominal value accumulates over time, as a result of which even small systematic process changes can be recognized very early and sensitively. The limits of the CUSUM quality control chart are defined as a function of time using the gradient of the accumulation, with the aim of preventing the expected value from being shifted upwards or downwards. To this end, a reference value is subtracted from each measurement value, as a result of which the mean value fluctuates around zero. The mean value of the database is used as a reference for the purposes of measurement data diagnosis. The accumulated characteristic variables of the CUSUM quality control chart are calculated using equation 5.26:

Sₕᵢ=max(0,Sₕᵢ(i−1)+xᵢ− x̅_{database}−k)

Sₗₒ=max(0,Sₗₒ(i−1)+ x̅_{database}−k−xᵢ) [Eq. 5.26]

In this case, S_{Hi}(0)=0 and S_{Lo}(0)=0.

If the result of S_{Hi}(i−1)+xᵢ− x̅_{database}−k<0, then the current CUSUM value for S_{Hi} is set to zero. However, if this value is greater than zero, then S_{Hi} is accumulated. For S_{Lo}, this means that accumulation is carried out if S_{Lo}<0 and is reset to zero if S_{Lo}>0. If S_{Hi} exceeds the critical limit h, then, from then on, the process is considered to be not under statistical control. h=5 and k=0.5 are quoted as guideline values in “Statistical Methods for Quality Improvement”, Thomas P. Ryan, Second Edition, Wiley & Son Inc; 2000, ISBN 0-471-19775-0. Table T5.9 provides an example relating to this.

TABLE T5.8
Example of the CUSUM quality control chart

| | Measurement | | | |
|---|---|---|---|---|
| No. | value | S_{Hi} | S_{Lo} | CUSUM |
| 1 | 324.93 | 0 | 0 | −0.07 |
| 2 | 324.68 | 0 | 0 | −0.39 |
| 3 | 324.73 | 0 | 0 | −0.66 |
| 4 | 324.35 | 0 | 0.15 | −1.31 |
| 5 | 325.35 | 0 | 0 | −0.96 |
| 6 | 325.23 | 0 | 0 | −0.73 |
| 7 | 324.13 | 0 | 0.37 | −1.6 |
| 8 | 324.53 | 0.03 | 0 | −1.07 |
| 9 | 325.23 | 0 | 0 | −0.84 |
| 10 | 324.6 | 0 | 0 | −1.24 |
| 11 | 324.63 | 0.13 | 0 | −0.61 |
| 12 | 325.15 | 0 | 0 | −0.46 |
| 13 | 328.33 | 2.83 | 0 | 2.87 |
| 14 | 327.25 | 4.58 | 0 | 5.12 |
| 15 | 327.83 | 6.91 | 0 | 7.95 |
| 16 | 328.5 | 9.91 | 0 | 11.45 |
| 17 | 326.68 | 11.09 | 0 | 13.13 |
| 18 | 327.78 | 13.37 | 0 | 15.91 |
| 19 | 326.88 | 14.75 | 0 | 17.79 |
| 20 | 328.35 | 17.6 | 0 | 21.14 |

The Shewhart quality control chart is the most frequently used control chart. It can be used individually or in combination with other control charts. The samples which are analysed in the chart may in this case be either individual values or the result of a sample taken of size n, the so-called subgroups. In the first case, these are referred to as X charts, and in the second case as X̅ charts. The consideration of subgroups has a certain damping effect and leads to the chart being less sensitive to individual extreme values. Where Shewhart quality control charts are referred to throughout the rest of this work, this expression always relates to X̅ charts.

Since, in general, neither the standard deviation nor the mean value of the total population under consideration from the ongoing process are known, these must be calculated by appropriate estimators. To do this, a greater number of samples, of size n, are taken from the ongoing process. As can be seen from “Statistical Methods for Quality Improvement”, by Thomas P. Ryan, Second Edition, Wiley & Son Inc; 2000, ISBN 0-471-19775-0, at least 20 subgroups with n=4 to 5 elements per subgroup can be recommended for Shewhart quality control charts.

Normally, the X̅ chart is encountered in combination with an s chart. The s chart is in this case first of all used to check whether the distribution of the quality feature (for the purposes of this work, this is the mean value) can be considered to be stationary. For this purpose, the standard deviation sᵢ and the mean value X̅ᵢ are first of all calculated for each subgroup i. The average standard deviation of the subgroups can now be calculated using the number of subgroups m, using equation 5.27:

$$\overline{s} = \frac{1}{m} {\sum }_{i = 1}^{m} {s}_{i} \qquad [ Equation 5.27 ]$$

A further value, the so-called s̅/c₄ statistic is also required to calculate the control limits for the s chart. s̅/c₄ is an estimator, true to expectation, for the standard deviation of the unknown basic totality σ. The factor c₄ can in this case be calculated either taking account of the sample size n using equation 5.28

$${c}_{4} = \sqrt{\frac{2}{n - 1}} \cdot \frac{( \frac{n}{2} - 1 ) !}{( \frac{n - 1}{2} - 1 ) !} \qquad [ Equation 5.28 ]$$

or can be taken from a table in the specialist literature.

The control limits for the s charts are calculated using s̅ and c₄ using equation 5.29a and equation 5.29b.

$$\begin{matrix}U C L = \overline{s} + 3 \frac{\overline{s}}{{c}_{4}} \sqrt{1 - {c}_{4}^{2}} = {B}_{4} \overline{s} & [ Equation 5.29 a ] \\ L C L = \overline{s} - 3 \frac{\overline{s}}{{c}_{4}} \sqrt{1 - {c}_{4}^{2}} = {B}_{3} \overline{s} & [ Equation 5.29 b ]\end{matrix}$$

The parameters B₃ and B₄ can likewise be obtained from the specialist literature. The control limits for the X̅ chart are calculated in the same way. First of all, the overall mean value X̅ is calculated using equation 5.30.

$${x}^{\overline{\_}} = \frac{1}{m} {\sum }_{i = 1}^{m} {\overline{x}}_{i} \qquad [ Equation 5.30 ]$$

The limits are thus calculated using equation 5.31a and equation 5.31b to be:

$$\begin{matrix}U C L = {x}^{\overline{\_}} + 3 \frac{s}{{c}_{4} \sqrt{n}} = {x}^{\overline{\_}} + {A}_{3} \overline{s} & [ Equation 5.31 a ] \\ L C L = {x}^{\overline{\_}} - 3 \frac{s}{{c}_{4} \sqrt{n}} = {x}^{\overline{\_}} - {A}_{3} \overline{s} & [ Equation 5.31 b ]\end{matrix}$$

The parameter A₃ can likewise be found in the specialist literate.

If the assumptions relating to independence and normal distribution are severely infringed, then this leads, particularly in the case of correlated data, to an incorrect calculation of the control limits. As stated in “Statistical Methods for Quality Improvement”, by Thomas P. Ryan, Second Edition, Wiley & Son Inc; 2000, ISBN 0-471-19775-0, the limits for s charts and X̅ charts are generally defined as being too low for correlated data. The influence of correlated data on the method of operation of the Shewhart quality control chart has been investigated in detail in “Modification of control chart limits in the presence of data correlation”, by A. Vasilopoulos and A. Stamboulis, Journal of Quality Technology, 1978, and solution approaches for this problem have been published. However, these approaches are much too complex for centralized measurement data diagnosis since different diagrams with correction values are required. In order nevertheless to take account of the effect of correlated data, an empirical correction factor has been introduced in the course of the present work which results in the control limits of the X̅ chart being widened as a function of the autocorrelation coefficient AKK. The corrected limits are calculated as follows, using equation 5.32a and equation 5.32b:

$$\begin{matrix}U C L = {x}^{\overline{\_}} + 3 \frac{\overline{s}}{{c}_{4} \sqrt{n}} + \frac{1}{1 - AKK} & [ Equation 5.32 a ] \\ L C L = {x}^{\overline{\_}} - 3 \frac{\overline{s}}{{c}_{4} \sqrt{n}} - \frac{1}{1 - AKK} & [ Equation 5.32 b ]\end{matrix}$$

The correction is carried out in the region where the autocorrelation coefficient is greater than 0.5. AKK=AKKₘₐₓ is limited to 0.9 in order to ensure that the limits are not drawn too far apart.

The WECO rules were developed at Western Electric in order to monitor manufacturing processes. These rules are based on the sample standard deviation s and the significance limits for 1s, 2s and 3s. The background to the rules is that the probability of occurrence of one of the described cases, being p=0.0027, should not be considered random, but should be considered to be a fault since, in the case of normally distributed data, 99.73% of the data considered will be within ±3s.

The rules are defined as follows:
1. At least one value undershoots the 3s limit (zone A)
2. Two of three successive values overshoot the 2s limit (zone B)
3. Four of five successive values overshoot the is limit (zone C)
4. Eight successive values are on one side of the centre line.
5. The trend rule states that six successive rising or falling values indicate a trend behaviour.

If the individual methods are compared, it is evident that only the Grubbs test and the Z-score test produce the same results and the two methods, in comparison, result in a considerably more conservative cutoff. That is to say, fewer spurious values are recognized. In contrast, when the X̅ quality control chart and the WECO rules are compared, it is evident that the WECO rules come into effect considerably more frequently than the X̅ quality control chart. This is a result of the group formation. In the case of the WECO rules, each one is included in the assessment with no damping. In the case of the X̅ quality control chart, extreme values are attenuated by the group formation. However, in the case of the WECO rules, the point sequence likewise plays an important role. No individual optimum method can therefore be quoted for the limit-value block. In this case, it must be remembered that all the methods quoted are distribution-dependent to a greater or lesser extent and that the Jarque-Bera test recognizes a normal distribution which is likewise more or less strongly pronounced. A number of methods are therefore used in parallel for recognition of spurious values. The combination of the following methods has been found to be extremely objective and robust:
Nalimov: Nalimov test at the 95% level with two recognized spurious values in the test interval.
Grubbs: rejection of the null hypothesis, H₀ (no spurious values) at the 95% level
Quality control charts: one or more group values are outside the quality control chart
Z score: one or more sample values are outside the interval −3.5<z<3.5.

For the subsequent fault isolation and fault recognition, a single binary result must be produced from the individual blocks of the low-frequency signal analysis. Specific logic has been developed for this purpose, and this is illustrated schematically in FIG. 26. First of all, the equations 5.33a to 5.33c were developed for the signal-quality logic, and these are used to form the block results of the binary individual results:

$$\begin{matrix}E R B = \frac{Steady state + Sudden change + JBT + AKK}{8} & [ Equation 5.33 a ] \\ E K G = \frac{{SNR}_{statistic . bin}}{3} & [ Equation 5.33 b ] \\ E G W = \frac{N + Grubbs + QRK + Z}{8} & [ Equation 5.33 c ]\end{matrix}$$

The block results are accumulated once again and are compared with the test variable of the signal quality PGSQ. This is adapted such that in each case one individual method cannot be satisfied in the steady-state block and in the limit values block without this producing a fault in the signal quality area.

The procedure will be explained using a brief example. By way of example, the evaluation of the database for a measured torque produces the result illustrated in Table T5.9:

TABLE T5.9

| | Characteristic | |
|---|---|---|
| Constraint | variables | Limit values |
| JBT = 0 | SNR_{statistic} = 39.34 dB | Nalimov = 0 |
| AKK = 0 | SNR_{statiscic} < | Grubbs = 0 |
| | SNR_{statistic, crit} | |
| Steady state = 1 | SNR_{statistic, bin} = 0 | Quality control |
| | | chart = 0 |
| Sudden change = 0 | | Z-score = 0 |
| Block result = 0.125 | Block result = 0 | Block result = 0 |

Overall result = 0.125 + 0 + 0 = 0.125 < 0.5 => Signal quality = 0

The associated quality control chart is shown in FIG. 27, and the z-transformed distribution function associated with this is illustrated in FIG. 28. In this case, FIG. 27 shows the 30 sample values xᵢ as an MD curve, and the group values of the quality control chart as xbar points. UCL and LCL indicate the upper control limit and the lower control limit. Apart from this, this example also shows the damping effect of the X̅ quality control chart. Although x_{g}<LCL and x₂₄<LCL, this is damped by the group formation process to such an extent that no fault message is produced.

When two or more measurement variables of the same type (for example 4×exhaust-gas temperature T3) have been selected by the configuration process, it is necessary to consider whether the plausibility functions should be calculated individually for each channel or whether the calculation should be carried out only for one representative variable.

The equality of the variables involved can easily be investigated by means of the median comparison by calculating the median from all the variables and by placing a configurable tolerance band around this. For all the variables which are within the tolerance band, it is irrelevant which of the variables will still be used for the following plausibility calculation. This process leads to a considerable reduction in the system load, with the same validity.

However, the median comparison is also at the same time an efficient fault recognition method. In this context, FIG. 29 shows a measurement of the exhaust-gas temperatures for cylinder 1 to cylinder 4 on a 2.21 Otto-cycle DI. The knock recognition in the ECU was activated as a result of a defective hydraulic lifter, which shifted the ignition time in the late direction for cylinder 1. The resultant rise in the exhaust-gas temperature and the change in the ignition time for cylinder 1 then led to fault recognition by means of the median comparison. In this case, a fault of T3_{—}1 and ZZP1 was emitted as a fault message. The subsequent fault analysis led to the fault cause “hydraulic lift defective”.

In the simplest case, the test rig system should provide accurate information about an operating point and variation-point change. In order to allow this function to also be used independently of the test rig system and for any desired measurement signals, however, the operating-point change recognition is implemented as a specific function. In general terms, it is used for identification of sudden changes in a defined measurement variable, and can therefore also be referred to as sudden-change recognition.

One approach is based on the hypothesis that the median values of two samples which are taken from the same measurement series but are shifted through t+1 differ considerably from one another in the event of an operating-point change. However, this also means that a sudden change in a variable must lead to a significant change in the system behaviour. Furthermore, it is assumed that only nominal variables or reference variables actually have the capability to change suddenly. These variables include, for example, the rotation speed, the torque or the accelerator pedal position, which are also referred to as operating-point variables. Variables such as the ignition time (ZZP), the AGR rate or other variables which can be adjusted by the ECU are referred to as factors or variation variables.

As is sketched in schematic form in FIG. 30, the sudden-change recognition operates with two rolling-map memories which are each shifted through a value (t+1) with respect to one another. The median is calculated from both rolling-map memories. An operating-point change is recognized precisely when equation 5.34a or equation 5.34b is satisfied.

\tilde{x}₂>\tilde{x}₁+tolerance (positive sudden change) [Relationship 5.34a]

\tilde{x}₂<\tilde{x}₁−tolerance (negative sudden change) [Relationship 5.34b]

In addition to the time of a sudden change, it is therefore also possible to determine the direction of the change at the same time.

In general, a recognized sudden change is also associated with the “not steady state” state. The result signal quality=1 is therefore initiated automatically in the logic block, as described above, of the signal analysis. In formal terms, this statement is completely correct since the required signal quality did not exist at this time. However, if this is caused by a deliberate operating-point change, no fault message should be produced at this point, and instead the fault recognition should be deactivated. For this purpose, the result of the operating-point change recognition is at the same time also used as an enable condition in a higher-level logic loop.

FIG. 31 shows how a sudden change in the engine torque at a constant rotation speed acts on various response variables such as the exhaust-gas temperature or the oil temperature and water temperature. In addition to detection of sudden changes in reference variables, the operating-point change recognition plays a critical role in the identification of the signal profile. The start point and the start values for the non-linear regression can also be determined at the same time by the exact determination of the operating-point change.

The steady-state recognition is relevant for all function elements which are predicated on a steady-state system behaviour. This applies in particular to all statistical functions for signal analysis, and to a large number of plausibility methods and stationary diagnoses.

In this case, the steady state is determined individually for each selected measurement channel. By way of example, this is an important enable criterion for channel-specific signal analysis and for some plausibility methods. In order to allow the computation complexity to be reduced, the steady-state recognition can also be applied only to a small number of variables or even only to one variable, which is then used as an indicator for the entire process state. Exhaust-gas, oil or water temperatures are variables such as these. The use of this method depends on the respective test rig situation, and is therefore configurable.

From the methodological point of view, steady-state recognition is a nominal/actual comparison for straight lines. A limit gradient must be entered for each channel for this purpose, during the configuration process. In this case, the gradient should cover the quasi-steady-state. This means that the gradient is already relatively “flat”, but is not yet asymptotic.

Since measurement data generally has a stochastic behaviour, a corresponding data model must be created for the corresponding measurement signal. Regression modules are particularly highly suitable for this purpose, in particular the three approaches of linear regression, nonlinear regression using the Gauss-Newton method, and multiple regression.

In contrast to linear regression, the previously described operating-point change recognition is required for the methods of nonlinear and multiple regression. The object of this is to define the precise starting point for the regression algorithm, since the model profile can otherwise not be calculated correctly and the subsequent gradient comparison will be incorrect.

The testing of the described approaches has led to the result that the iterative methods are very temperamental, and are highly dependent on recognition of a significant operating-point change. In addition, the computation complexity needed to solve the corresponding matrices should not be ignored. As an additional statement, a model equation is available, but this is only as good as the approach that is adopted. However, this does not result in any advantage in comparison to linear regression, with respect to the sought straight line.

The effort is therefore out of all proportion to the benefit. In contrast, linear regression is characterized by a robust response, little computation complexity and adequate accuracy for the calculation of the sought straight line, as is also expressed in FIG. 32. Linear regression is therefore particularly preferable for gradient calculation for the purposes of integrated measurement data diagnosis. In order to illustrate this better, FIG. 33 shows the range from 0 to 240 s, from FIG. 32, in the form of an enlarged detail. This shows particularly well that the local, linear model elements (LLM) follow the measurement data profile for steady-state recognition, with adequate accuracy.

Independently of the identification methods used, the calculated straight line of the local linear model elements is compared on a channel-specific basis with a limit straight line, defined during the configuration process, according to equation 5.35.

$$\frac{d y}{d t} {\vert}_{t = {t}_{n}}$$

≦Limit gradient=>steady state achieved [Relationship 5.35]

In order to avoid continuous oscillation between the states of “steady state reached” and “steady state not reached”, a steady-state counter was introduced. This counter indicates the number of the subsequent iteration steps for which equation 5.35 must be satisfied before a channel is assessed as being “in the steady state”. A value of 5 seconds is proposed as the basic setting in this case. This means that the corresponding channel must already have been in the steady state for 5 s, when using an operating frequency of 1 Hz, before this is indicated. The delay which results from this is of only secondary importance during practical operation and on the other hand leads to better information quality for the user.

During the plausibility check, the physical system behaviour is compared with an expected nominal behaviour. The nominal behaviour is described by logic relationships and by equations or models. For this purpose, main groups have been defined for temperature, pressure, mass flows and exhaust-gas emissions, and these are combined in corresponding toolboxes. A toolbox should be understood as a functional collection which combines a plurality of functions relating to fault recognition in one processing unit. The aim is to achieve simple, robust and generally applicable methods with a good detection and separation sharpness.

The detection sharpness is in this case both a method characteristic and a parameter, and is therefore a measure of the smallest fault which can be detected reliably. Because of certain simplifications or assumptions, the detection sharpness must be regarded as a method characteristic, since these assumptions and simplifications do not allow any more accurate statement of the corresponding method. Since the user can adjust the detection sharpness as appropriate for the test task, it can, however, also be considered to be a parameter.

The separation sharpness was introduced for fault isolation purposes for automatic and generic evaluation of the fault recognition and is defined as the capability of a method to associate a fault with a faulty measurement channel. By way of example, the inequality T3>T2 has two terms of equal value and thus a separation sharpness of p=0.5. The appliance check methods always have a separation sharpness of p=1 since only one channel is ever considered here. The comparison between a measured lambda value and the calculated lambda from the air and fuel mass flow has, for example, a separation sharpness of p=0.33 since three equivalent information items are used in the test.

A number of functions relating to fault recognition will be introduced in the following text, and will be discussed in particular with reference to robustness and separation sharpness. These results will then be used for fault isolation and fault classification.

The position and therefore also the temperature level can be deduced by naming the individual temperature measurement points. The temperature hierarchy that results from this means that the logical relationships can be tested using simple inequalities. In this context, FIG. 34 shows the configuration of the temperature toolbox with the corresponding input and output variables.

For better association and because of system-dependent special features, a distinction is drawn in the case of the temperature toolbox between normally aspirated engines and boosted engines with exhaust-gas turbochargers or compressors.

A turbo configuration, in contrast to a normally aspirated engine generally has measurement points before and after the boost air cooler. In the case of a double-flow arrangement, many variables occur in a duplicated form, as can be seen by way of example, on a practical example in FIG. 35 such that, with regard to the implementation of the methods and jobs, care must be taken to ensure that these can also be implemented in a duplicated form.

The master classes, which have already been described above, were introduced for the situation in which a plurality of variables of the same type occur. In the case of multiple use of one master class, a median comparison of the corresponding variables is carried out in the first step, in order to reduce the computation complexity. If all the relevant variables pass this test, the measurement variables can be regarded as being equivalent, and further calculation is carried out using the first variable as a “representative”. If one variable falls out of the median test, this will have already been recognized as a conspicuous variable and therefore will also not be used as a variable for further calculations. The association between the corresponding measurement points and the individual master classes takes place in the standard name mapping process during the configuration process

Table T5.10 shows which tests are a component of the temperature toolbox and the engine types to which these apply. In order to avoid false alarms, the temperature toolbox method should be used only at steady-state operating points (enable condition). By way of example, this is because of the behaviour of the exhaust-gas temperatures on the TDI in an NEEDC cycle (FIG. 36). As can easily be seen, the situation in which T4>T3 occurs occasionally throughout the entire cycle as a result of overrun phases. Although this would lead to a formally correct fault recognition this is not, however, caused by a faulty sensor but by an unstable operating point. For this reason, the temperature-toolbox methods should be switched off when overrunning and at non-steady-state operating points.

With respect to the separation sharpness, it should be noted that all inequalities have a separation sharpness of p=0.5. The interval testing of the water and oil temperature leads to a separation sharpness of p=1. A separation sharpness of p=1/n is applicable to the comparison of a number of temperatures of the same type, where n in this case describes the number of channels involved.

TABLE T5.10
Fault recognition methods in the temperature
toolbox, as a function of the engine type

| Test | Validity |
|---|---|
| T3 > T0 | General |
| T3 > T1 | |
| T1 ≈ T0 or \|T1 − T0\| < 10 | |
| TWA > TWE | |
| TKA > TKE | |
| TOilmin < TOiL < TOilmax | |
| TWAmin < TWA < TWAmax | |
| T2 > T0 | Boosted engine |
| T2 > T1 | |
| T3 > T2 | Boosted engines with boost air cooler |
| T3 > T2s | |
| T2 > T2s | |
| T2s > T0 | |
| T2s > T1 | |
| T3_{cyl1} ≈ T3_{cyl2} ≈ . . . ≈ T3_{cyln} | Engines with a plurality of exhaust- |
| | gas temperature measurement points |
| T3 > T4 | Boosted engines with exhaust-gas |
| T4 > T0 | turbocharger |
| T4 > T1 | |
| T4 > T2 | Boosted engines with exhaust-gas |
| T4 > T2s | turbocharger and boost air cooler |
| T4_{Bank1} ≈ T4_{Bank2} | Boosted engines with exhaust-gas |
| | turbocharger in a two-flow arrangement |
| | (for example V6, V8 or V12) |

The individual pressure measurement points are characterized on the basis of the measurement point position, in precisely the same way as for fault recognition in the temperature area. This results in a similar hierarchy as that for the temperature toolbox. However, in the case of the pressure toolbox as illustrated in FIG. 37, the distinction between the different engine concepts is even more important than in the case of the temperature toolbox.

Table T5.11 shows which tests are components of the pressure toolbox, and the engine types to which these apply. In this case, precisely the same restrictions must be observed for the pressure toolbox as for the temperature toolbox. In addition, certain load ranges must be noted in particular for turbocharging.

During steady-state operation (from pme≈1 bar), the booster generally always produces a small overpressure in comparison to the environment. This assumption justifies the methods for testing the boost pressure against the pressures p₀ and p₁. This check should not be carried out when the loads are low (pme<1 bar) since, in this case, the booster can act as a restrictor. This is the case in particular when the booster bearing points are cold, and because of the bearing friction associated with this (“difficulty in movement on the booster”).

With regard to the separation sharpness, it should be noted that all the inequalities have a separation sharpness of p=0.5. The interval test of the oil pressure leads to a separation sharpness of p=1. A separation sharpness of p=1/n is applicable to the comparison of a number of pressures of the same type, where n in this case describes the number of channels involved.

TABLE T5.11
Fault recognition methods for the pressure
toolbox, as a function of the engine type

| Test | Validity |
|---|---|
| P3 > p0 | General |
| P3 > p1 | |
| pOilmin < pOiL < pOilmax | |
| P3 > p4 | Boosted engines with exhaust-gas |
| | turbocharger |
| P2 > p2s | Boosted engines with boost air |
| P2 > p0 | cooler/only for pme ≧ 1 bar and Tₒᵢₗ ≧ |
| P2 > p1 | 60° C. |
| P3_{Bank1} ≈ p3_{Bank2} | All fittings with two-flow arrangement |
| | (for example V6, V8 or V12) |
| P4_{Bank1} ≈ P4_{Bank2} | Boosted engines with exhaust-gas |
| | turbocharger and a two-flow |
| | arrangement (for example V6, V8 or |
| | V12) |

The C balance (carbon balance) is based on the mass maintenance rule and is in principle suitable both for plausibility checking of the exhaust-gas concentration, in just the same way as for checking the air and fuel mass flows. Methodologically, this is a component of the exhaust-gas toolbox as illustrated in figure.

In the case of the C balance, the carbon mass flows entering and leaving the engine are taken into account. For the equilibrium state (during steady-state operation), the input and output carbon masses must be the same, taking account of a configurable tolerance.

The components of the C balance comprise the carbon mass flows introduced into the engine by air, fuel and oil, and those leaving via the exhaust gas. The C component introduced by burnt oil can be estimated only with difficulty and is therefore ignored in the balance. The fact that this is ignored must be taken into account in the definition of the tolerances for the C balance.

Furthermore, it is necessary to take account of the fact that exhaust-gas mass flows, exhaust-gas molar masses and exhaust-gas concentrations always relate to moist raw exhaust gas, this resulting in the requirements that it is necessary to know which exhaust-gas components are measured dry and which are measured moist, and that the dry measured concentrations must be converted to moist exhaust gas. A so-called moisture correction is required to do this.

The concentrations of the moist raw exhaust gas (raw exhaust-gas emission, raw emission) is always used for all exhaust-gas calculations. However, for appliance reasons, a distinction must be drawn between dry and moist measurement for the exhaust-gas measurement. This situation necessitates appropriate conversion of the components which are measured dry. If the exhaust gas is cooled in a gas cooler upstream of an exhaust-gas analyzer, then this is referred to as dry exhaust-gas measurement. In the case of these analyzers, the combustion water is condensed out before analysis. This leads to simpler analyzers.

In the case of moist exhaust-gas measurement, the corresponding analyzer (for example FID) is heated completely in order to prevent condensation of the combustion water. FIG. 39 shows the influence of moisture correction using the example of the output carbon mass flow. The difference between the corrected and uncorrected mass flow is about 5.2%, and should therefore not be ignored.

The calculation of the correction factor between dry and moist exhaust-gas measurement is carried out in accordance with Council Guideline 91/441/EEC dated Jun. 26, 1991, L 242 1 30.8.1991. According to this approach, the correction factor is calculated as follows:

$$\begin{matrix}{t}_{corr} = ( 1 - {F}_{FH} \cdot \frac{{m}_{fuel}}{{m}_{air}} ) - {KW}_{2} & [ Equation AIII .1 ] \\ {F}_{FH} = \frac{1.969}{( 1 + \frac{{m}_{fuel}}{{m}_{air}} )} & [ Equation AIII .2 ] \\ {KW}_{2} = \frac{1.608 \cdot {H}_{a}}{1000 + ( 1.1608 \cdot {H}_{a} )} & [ Equation AIII .3 ] \\ {H}_{a} = \frac{6.22 \cdot {R}_{a} \cdot {p}_{a}}{{p}_{B} - {p}_{a} \cdot {R}_{a} \cdot {10}^{- 2}} & [ Equation AIII .4 ] \\ {p}_{a} = 611.15 \cdot {10}^{\frac{7.602 \cdot T}{241.2 + T}} & [ Equation AIII .5 ]\end{matrix}$$

In this case, m_{fuel} is the fuel mass flow, mₐᵢᵣ is the inducted air mass flow, Rₐ is the air humidity, pₐ is the ambient pressure and T is the temperature of the inducted air.

After calculation of the correction factor t_{corr}, all the exhaust-gas components which are configured as dry are converted from dry to moist using t_{corr} according to equation AIII.6.

xₘₒᵢₛₜ=x_{dry}−t_{corr} [Equation AIII.6]

In theory, the air humidity must likewise be considered after a moisture correction. However, this is ignored for the purposes of this work.

In addition to moisture correction, a conversion from space components to mass components is often also required. The measurement values of the exhaust-gas analyzers represent space components, which can be converted to weight components using the appropriate molar mass, using equation AIII.7.

$${g}_{i} = {r}_{i} * \frac{{M}_{i}}{{M}_{mixture}} \qquad [ Equation AIII .7 ]$$

In order to calculate the mass flow of the individual components, the weight component is multiplied by the total mass flow (Equation AIII.8).

$${r}_{i , dry} * \frac{{M}_{i}}{{M}_{mixture}} * {\dot{m}}_{mixture} \qquad [ Equation AIII .8 ]$$

The actual test variable for the C balance (ECB) is calculated using equation 5.36

$$E C B = \frac{{\dot{m}}_{carbon , supplied} + {\dot{m}}_{carbon , output}}{{\dot{m}}_{carbon , supplied}} \qquad [ Equation 5.36 ]$$

A fault is recognized when the relationship 5.37 is not satisfied.

UG≦ECB≦OG [Relationship 5.37]

In contrast to fault recognition in the area of pressure and temperature, the C-balance is in principle applicable to all engine types. When the load is low (pme<1 bar), the method should not be used since, in this area, the air and fuel mass flow tend to zero, and the potential for false alarms therefore rises sharply. Furthermore, it must be remembered that the normal exhaust-gas instrumentation is generally not intended for dynamic operation. For this reason, the C-balance should be used only for steady-state operating points.

As a result of the simplifications made and the factors that are ignored, and because of measurement inaccuracies in the exhaust-gas, air and fuel mass flow measurement, the tolerances should be chosen to be not less than 10% for robust and nevertheless critical fault recognition. Table T5.12 shows a proposal for the corresponding tolerances as a function of the detection sharpness.

| | Detection | |
|---|---|---|
| Tests | sharpness | Tolerance |
| UG ≦ ECB 100 ≦ OG | High | 10% |
| | Medium | 15% |
| | Low | 20% |

As has already been mentioned somewhat further above, in addition to the detection sharpness, the separation sharpness or a method is also important. In the case of the C-balance, because of the moisture correction, all of the exhaust-gas measurement variables (HC, CO, CO2, O2, NOX) and the mass flows for air and fuel are also included in the balance. This is based on the assumption that the molar masses, the fuel data and the lambda that is included are correct.

On the assumption that all the variables are equivalent, this therefore results in a separation sharpness of p= 1/7≈0.14. This assumption is, of course, incorrect since, for example, in the case of a diesel engine, the variables O2 and CO2 are in the percentage % range and HC, CO and NOX are in the ppm range. The factor between these variables is therefore 10,000. This means that even major errors in the variables HC, CO or NOX lead to only minor effects in the C-balance. In order to take account of this situation, the influence of the individual components on the C-balance was investigated using a stage measurement on the 2.0 l TDI. The following points were approached for the measurement:

| Rotation speed | Torque | Stage time |
|---|---|---|
| 2000 rpm | 50 Nm, 100 Nm, 150 Nm | 300 s |

For the purposes of the investigation, all the components have a 50% error (measurement value*1.5) applied to them successively, and they were compared with the original measurement. The result is illustrated in FIG. 40.

With reference to FIG. 40, it can first of all be seen that, in the case of a fault-free measurement, this results in a discrepancy of 5% to 10% between the carbon mass flows flowing in and those flowing out, thus justifying the statement of the minimum detection sharpness of 10%.

An error of 50% with respect to the correct measurement value in the air or fuel mass flow (ML and MB, respectively) and in the CO2 concentration leads, as shown in FIG. 39, to a significant discrepancy in the result of the C-balance. A corresponding error in the variables NOX, CO, O2 and HC in contrast does not have any significant effects.

Since the CO2 emission is used only for calculating the output carbon mass flows, the artificial 50% error can be seen in a negative C-balance.

That is to say more carbon is output than is supplied. In contrast, the air mass flow is included on both sides of the balance. In this case, however, it must be remembered that the CO2 concentration of the inducted air (approximately 350 ppm) is considerably less than the concentration in the exhaust gas. In consequence, the effect on the output side is also considerably greater than on the supplied side. This is evident in a negative C-balance.

Precisely the opposite situation occurs when considering the fuel mass flow. In this case, the influence on the supplied side resulting from the term relating to the fuel that is supplied is considerably greater than on the output side. This is characterized by a positive C-balance.

The behaviour that has just been described is likewise reversed, on the basis of the stated argument, for the opposite fault situation. However, the effect is actually no so clearly pronounced for relatively minor discrepancies.

It can be seen from this that the separation sharpness of the C-balance in the area of the mass flows and in the case of the CO2 concentration can be considered to be good. For the variables HC, CO, NOX and O2, the separation sharpness can be considered to be virtually zero. In the case of CO, the distinction must still be drawn between Otto-cycle and diesel engines. The C-balance thus achieves the following channel-specific separation sharpnesses:

TABLE T5.13
Channel-specific separation sharpness of the C-balance

Separation sharpness p

| Channel | Otto-cycle | Diesel |
|---|---|---|
| HC | 0.0001 | 0.0001 |
| CO | 0.25 | 0.0001 |
| CO2 | 0.25 | 0.25 |
| O2 | 0.25 | 0.25 |
| NOX | 0.0001 | 0.0001 |
| ML | 0.25 | 0.25 |
| MB | 0.25 | 0.25 |

In addition, a feature effect which is particularly valuable for subsequent fault isolation and fault classification can also be derived from the C-balance. A significant negative discrepancy of the C-balance can accordingly be used as a feature for a positive error in the air mass measurement or in the CO2 measurement. A significant positive discrepancy indicates a positive error in the fuel mass flow measurement. In this case, positive means that the measurement value is too high.

The oxygen balance is based on the same approach as the already described C-balance. In this case, the oxygen mass flows entering and leaving the engine are balanced. FIG. 41 shows the configuration of the O2 toolbox.

The actual test variable of the O2 balance (EO2B) is calculated using equation 5.38.

$$EO 2 B = \frac{{m}_{O .2 , supplied} - {m}_{O .2 output}}{{m}_{O .2 supplied}} \qquad [ Equation 5.38 ]$$

A fault is recognized when the relationship 5.39 is not satisfied.

UG≦EO2B≦OG [Relationship 5.39]

In precisely the same way as the C-balance, the oxygen balance should be used only for steady-state operation and when pme>1 bar. Table T5.14 is a proposal for the corresponding tolerances as a function of the recognition sharpness.

TABLE T5.14
Guideline values for the detection sharpness for the O2 balance

| | Detection | |
|---|---|---|
| Tests | sharpness | Tolerance |
| UG ≦ EO2B 100 ≦ OG | High | 10% |
| | Medium | 15% |
| | Low | 20% |

The scenario from the previous section will be used for the discussion of the separation sharpness. The result is illustrated in FIG. 42.

As expected, this shows a somewhat different picture to that for the C balance. Although the effect of the error on the air and fuel mass flow can be seen, it is still below the recommended detection threshold, however. The effects resulting from a 50% error in the channel or in the CO2 channel are in contrast considerably significant. The feature effect in the negative direction is explained by the “excessively high” outlet oxygen mass flow. This means that a significant negative discrepancy in the O2 balance can be derived as a feature for a positive error in the case of the O2 measurement or in the case of the CO2 measurement.

The O2 balance thus achieves the following channel-specific separation sharpnesses:

TABLE T5.15
Channel-specific separation sharpness of the O2 balance

Separation sharpness p

| Channel | Otto-cycle | Diesel |
|---|---|---|
| HC | 0.0001 | 0.0001 |
| CO | 0.2 | 0.0001 |
| CO2 | 0.2 | 0.25 |
| O2 | 0.2 | 0.25 |
| NOX | 0.0001 | 0.0001 |
| ML | 0.2 | 0.25 |
| MB | 0.2 | 0.25 |

For the purposes of measurement data diagnosis, it is possible to determine different lambda values, and to compare them. This always relates to the global air/fuel ratio, which describes the relationship between the input and output variables at the steady-state point. FIG. 43 provides an overview of the overall function of the lambda comparison.

As can be seen from FIG. 43, there are in principle three information sources for the calculation or measurement of the respective lambda values, specifically lambda as a measurement value (lambda of the ECU from the engine/vehicle's own lambda probe (λECU) or lambda as a measurement value of an external probe (λprobe)), calculated lambda from the air and fuel mass flow (λair/fuel), or calculated lambda from the raw exhaust-gas emissions (λBrettschneider).

The purpose of the lambda comparison is essentially to recognize faults in the area of the exhaust-gas and mass flow by comparison of redundant variables. The individual results are processed in the logic toolbox. Methodologically, the lambda comparison is associated with the mass-flow toolbox.

In order to reduce the computation complexity for the Brettschneider formula, the following simplifications have been made:

Data relating to the air humidity and relating to the ambient temperature is defined in the configuration process (for example φ=50% for TUmg=20° C.). The oil consumption is set to 0. Sulphur-free fuel is assumed. The concentrations of the compounds NH3, H2S, H2 in the exhaust gas are so low that they are ignored. Large proportions of the HC compounds CH4, CH3OH and HCHO are also covered by the FID, and the rest is ignored.

The test rules can be derived from Table T5.16 from λBrettschneider, λair/fuel and λprobe. Since it should not be expected that the calculated and/or measured λ values will be precisely the same, a certain tolerance must be permitted in a comparison. This situation is taken into account by the ≅ sign.

The tolerance is configurable and, at the same time, is also an indicator of the detection sharpness of the individual test rules.

In order to allow objective description of the conflict of aims between good robustness and strict fault recognition, the influence of the simplifications relating to the Brettschneider formula and the influence of the operating point and of the various measurement methods has been analysed.

TABLE T5.16
Fault recognition methods using the lambda comparison

| Test | Validity |
|---|---|
| λ_{Brettschneider} ≅ λ_{air/fuel} | General |
| λ_{Brettschneider} ≅ λ_{ECU} | |
| λ_{Brettschneider} ≅ λ_{probe} | |
| Λ_{air/fuel} ≅ λ_{probe} | |
| Λ_{air/fuel} ≅ λ_{ECU} | |
| Λ_{probe} ≅ λ_{ECU} | |
| 0.7 ≦ λ_{probe} ≅ λ_{ECU} ≅ λ_{Brettschneider} ≦ 1.3 | Otto-cycle engines |
| 1.2 ≦ λ_{probe} ≅ λ_{ECU} ≅ λ_{Brettschneider} ≦ 10 | Diesel engines |

Owing to the simplifications in the calculation according to Brettschneider and because of measurement inaccuracies in the air and fuel mass flow measurement, and in the case of measurement with lambda probes, the tolerances should be chosen to be no less than 10%, for robust and nevertheless critical fault recognition. Table T5.17 is a proposal for the corresponding tolerances as a function of the detection sharpness.

T5.17
Guideline values for the detection
sharpness for the lambda comparison

| | Detection | |
|---|---|---|
| Tests | sharpness | Tolerance |
| λ_{Brettschneider} ≅ λ_{air/fuel} | High | 10% |
| λ_{Brettschneider} ≅ λ_{ECU} | | |
| λ_{Brettschneider} ≅ λ_{probe} | Medium | 15% |
| λ_{air/fuel} ≅ λ_{probe} | | |
| λ_{air/fuel} ≅ λ_{ECU} | Low | 20% |
| λ_{probe} ≅ λ_{ECU} | | |

The same operating and switch off conditions apply for the lambda toolbox as for the pressure and temperature toolboxes. This means that they should be used only at steady-state operating points, and that the methods are not carried out in the case of an overrun switch off.

The discussion of the separation sharpness for the λ test rules can be considered on a somewhat more differentiated basis.

The comparison λ_{probe}≈λ_{ECU} is characterized by a separation sharpness p=0.5, since only two equivalent measurement signals are a component of the test.

Three equivalent measurement signals are included in each of the comparisons λ_{air/fuel}≈λ_{ECU} and λ_{air/fuel}≈λ_{probe}, thus resulting in a separation sharpness of p= 1/3.

The method separation sharpness for λ_{air/fuel}≈λ_{Brettschneider} and λ_{Brettschneider}≈λ_{ECU} and λ_{Brettschneider}≈λ_{probe} must in contrast be considered on a channel-specific basis, and this is shown in Table T5.18.

CO measurements are carried out as a % in the case of otto-cycle engines and in ppm in the case of diesel engines, a distinction must be drawn between the two engine types for the definition of the channel-specific separation sharpness. In this case, for simplicity, it is assumed that the CO term in the case of otto-cycle engines has the same manipulated value as the terms CO2, O2, ML, MB, λ_{probe} and λ_{ECU}. Since p_{NOX}=0.0001, the NOX term is ignored in the definition of the method separation sharpness. In addition, the CO term is also ignored for diesel engines.

This will be explained briefly using the example of the λ_{air/fuel}≈λ_{probe} method. If the method is carried out for an otto-cycle engine, then the variables HC, CO, CO2, O2, NOX and λ_{probe} are required for the calculation. However, because of their minor influence, HC and NOX are ignored for the definition of the separation sharpness. Only 5 instead of 7 equivalent terms are therefore used for the definition of p, resulting in a separation sharpness of p=⅕.

TABLE T5.18
Channel-specific separation sharpness of the O2 balance

| | Separation | | Separation | | Separation | |
|---|---|---|---|---|---|---|
| | sharpness p | | sharpness p | | sharpness p | |
| | λ_{air/fuel} ≅ | | λ_{Brettschneider} ≅ | | λ_{Brettschneider} ≅ | |
| | λ_{Brettschneider} | | λ_{ECU} | | λ_{probe} | |
| | Otto- | | Otto- | | Otto- | |
| Channel | cycle | Diesel | cycle | Diesel | cycle | Diesel |
| HC | 0.0001 | 0.0001 | 0.0001 | 0.0001 | 0.0001 | 0.0001 |
| CO | 0.2 | 0.25 | 0.0167 | 0.2 | 0.0167 | 0.2 |
| CO2 | 0.2 | 0.25 | 0.0167 | 0.2 | 0.0167 | 0.2 |
| O2 | 0.2 | 0.25 | 0.0167 | 0.2 | 0.0167 | 0.2 |
| NOX | 0.0001 | 0.0001 | 0.0001 | 0.0001 | 0.0001 | 0.0001 |
| ML | 0.2 | 0.25 | 0.0167 | 0.2 | 0.0167 | 0.2 |
| MB | 0.2 | 0.25 | 0.0167 | 0.2 | 0.0167 | 0.2 |

Precisely in the same way as in the balances that have already been described, corresponding fault features for fault classification can also be extracted in the case of the lambda comparison. As can clearly be seen from FIG. 44, significant errors in the air or fuel mass flow measurement lead to corresponding features in the lambda calculation. In contrast, as expected, errors in the area of the CO2 and O2 measurements dominate in the case of the calculation according to Brettschneider.

The major components C_{fuel}, h_{fuel} and O_{fuel} can be determined by a fuel analysis. The sum of these components must result in virtual unity. In the configuration process, it is either possible to select preset values for the respective fuel or to enter current values. During the inputting process, a check is carried out to determine whether the condition according to the relationship 5.40 is satisfied.

0.99<C_{fuel}+h_{fuel}+O_{fuel}<1.01 [Relationship 5.40]

In addition, it has been possible to store minimum and maximum values for the major components, as a comparison normal, from a plurality of fuel analyses for the normal fuel unleaded, super, super plus and diesel.

TABLE T5.19
Limit values for the gravimetric major fuel components
Otto-cycle fuels

| | |
|---|---|
| C_{fuel min} = 0.8466 | C_{fuel max} = 0.8865 |
| h_{fuel min} = 0.1015 | h_{fuel max} = 0.136 |
| o_{fuel min} = 0.05 | o_{fuel max} = 0.0227 |

Diesel fuels

| | |
|---|---|
| C_{fuel min} = 0.8298 | C_{fuel max} = 0.8371 |
| h_{fuel min} = 0.127 | h_{fuel max} = 0.142 |
| o_{fuel min} = 0 | o_{fuel max} = 0 |

This results in the test according to relationship 5.41.

c,h,o_{fuel, min}≦c,h,o_{fuel}≦c,h,o_{fuel, max} [Relationship 5.41]

In addition to the gravimetric components it is, of course, also possible to determine the fuel density in the fuel analysis. In this case, the following limit values have been determined for the corresponding fuels.

TABLE T5.20
Limit values for the fuel density
Otto-cycle fuels

| | |
|---|---|
| ρₘᵢₙ = 730 kg/m³ | ρₘₐₓ = 773 kg/m³ |

Diesel fuels

| | |
|---|---|
| ρₘᵢₙ = 829 kg/m³ | Pₘₐₓ = 837 kg/m³ |

The fuel density is then tested using relationship 5.42.

ρ_{fuel,min}≦ρ_{fuel}≦ρ_{fuel,max} [5.42]

At this point, it should be noted that the limit values should be regarded as guideline values since they have been calculated only from a very restricted sample set. The consideration of the fuel data is therefore intended essentially to avoid input errors.

The stationary diagnosis is intended to detect faults on the engine and/or test rig even before the start of a test run. For this purpose, for selected channels, measurement data is gathered in a configurable time window (for example 60 seconds) using a recording frequency of 1 Hz, and is processed in a simple start-up check. The time window forms the database to which all the individual functions described in this section relate.

Corresponding methods are used to check whether all the temperatures correspond approximately to the ambient temperature and all the pressures fluctuate around the ambient pressure. Care is also taken to ensure that all the selected measurement channels exist and are producing measurement values as expected. The final check investigates whether all the selected measurement values are free of drift or noise.

The approach is justified by the simple fact that all the measurement variables will be in a stable equilibrium state with the environment following a sufficiently long waiting time. For example, temperatures will approximate to the ambient temperature and pressures will logically approximate to the ambient pressure (FIG. 45). Furthermore, even while stationary, it is possible to determine whether signals differ significantly from the expected signal behaviour.

The functions for limit-value monitoring, for value comparison, for stability and for signal quality must therefore be provided for useable stationary diagnosis.

The limit-value test in the stationary state is based on the simple fact that measurement variables on engine test rigs will approach specific asymptotic values after a greater or lesser waiting time. In the case of pressures, this is in general the ambient pressure, and in the case of temperatures, it is the ambient temperature. In the case of temperatures, strict attention must be paid to how long it is since the last operation in which combustion took place, since components, oil and cooling water may still be in the cooling-down phase. If one assumes a cold, stationary engine, then the pressures, temperatures, “exhaust-gas measurement values”, or mass flows must be within characteristic limits. These are monitored in the course of the limit-value test in the stationary state. Table T5.21 shows an overview of typical limit values which are investigated for the purposes of limit-value monitoring.

TABLE T5.21
Limit values for limit monitoring within the stationary diagnosis

| Channel type | Unit | Min | Max |
|---|---|---|---|
| Rotation speeds | rpm | −5 | 5 |
| Torques | Nm | −5 | 5 |
| Fuel mass flow | kg/h | −0.01 | 0.01 |
| Air mass flow | kg/h | −0.01 | 0.01 |
| O2 | vol % | 20 | 21.5 |
| CO2 | vol % (ppm) | 0.01 (100) | 0.04 (400) |
| Pressures | mbar | 990 | 1100 |
| Temperatures | ° C. | 15 | 40 |

The temperature details are guideline values which are applicable to normal box temperature stabilisation. Other temperature ranges may also be required in all cases, depending on the test task (for example cold chamber).

The function “value comparison when stationary” checks whether measurement variables of the same type are moving around a defined reference. Pressures and temperatures are a typical example of this. The comparison basis in this case may be both a predetermined value and a calculated reference value.

In the case of a predetermined limit value, all the measurement variables of the same type are compared with this reference value, within a configurable tolerance band. One such limit value may, for example, be the measured ambient temperature. All the considered temperatures must then satisfy the relationship 5.43.

T_{ambient}−tolerance≦Tₜₑₛₜ≦T_{ambient}+tolerance [5.43]

In this case, Tₜₑₛₜ is the temperature to be assessed and tolerance is the tolerance to be configured by the user.

The reference variable can also be determined automatically. However, at least two measurement variables of the same type are required to do this. In this case, the reference variable can be formed from the individual variables via the median calculation. The rest of the testing is then carried out as already described above and is illustrated by way of example in FIG. 46.

The value comparison in the stationary state is implemented for the purposes of measurement data diagnosis in such a way that the user can decide whether he wishes to preset a reference variable or whether this should be calculated from the data.

In the case of stationary diagnosis, the assessment of the stability has the two functions of drift recognition and time-response compensation. For drift recognition, the gradient of the channel-specific database is determined by means of a simple linear regression, and is compared with a configurable limit gradient. This is used to determine whether the corresponding channel is in an asymptotic state. This is particularly important for temperature channels.

The compensation for the time response is fundamentally applicable to all measurement channels, but relates essentially to temperature channels. In this method, the time response is compensated for by local, linear models (LLM) in that, with a corresponding r², the model value is subtracted from the measurement value. This results in a signal which is around zero (FIG. 47), which has no drift and is free of any mean value, by means of which it is possible to assess the signal quality.

FIG. 48 shows the first four subareas for the time interval 0 s<t<120 s with the corresponding model equations of the LLMs and the regression coefficient r².

The assessment of the signal quality in the stationary state is carried out in precisely the same way as that already described further above. In this case, the stationary data is used as the database.

All of the fault recognition methods described so far have the common feature that they can be used only for the steady-state or quasi-steady-state operating point. It is therefore intended, at this point, to introduce an approach for fault recognition in non-steady-state operating conditions, for example as in the case of the NEDC exhaust-gas cycle.

As already mentioned, model-based fault recognition generally fails for time reasons. A method must therefore be found which learns data patterns in parallel with the test run without effort, and can subsequently classify these patterns correctly again. This requirement corresponds to a self-learning observer system.

The adaptive resonance theory (ART) from Gail Carpenter and Stephen Grossberg was chosen as the solution approach. ART is not a single model but a family of models which belong to the algorithms, which learn without being monitored.

These models were originally developed to solve the elasticity/plasticity dilemma of neural nets. This means, inter alia, the question of how new associations can be learnt in neural nets without having to forget old associations in the process.

However, the solution to the elasticity/plasticity dilemma therefore also at the same time corresponds to the solution of the classification problem of a self-learning observer system. The learning process in the case of ART nets can be carried out using a slow or a fast learning method. In the case of slow learning, the weights of the selected class are adapted by means of differential equations. In the case of fast learning, the adaptation is in contrast determined using algebraic equations.

The fast-learning mode will be used for use as an observer system since, in this case, an input pattern need be presented only once in order to be learnt. This is a characteristic which is of critical relevance for an observer system. This is made possible by means of high plasticity with respect to the pattern which is retained and has already been learnt but which at the same time prevents excessive modification of patterns which have already been learnt. This means that, in principle, each measurement can be learnt as a new pattern and, conversely, can be used as a reference for future measurements. In principle, the ART models operate on the following basis:
1) An input pattern is applied to the net.
2) The algorithm attempts to classify the input pattern in an existing class, depending on the similarity with stored patterns.
3) If the pattern cannot be associated with any existing class, a new class is produced. This is done by storing a pattern which is similar to the input pattern.
4) If a pattern is found which is similar, taking into account a predetermined tolerance, the stored pattern is slightly modified in order to make it more similar to the new pattern.
5) Stored patterns which are not similar to the current input pattern are not changed.

This procedure can thus be used to produce new classes (plasticity) without having to change existing patterns when they are not similar to the current input pattern (stability).

Another important feature is that ART models exist for binary input patterns and for continuous input patterns.

Since the measurement data is continuous data, only the ART variants for continuous input vectors may be used for implementation, as well. These specific models are referred to as ART-2 or ART-2A models and represent an extension to the classic ART models. FIG. 49 shows a schematic section through an ART2 network.

The input pattern is applied to the input layer F₀ and then propagates to the comparison layer F₁ where it is amplified and normalised in different steps. This is done until a defined equilibrium state occurs between the comparison layer and the recognition layer F₂. This is controlled by means of a similarity parameter r and a reset component. The neurons in F₁ represent the net attributes while in contrast the neurons in F₂ represent the categories or classes. Each link is weighted with specific weights. The weight matrix is therefore also referred to as the long-term memory of the ART.

When configuring ART nets, particular attention should be paid to the similarity parameter. This has a major influence on the classification characteristics of the network. The high value in this case causes a fine memory, that is to say a large number of small classes are formed. In contrast, a low value leads to higher abstraction with fewer, but coarser, classes.

The algorithm will not be described mathematically in detail at this point and, instead of this, reference is made to “Simulation neuronaler Netze” [Simulation of neural nets] by A. Zell, Addison Wesley Longmann Verlag, 1994, to “Entwicklung und Verifizierung eines dynamischen Beobachtersystems für Motorenprüfstände” [Development and verification of a dynamic observer system for engine test rigs] by E. Maronova, bachelor thesis, Darmstadt 2006, or “Adaptiv-Resonanz-Theorie und Entwicklung eines dynamischen Beobachtersystems zur Motor-Diagnose” [Adaptive resonance theory and development of a dynamic observer system for engine diagnosis] by Toma Donchev, bachelor thesis, Darmstadt 2007.

However, the object of an observer system does not just comprise classification but also comparison of the measurement values with associated reference values. This is the only way in which the observer system can recognize faults in the monitored target variable. Appropriate input and output variables must be specified for this purpose in the configuration process. The number is theoretically unlimited, but, for system load reasons, is restricted to 10 input and output variables. In principle, this also applies to the number of classes.

The configuration process thus defines what data will be associated by the net. This means that the observer system is used to form an empirical association model between target variables and response variables for the fault-free process. An extension to the ART is required for this task, and this is referred to as ARTMAP or predicted ART. In the case of ARTMAP nets, two ART nets are combined with a linking net, the so-called MAP field, to form a system which learns in a monitored manner (FIG. 50). This means that a training pattern must now comprise an input vector (target variable or factor) and an output vector (response variable) associated with it.

In this case, it is irrelevant whether one uses ART-1, ART-2 or ART-2A nets. ART-2A nets were used for the purposes of the present work.

The first ART net (ART^{a}) processes the input vector, and the second (ART^{b}) processes the result vector. The two ART nets are linked to one another by the MAP field and are thus synchronized to one another.

In order to check the quality of an already trained ARTMAP network, an input vector is applied to the recognition layer of ART^{a} and, at the same time, all the inputs of the recognition layer of ART^{b} are set to zero. An appropriate class for the input is now set for ART^{a}.

If an already trained cell is addressed by the activation, this leads to activation of the appropriate MAP field cell, which in turn produces an appropriate output. If, in contrast, an untrained cell in ART^{a} is activated, this results in the activation of all the MAP field cells. This is a feature which cannot classify the input sufficiently reliably.

This characteristic is excellently suitable for controlling an automatic observer system. The algorithm described above is now carried out for each pattern. If an input pattern cannot be classified, another run is carried out through the training algorithm once again, automatically, with this pattern. This is continued until either a defined termination criterion or a trained state is reached.

Various NEDC cycles were used in order to investigate the fundamental suitability of an ARTMAT network as the basis for a self-learning observer system. These were first of all compared with one another in order to exclude impermissible discrepancies for the assessment. One cycle from all the cycles was selected as a reference pattern and was presented as a “measurement” to the ARTMAP prototype (FIG. 50). The net was then operated with the other cycles. The aim in this case was to check two aspects:
1) How well can the ARTMAP net classify similar patterns?
2) How good is the prediction of the ARTMAP net for the time variable?

It is important for the evaluation that the NEDC measurements to be investigated were measured over several days using the same engine (TDI passenger car engine).

The analysis is illustrated, by way of example, in FIG. 51 for the raw NOX emission. As can easily be seen, the reproducibility of the NOX measurement is relatively good. On average, the fluctuations are less than 50 ppm. This data was used to investigate how suitable an ARTMAP network is for use as a reference for a non-steady-state NEDC cycle.

The investigation relating to the ARTMAP observer system was carried out offline using a prototype. An ARTMAP net with six input variables and one output variable was produced for the investigation. The rotation speed, accelerator pedal position, torque, start of actuation of the main injection, injection amount of the main injection and the duration of the main injection were used as input variables. The target variable or output variable was the raw NOX emission. For the training phase, the net was trained using the method as described above with an arbitrarily selected NEDC cycle (red line in FIG. 51). In this case, training means that the corresponding data is presented as a starting pattern to an untrained net. This data should be classified by the net, and should be associated with the correct target variable. During the validation with other NEDC data, a check is first of all carried out to determine whether the current pattern is already known or must be used for new training. In the case of a known pattern, a comparison is carried out between the current measurement value and the predicted net output.

FIG. 52 shows the result of an arbitrarily selected NEDC cycle with respect to the reference measurement on a representative basis (the investigation of the other cycles leads to similar results). As can be seen from the profile, the net output can follow the actual measurement well. The only major discrepancies that can be seen are in the cross-country and motorway section of the NEDC. This is because of the use of two very similar classes and excessively low contrast. This can easily be seen from the oscillating net output in the region from 1750 to 2000 s. Since the model and the measurement have the same dynamic response, fundamental suitability of the ARTMAP network for dynamic diagnosis can be derived from this. With a maximum discrepancy of 202 ppm (on average about 25-30 ppm) between the net output and the measurement, it was possible to achieve a surprisingly good result even with the prototype. In this case, it should be noted that the measurements themselves were scattered by up to 50 ppm. The adaptation of the similarity factor still has a considerable optimization potential at this point.

The ARTMAP approach is fundamentally highly suitable for use as a basis for dynamic fault recognition in the form of an observer system.

Fault isolation is subject to two fundamental requirements:

Reliable signalling of faulty or conspicuous measurement variables taking account of a configurable diagnosis sharpness.

Generic design, in order to automatically include future fault recognition methods in the fault isolation algorithms.

Appropriate evaluation logic was developed for implementation of these requirements and this is referred to in the following text as a logic layer, and is illustrated schematically in FIG. 53.

The development took account of the fact that both channel-selective methods and methods covering more than one channel are used for fault recognition. Furthermore, a distinction was drawn between single-value fault recognition by cyclic online fault recognition and between diagnosis of time windows in the form of cyclic buffer elements.

In order to allow all information elements to be interpreted correctly and generically, the structure of the evaluation logic for fault isolation is based on a channel-selective approach.

The channel-selective approach requires the fault recognition methods with a plurality of input variables to be projected on to the measurement channels involved. The results of the corresponding methods are supplied to the logic layer, where they are evaluated automatically and are processed further to form appropriate messages. The messages are then passed on to the visualization and, in parallel, to the data storage.

The configuration of the logic layer, which comprises the fault isolation and fault classification blocks, is illustrated in FIG. 54. Remembering the diagnosis workflow, the fault recognition and the fault isolation were in this case combined to form the “fault isolation” block, and the fault identification and fault classification were combined to form the “fault classification” block.

Fault isolation has the task of feeding back all the individual results of the fault recognition to the measurement channels involved, and of adding them up. A test variable is then calculated from the sum of the individual results, and is compared with a defined limit value. Conspicuous measurement channels are separated from inconspicuous measurement channels in this way. The limit value is in consequence a measure of the recognition sharpness, and can be set to the levels low, medium or high.

The so-called method separation sharpness (separation sharpness, for short) was introduced for automatic and generic evaluation of the fault recognition for fault isolation purposes. The separation sharpness is a characteristic variable which defines how well a method can identify a faulty measurement channel. It thus describes the capability of a method to associate a fault with the faulty measurement channel.

For example, the inequality T3>T2 has two equivalent terms and thus a separation sharpness of p=0.5. The appliance check methods always have a separation sharpness of p=1, since in this case only one channel is ever considered. The comparison between a measured lambda value and the calculated lambda from the air and fuel mass flow has, for example, a separation sharpness of p=0.33 since three equivalent information items are used in the check.

It is self-evident that a method with a low separation sharpness may be included to a lesser extent in the fault isolation than a method with a high separation sharpness.

Methods with a separation sharpness of p=1 do not require any further differentiation since they produce a clear result. In contrast, the number of methods and their method separation sharpness must be taken into account in the plausibility testing methods (separation sharpness p<1). In mathematical terms, this means that a certain number of independent test instances will be present with specific recognition probabilities. The linking weight must in consequence link the number and the specific probability.

The “generalized addition rule of statistics for events which are not mutually exclusive” is used as an approach for this purpose. According to this, the probability of at least one of the events Eᵢ occurring is:

p_{plausibility}(E₁∪E₂∪ . . . ∪Eₖ)={[1−P(E₁)]·[1−P(E₂)]· . . . ·[1−P(Eₖ)]} [Equation 1.1]

For fault isolation, it follows from this that, using this rule, the recognition probability of the plausibility check p_{plausibility} for a defined channel can be determined taking account of the test rules that are used. However, this approach works only when the individual probabilities can be defined precisely. That is to say all influences must have the same probability and must be statistically symmetrical. Physical symmetry is therefore required, allowing the conclusion of statistical symmetry (for example the ideal cube). However, remembering the lambda comparison for the O2 balance, it is precisely this requirement for the measured exhaust-gas concentration that is not satisfied since some variables are measured as % by volume and others as ppm. A number of assumptions are being made, for this reason:
1) In the case of diesel engines, the CO2 concentration and the O2 concentration have approximately the same methodological influence as the mass flows.
2) In the case of otto-cycle engines, the CO concentration must additionally also be considered. The variables CO2, O2 and CO are therefore considered to be equivalent to the mass flows.
3) For the variables HC and NOX, the separation sharpness is defined as p= 1/10,000, by definition. Strictly speaking, a distinction can also be drawn here on the basis of the configured engine types, in such a way that only HC and NOX are considered for the otto-cycle engine, and HC, CO and NOX, with p= 1/10,000, for the diesel engine.

The test variable t_{fault isolation} is calculated using the approach that every plausibility method produces a binary test result E_{bin, method}. The method result E_{method} is calculated by multiplying the binary method result E_{bin, method} by the method separation sharpness p_{method} (equation 1.2).

E_{method}=E_{bin,method}·p_{method} [Equation 1.2]

The results of all the plausibility methods which can be carried out are then added up and multiplied by the overall probability of the plausibility. The test variable for the fault isolation can thus now be calculated using equation 1.3:

$${t}_{fault isolation} = \frac{\begin{matrix}{E}_{RA} + {E}_{SA} + 6 \cdot ( {E}_{GC} + {E}_{LC} ) + \\ {E}_{B } + {p}_{plausibility} Σ {E}_{method} \cdot {p}_{method}\end{matrix}}{6} \qquad [ Equation 1.3 ]$$

where E_{RA}=raw data analysis
   E_{SA}=1 Hz signal analysis
   E_{GC}=appliance check
   E_{LC}=limit check
   E_{B}=steady state

The term 6·(E_{GC}+E_{LC}) is justified by the fact that one channel must always be isolated as being faulty in the event of a fault message in the limit check or appliance check.

The only item which still remains open for fault isolation is determination of the limit values for the settings low, medium and high. For this purpose, it is assumed that, on average, 4 to 5 methods for plausibility are used per channel. For the high setting, at least one warning should be issued only if the following individual results occur:

| | | |
|---|---|---|
| p_{plausibility} ≧ 0.5 | | |
| Raw data analysis = 0 [symbol] 1 Hz − signal | | |
| analysis = 0 \hat{ } solid state = 0 | {close oversize brace} | → warning |
| Appliance check = 0 [symbol] limit check = 0 | | |

With the medium setting, at least one warning is produced when

| | | |
|---|---|---|
| p_{plausibility} ≧ 0.5 | | |
| 1 Hz − signal analysis = 1 [symbol] raw | | |
| data analysis = 1 [symbol] steady state = 1 | {close oversize brace} | → warning occurs |
| Appliance check = 0 [symbol] limit check = 0 | | |

In order to initiate at least one warning with the low setting, at least the following individual results must occur.

| | | |
|---|---|---|
| p_{plausibility} ≧ 0.5 | | |
| Raw data analysis = 1 [symbol] steady | | |
| state = 1 [symbol] Hz − signal analysis = 1 [symbol] | | |
| solid state = 1 | {close oversize brace} | → warning |
| Appliance check = 0 | | |
| Limit check = 0 | | |

This results in the critical limit values shown in Table T1.1.

TABLE T1.1
Critical limit values for fault isolation

| Message | Value | t_{crit} for low | t_{crit} for medium | t_{crit} for high |
|---|---|---|---|---|
| Channel is | 0 | t_{crit} < 0.3 | t_{crit} < 0.2 | t_{crit} < 0.05 |
| OK | | | | |
| Channel is | 1 | 0.3 < t_{crit} < | 0.2 < t_{crit} < | 0.05 < t_{crit} < |
| suspect | | 0.6 | 0.4 | 0.2 |
| Channel is | 2 | t_{crit} ≧ 0.6 | t_{crit} ≧ 0.4 | t_{crit} ≧ 0.6 |
| faulty | | | | |

The fault isolation result is transferred in the form of a numerical value (0, 1 or 2) to the fault classification.

In principle, the same structure is used for the case of measurement-synchronous fault recognition. The only difference is that the mean value from the buffer store is used rather than the current measurement value for the individual-value methods.

For fault classification purposes, the fault significance is assessed using the debouncing buffer \vec{EP}. For this purpose the channel-specific fault isolation results are written to a likewise channel-specific column vector of configurable length. This vector is in the form of software, as a rolling-map memory.

The test variable t_{classification} is calculated from the debouncing buffer using equation 1.4, and is compared with the critical value t_{classification, crit}.

$${t}_{classification} = \frac{{\sum }_{i = 1}^{n} {EP}_{i}}{2 \cdot n} < {t}_{classification , crit} \qquad [ Equation 1.4 ]$$

Subdivision into the levels low, medium and high takes place in precisely the same way as in the case of fault isolation. Depending on the sharpness level (Table T1.2), the corresponding channel is classified as being fault-free, significantly faulty or severely significantly faulty, and is associated with a corresponding message (“OK”, “Warning” or “Error”).

TABLE T1.2
Critical limit values for fault classification

| Message | Value | t_{crit} for low | t_{crit} for medium | t_{crit} for high |
|---|---|---|---|---|
| Channel is not | 0 | t_{crit} < 0.3 | t_{crit} < 0.2 | t_{crit} < 0.1 |
| significantly | | | | |
| faulty → OK | | | | |
| Channel is | 1 | 0.3 ≦ t_{crit} ≦ | 0.2 ≦ t_{crit} ≦ | 0.1 ≦ t_{crit} ≦ |
| significantly | | 0.6 | 0.5 | 0.3 |
| faulty → warning | | | | |
| Channel is | 2 | t_{crit} > 0.6 | t_{crit} > 0.5 | t_{crit} > 0.3 |
| severely | | | | |
| significantly | | | | |
| faulty → fault | | | | |

A general, more far-reaching determination of the fault cause is not possible with the signal-based fault recognition approach that is used. This is justified by the fact that, in general, no direct conclusion is possible from a measurement channel to a fault in a technical system component. The fault classification is therefore automatically reduced to the designation of faulty measurement signals with respect to fault magnitude and fault duration.

In order to avoid false alarms, the fault classification can be bridged by defined enable conditions. In the situation in which the enable conditions are not satisfied, the “switch” in FIG. 54 is opened, and the channel status is automatically set to 3. This means that it has not been possible to test the corresponding channel.

The process of fault isolation and fault classification will be explained briefly using the example of a stationary stage measurement. The assessment is in this case carried out once for the air mass flow and once for the fuel mass flow.

The following constraints, which are defined by the configuration process, apply to the example:
1) Methods which can be Carried Out
   λ_{air/fuel}=λ_{probe}
   λ_{air/fuel}=λ_{Brettschneider}
   C balance
   O2 balance
   Raw signal analysis
   1 Hz signal quality
   Limit check
   Appliance check
2) Tolerances
   C balance=15%
   O2 balance=10%
   lambda comparisons=10%
3) Times
   Length of the cyclic buffer=30 s
   Length of the debouncing memory=30 s
4) Diagnosis Sharpness
   Medium

The measurement values from the lambda probe as well as the air mass flow and fuel mass flow are required in order to calculate the method λ_{air/fuel}=λ_{probe}. The method therefore has a probability of p=⅓ of recognizing a fault in the air mass flow or in the fuel mass flow, respectively.

The concentration of CO, CO2 is also required, in addition to the air mass flow and fuel mass flow, for the method λ_{air/fuel}=λ_{Brettschneider}. With respect to the air mass flow and fuel mass flow, NOX has a separation sharpness of p=0.0001, and for this reason is ignored. In consequence, this results in a probability of p=0.25 of correctly recognizing a fault in the air mass flow using the method. Based on the same scheme, p=0.25 is likewise obtained for the C balance and for the O2 balance. The limit check and the signal analysis are each included in the calculation with p=1. The plausibility therefore has a total component of:

$${p}_{plausibility} = 1 - \{ [ 1 - \frac{1}{3} ] \cdot [ 1 - \frac{1}{6} ] \cdot [ 1 - \frac{1}{4} ] \cdot [ 1 - \frac{1}{4} ] \} = 0.6875$$

TABLE T1.3
Result of the fault classification for the fuel mass flow
Example calculation for the fuel mass flow

| | 840 to | 870 to | 900 to | 930 to |
|---|---|---|---|---|
| | 870 s | 900 s | 930 s | 960 s |
| λ_{air/fuel} = λ_{probe} | 0 | 1 | 1 | 0 |
| λ_{air/fuel} = λ_{Brettschneider} | 0 | 1 | 1 | 0 |
| C balance | 0 | 1 | 1 | 0 |
| O2 balance | 0 | 1 | 1 | 0 |
| Steady state | 0 | 1 | 0 | 0 |
| 1 Hz signal quality | 0 | 1 | 0 | 0 |
| Limit check | 0 | 1 | 1 | 0 |
| Appliance check | 0 | 0 | 0 | 0 |
| Raw signal analysis | 0 | 1 | 0 | 0 |
| t_{fault isolation} | 0 | 1.6131 | 1.1131 | 0 |
| Isolation result | 0 | 2 | 2 | 0 |
| Classification | OK | ERROR | ERROR | OK |
| result | | | | |

TABLE T6.4
Result of the fault classification for the air mass flow
Example calculation for the fuel mass flow

| | 840 to | 870 to | 900 to | 930 to |
|---|---|---|---|---|
| | 870 s | 900 s | 930 s | 960 s |
| λ_{air/fuel} = λ_{probe} | 0 | 1 | 1 | 0 |
| λ_{air/fuel} = λ_{Brettschneider} | 0 | 1 | 1 | 0 |
| C balance | 0 | 1 | 1 | 0 |
| O2 balance | 0 | 1 | 1 | 0 |
| Steady state | 0 | 0 | 0 | 0 |
| 1 Hz signal quality | 0 | 0 | 0 | 0 |
| Limit check | 0 | 0 | 0 | 0 |
| Appliance check | 0 | 0 | 0 | 0 |
| Raw signal analysis | 0 | 0 | 0 | 0 |
| t_{fault isolation} | 0 | 0.1131 | 0.1131 | 0 |
| Isolation result | 0 | 0 | 0 | 0 |
| Classification | OK | OK | OK | OK |
| result | | | | |

A change in the diagnosis sharpness from medium to high results in a warning for the air mass flow in the region from 870 s to 930 s.

The generic structure of the logic layer developed in this way makes it possible, without any restriction, to add new fault recognition methods easily by way of the known number of influencing variables and by means of the method separation sharpness, which is likewise known.

The previous sections have frequently referred to the internal data management. This is a “mini database” in which the various partial diagnosis results relating to the run time are temporarily stored in encoded form. These partial results are used on the one hand for fault evaluation and on the other hand for documentation of the diagnosis results. In order to carry out this function optimally, the internal data management comprises the areas illustrated in FIG. 56.

The static data area contains data which is changed only during the configuration process. In addition to management of constants, the occupancy of the master classes, for example, is also analysed here in order to determine from this the methods which can be carried out.

All user actions are documented with respect to the run time in the variable data area. In addition to the start and the end of the diagnosis, all actions by the user are noted here. By way of example, the deactivation and redeactivation of fault recognition methods or the acknowledgement of fault messages are particularly important.

In order to allow the results of the individual fault recognition methods to be evaluated at the same time, they must be available at a specific time and in a defined memory element. For example, fault isolation requires information about the methods used for each channel, and their separation sharpness. This data management is carried out in the equidistant online data block.

Visualization, in particular fault visualization, is an important element of measurement data diagnosis. In this case, strict attention must be paid to ensuring that the user is not overloaded by a flood of information relating to faults and to the system status. The visualization pyramid which has already been mentioned further above, using three visualization levels, was implemented exactly for this purpose, as can be seen in FIG. 57.

Information relating to the functional status and fault status of the diagnosis is indicated in level I by unambiguous symbology. A combination of a triangle and an exclamation mark is preferably chosen for this purpose since this allows three information items to be indicated in a very simple form.
1) A black button area (warning triangle can be seen slightly) can be used to symbolize that no faults are present at the moment on the basis of the configuration and of the fault recognition functions which can be carried out thereby (FIG. 58a).
2) A new fault on the test rig is symbolized by a warning triangle that is illuminated permanently in red (FIG. 58b).
3) In the situation in which a fault has been recognized and has disappeared again, FIG. 58c is used.

In the second visualization levels (level II), the user is presented with information relating to the diagnosis history (see FIG. 59). By means of a record window, it is possible to track precisely when and how often an event (fault, warning) has occurred. This is particularly important, for example, for partially manned or unmanned operation since the user can be provided with a rapid overview of the events which have occurred prior to that, after a lengthy absence.

The third level of result visualization shows the scope and the current status of fault recognition, with a distinction being drawn between a channel-based view and a method-based view.

Both views (the channel overview in FIG. 60a and the method overview in FIG. 60b) are constructed using a tree structure with a plurality of sub-layers. It should be noted that methods can be deactivated and activated again during the run time in both views. This is worthwhile, for example, when one channel or one method is continuously signalling faults even though this is irrelevant for the current test.

All information which is of importance for the creation of the overall diagnosis result is documented in the course of the measurement data diagnosis. This includes the data relating to the configuration as well as all classification results, user actions and system messages.

The following external references are used for result management:
Configuration data
System messages and user actions
Quality seal

The appropriate information is stored together with the test results via external references or attributes in the Puma database.

In this case, the quality seal should be stored directly with the measurement data. FIG. 61 shows the implementation of the quality seal using the example of a MAGIC database. In this case, correct data is not identified. This means that the quality seal is in this case a white background for fault-free data.

The introduction of a quality seal has a wide range of advantages for the user:
1) The introduction of a quality seal allows redundant data use with greater confidence.
2) Each user can immediately see whether the data relates to tested information.
3) In addition to the quality seal, the user is presented with all the information relating to configuration, fault acknowledgement, etc., by appropriate references.
4) In the case of DoE applications, it is possible to considerably shorten the time required for checking the plausibility of the raw data.

1. A method for analysis and assessment of measurement data of a measurement system having at least one measurement channel, comprising the assessment of the measurement data at freely selectable times and over a freely selectable period on the basis of at least one of a plurality of predeterminable criteria, wherein the raw data of the measurement channel is supplied to a fault isolation stage and then to a fault classification stage, and in that a measure is then determined for the quality of the measurement data of the respective measurement channel.

2. The method according to claim 1, wherein in the fault isolation stage, the raw data is first of all supplied to a fault recognition stage.

3. The method according to claim 2, wherein after being processed in the fault isolation stage, the data is supplied to a fault identification stage within the fault classification stage.

4. The method according to claim 3, wherein the raw data is recorded at the correct time and is supplied as required to the fault isolation stage and to its fault recognition stage.

5. The method according to claim 4, wherein the fault isolation stage, or its fault recognition stage, carries out a high-frequency signal analysis on the raw data.

6. The method according to claim 5, wherein the current measure for the quality of the measurement data of any desired measurement channel is compared with a predeterminable limit value, whose undershooting is indicated.

7. The method according to claim 6, wherein a chronological record is generated over the profile of the measures for the quality of the measurement data, and is indicated.

8. The method according to claim 7, wherein the current status of the fault isolation stage is read and is indicated.

9. The method according to claim 8, wherein the operating modes of stationary fault recognition, cyclic online fault recognition (ZOF) and measurement-synchronous fault recognition (MSF) are provided.

10. The method according to claim 9, wherein the operating modes can be provided individually or in parallel, in particular the cyclic online fault recognition (ZOF) and the measurement-synchronous fault recognition (MSF).

11. An apparatus for analysis and assessment of measurement data of a measurement system, comprising a unit for the assessment of the measurement data of at least one measurement channel of the test rig at any desired time on the basis of a plurality of predeterminable criteria, including an input for the raw data of the measurement channel, a unit in which a fault isolation stage and then a fault classification stage are implemented, and an output for a measure for the quality of the measurement data of the respective channel.

12. The apparatus according to claim 11, wherein a fault recognition stage with an input for the raw data is implemented in the fault isolation stage.

13. The apparatus according to claim 12, wherein the output of the fault isolation stage is connected to an input of a fault recognition stage which is implemented within the fault classification stage.

14. The apparatus according to claim 13, wherein a cyclic buffer is provided for recording the raw data at the correct time and is connected to the input of the fault isolation stage and/or its fault recognition stage, for checking by this stage or these stages.

15. The apparatus according to claim 14, wherein a high-frequency signal analysis device for the raw data is provided in the unit with the fault isolation stage and its fault recognition stage.

16. The apparatus according to claim 15, wherein a freely selectable limit value for the measure for the quality of the measurement data of any desired measurement channel is stored, and in that comparison logic is provided which compares the current measure with the limit value and signals its undershooting, with this signal preferably driving an indication device.

17. The apparatus according to claim 16, wherein a memory area which can be read is provided for a chronological record over the profile of the measures for the quality of the measurement data.

18. The apparatus according to claim 17, wherein visualization is provided for the current status of the fault isolation stage, and can be called up.
